(19) United States
(12) Patent Application Publication
(10) Pub. No.: US 2006/0224487 A1
(43) Pub. Date: Oct. 5, 2006

(54) Apparatuses, methods, and systems to design, develop, and implement book income indices

(76) Inventor: Philip H. Galdi, Orangeburg, NY (US)

Correspondence Address: MORGAN & FINNEGAN, L.L.P., 3 World Financial Center, New York, NY, 10281-2101, US

(21) Appl. No.: 11/259,666

(22) Filed: Oct. 25, 2005

Related U.S. Application Data
(60) Provisional application No. 60/666,933, filed on Mar. 31, 2005.

(51) Int. Cl. G06Q 40/00

(52) U.S. Cl. 705/35

(57) ABSTRACT

The disclosure details the implementation of apparatuses, methods, and systems of developing and constructing book income indices. The disclosure teaches methodologies for the performance measurement of a portfolio accounted for on an historical cost-based method. Book income indices measure the performance of a base-line asset class (the “market”). Unlike total return indices, however, they account for performance on an historical cost basis, and they take account of the timing of portfolio cash flows, gain/loss recognition constraints and tax considerations.

### RELATED APPLICATIONS

The instant application hereby claims priority to and incorporates by reference herein U.S. provisional patent application Ser. No. 60/666,933 for “Apparatus, Methods, and Systems to Design, Develop, and Implement Book Income Indices” filed on Mar. 31, 2005.

### FIELD

The present system is directed generally to apparatuses, methods, and systems of financial indices, and more particularly, to apparatuses, methods, and systems of index construction and customization.

### BACKGROUND

Over the years, performance measurement has become an important part of the investment process. The largest investors have gone as far as establishing separate performance measurement departments—elevating the function to the same level of importance within the organization as research, portfolio management, and risk management.

The most common approaches to performance measurement of fixed income portfolios first began in the 1970s following the development of the very first fixed income total return indices. Since that time, the analysis and attribution tools available to analyze the total return performance of a portfolio and its benchmark index have become quite sophisticated. However, suitable book income indexing and analysis/attribution tools have not been developed for investors who record their fixed income assets on an historical cost-based accounting method. These investors have a wide range of investment performance measurement needs. Additionally, investor return objectives and risk preferences are widely varied. As such, it was difficult to accurately support the performance measurement requirements of all investors with a limited number of generic index solutions. For these reasons and others, existing indexing solutions may not provide the proper tools for an investor's performance measurement needs.

### SUMMARY

Against this backdrop, the present system undertakes the task of developing book income indices for improved performance measurement of fixed income assets providing more accurate performance measurement tools for assets recorded on an historical cost-based accounting method.

A book income index begins with the selection of constituent assets. The underlying constituent assets may, in fact, be the same as those contained in a standard market-based index, or they may be customized to take account of policy guidelines, duration needs, asset allocation decisions, or other performance monitoring concerns. The fact that investment assets may be recorded on an historical cost basis does not mean that the investor disregards economic value. Accordingly, the system compiles total return results for a book income index just as it would for any other performance index. But the compilation process does not end there. Book income performance statistics are also compiled and may take account of the unique cash flow and gain/loss constraints of a portfolio in deriving these additional performance results.

The results of a book income index may be compiled on both or either a pre- and/or post-tax basis, using given tax rates. These results may additionally include statistics such as total return, book yield, ordinary income, capital gain/loss, book income, and unrealized gain/loss. The present system provides the ability to compile pre- and after-tax performance metrics on both a book income and total return basis.

In one embodiment, an apparatus, method, and system is taught for measuring book income performance. The apparatus, method, and system comprises tracking the movement of values on a book income basis for specified holdings over time, the specified holdings comprising an index, rebalancing the index to account for applicable cash flow in accordance with one or more performance measurement preferences, and updating one or more values of the index to reflect the rebalancing.

In other embodiments, an apparatus, method, and system is taught for measuring book income performance while taking account of specified constraints, including policy, cash flow, timing, and capital gain/loss recognition constraints. These apparatuses, methods, and systems comprise rebalancing the index in accordance with any specified constraints.

Thus, the present system generally relates to performance measurement, using an index to provide a statistical composite for measuring changes in variable data and information. It is an object of the present system to provide an improved index for performance measurement of a fixed income portfolios measured on an historical cost-based accounting method. It is a further object of the present system to provide a customizable book income index to meet the needs of a user. It is a further object of the present system to provide a computer implemented book income index system for processing data for a book income index and/or a customized book income index.

### BRIEF DESCRIPTION OF THE DRAWINGS

In accordance with the present disclosure, the accompanying drawings illustrate certain non-limiting embodiments of the disclosure.

FIG. 1 illustrates one example embodiment incorporated into a Book Income Indices System controller;

FIG. 2 is of a chart illustrating the market yield of a U.S. Treasury Index and book yields of indices with various inception dates;

FIG. 3 is of a block diagram illustrating an embodiment of the present system of a Book Income Indices System for creating a base-line index for a Book Income Index;

FIG. 4 is of a block diagram illustrating an embodiment of the present system of a Book Income Indices System for determining aspects of a Book Income Index at inception;

FIG. 5 is of a block diagram providing embodiments of the present system of a Book Income Indices System for rebalancing a Book Income Index;

FIG. 6 is of a block diagram illustrating an embodiment of the present system of a Book Income Indices System controller for recognizing additional constraints on a Book Income Index;

FIG. 7 is of a block diagram illustrating an embodiment of the present system of a Book Income Indices System controller for rebalancing a Book Income Index and recognizing additional constraints on a Book Income Index;

FIG. 8 is of a chart illustrating an embodiment of the present system of a Book Income Indices System controller representing various Book Income Indices as represented by index lots each having a different inception date;

FIG. 9 is of a chart illustrating an embodiment of the present system of a Book Income Indices System controller representing various Book Income Indices as represented by index lots each having a different inception date;

FIG. 10 is of a chart illustrating the composition by acquisition month of a hypothetical broad investment grade bond index at various dates of valuation;

FIG. 11 is of a chart illustrating the composition of a hypothetical broad investment grade bond index based on the year of entry into the Index;

FIG. 12 is of a chart illustrating the market yield of a hypothetical bond at various valuation dates;

FIG. 13 is of a chart illustrating the book yields of the same hypothetical bond in FIG. 12 at various valuation dates assuming various purchase dates;

FIGS. 14 and 15 illustrate the market yields and credit-rating of a hypothetical bond at various valuation dates and the book yields of the bond as it enters and exits a series of hypothetical credit indices;

FIG. 16 is of a chart illustrating the organization of book valuation data for a bond organized according to book valuation date, index of which the bond is a member of, and the acquisition date for each of the indices;

FIGS. 17A and 17B are of a hypothetical detailed accounting of components of a Book Income Index illustrating an embodiment of the present system of a Book Income Indices System controller;

FIGS. 18A through 18D are a logic flow diagram illustrating embodiments of the present system of a Book Income Indices System;

FIG. 19 is of a block diagram illustrating embodiments of the present system of a Book Income Indices System;

FIG. 20 is of a logic flow diagram illustrating embodiments of the present system of a Book Income Indices System;

FIG. 21 is of a block diagram illustrating embodiments of the present system of a Book Income Indices System;

FIG. 22 is of a logic flow diagram illustrating embodiments of the present system of a Book Income Indices System;

FIG. 23 is of a block diagram illustrating embodiments of the present system of a Book Income Indices System;

FIG. 24 is of a logic flow diagram illustrating embodiments of the present system of a Book Income Indices System;

FIG. 25 is of a block diagram illustrating embodiments of the present system of a Book Income Indices System;

FIG. 26 is of a logic flow diagram illustrating embodiments of the present system of a Book Income Indices System;

FIG. 27 is of a block diagram illustrating embodiments of the present system of a Book Income Indices System;

FIG. 28 is of a logic flow diagram illustrating embodiments of the present system of a Book Income Indices System;

FIG. 29 is of a block diagram illustrating embodiments of the present system of a Book Income Indices System;

FIG. 30 is of a logic flow diagram illustrating embodiments of the present system of a Book Income Indices System;

FIG. 31 is of a block diagram illustrating embodiments of the present system of a Book Income Indices System;

FIG. 32 is of a logic flow diagram illustrating embodiments of the present system of a Book Income Indices System;

FIG. 33 is of a block diagram illustrating embodiments of the present system of a Book Income Indices System;

FIG. 34 is of a block diagram illustrating embodiments of the present system of a Book Income Indices System;

FIG. 35 is of a block diagram illustrating embodiments of the present system of a Book Income Indices System;

FIGS. 36, 37 and 38 are of a logic flow diagram illustrating embodiments of the present system of a Book Income Indices System;

FIG. 39 is of a block diagram illustrating embodiments of the present system of a Book Income Indices System;

FIGS. 40, 41 and 42 are of a logic flow diagram illustrating embodiments of the present system of a Book Income Indices System;

FIG. 43 is of a block diagram illustrating embodiments of the present system of a Book Income Indices System;

FIGS. 44A and 44B are of a logic flow diagram illustrating embodiments of the present system of a Book Income Indices System;

FIG. 45 is of a chart illustrating various reinvestment strategies of embodiments of the present system of a Book Income Indices System as compared to a market index;

FIG. 46 is of a logic flow diagram illustrating embodiments of the present system of a Book Income Indices System;

FIG. 47 is of a block diagram illustrating embodiments of the present system of a Book Income Indices System;

FIG. 48 is of a chart depicting a series of hypothetical deposits or withdrawals and capital gain/loss limits;

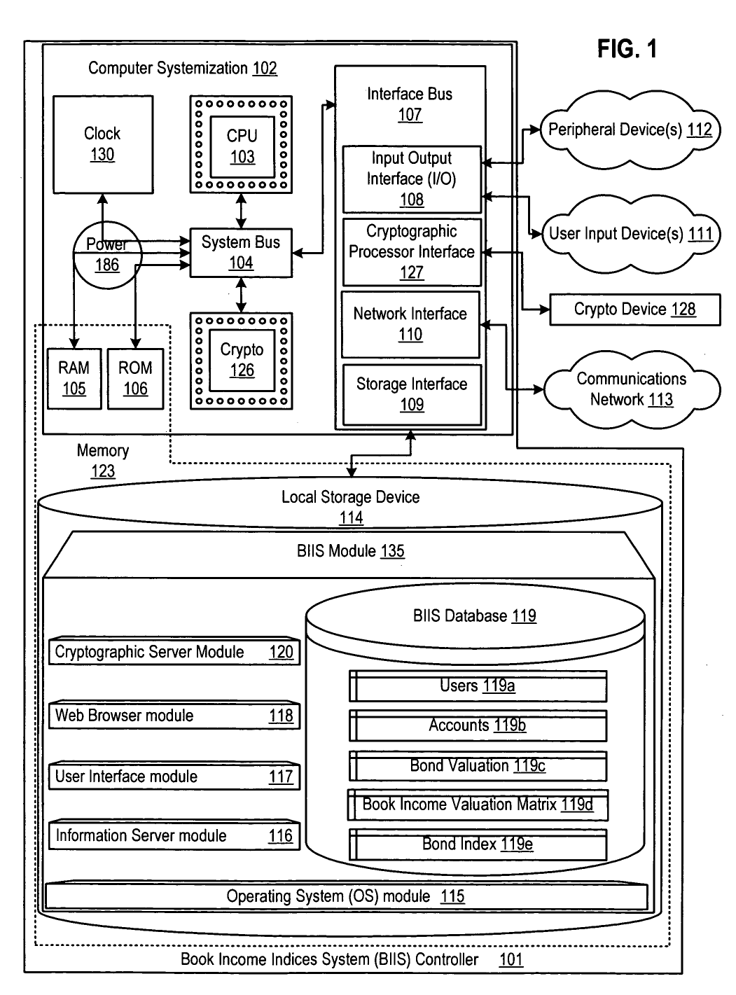

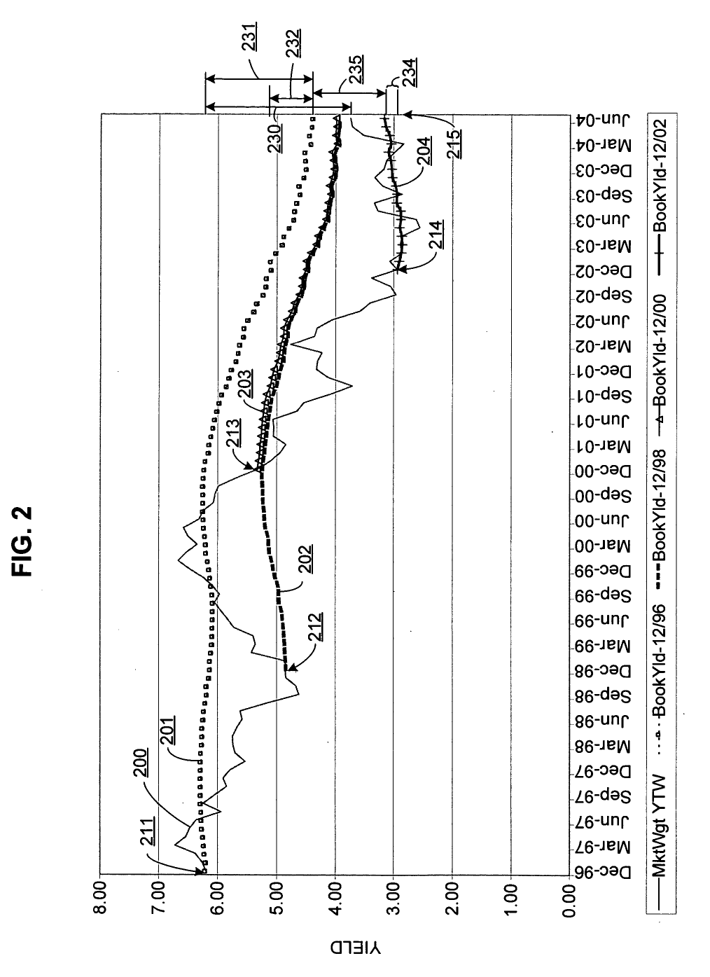

For ease of reference, the leading number of each reference number within the drawings indicates the first figure in which that reference number is introduced. As such, reference number 101 is first introduced in FIG. 1. Reference number 201 is first introduced in FIG. 2, etc.

### DETAILED DESCRIPTION

This disclosure provides a detailed explanation of the methodology used to construct book income indices. It includes several case studies that illustrate various applications of book income index performance measurement techniques for several hypothetical portfolios, including assumptions regarding policies, cash flow, cash flow timing, buy and hold constraints, and gain/loss constraints. The disclosed embodiments are representative only and are not exhaustive and/or exclusive. They are presented to assist in understanding the system. Further benefits and embodiments will become clear upon a reading of this disclosure. It should be understood that they are not representative of all systems defined by the claims, to be considered limitations on the system as defined by the claims, or limitations on equivalents to the claims. For instance, some of these embodiments may be mutually contradictory, in that they cannot be simultaneously present in a single embodiment. Thus, this summary of features and advantages are of a representative sample and should not be considered exhaustive, exclusive, and/or dispositive in determining equivalence. Additional features and advantages of the system will become apparent in the following description, from the drawings, and from the claims. As such, certain aspects of the disclosure have not been discussed herein. That alternate embodiments may not have been presented for a specific portion of the system or that further undescribed alternate embodiments may be available for a portion is not to be considered a disclaimer of those alternate embodiments. It will be appreciated that many of those undescribed embodiments incorporate the same principles of the system and others are equivalent. Thus, it is to be understood that other embodiments may be utilized and functional, logical, organizational, sequence, structural, temporal, and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of space and reducing repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. In describing embodiments of the system, in some cases, specific terminology has been used for the sake of clarity, however, the system is not intended to be limited to and/or by the specific terms so selected, and it is to be understood that each specific term includes all technical equivalents which operate in a similar manner to accomplish a similar purpose. It should be noted that terms and or phraseology in this disclosure are not exhaustive in detail, and are not provided as definitive definitions. Rather, the terms are provided herein simply as an aid to the reader. The terms are not limiting of the disclosure and/or claims herein. The use of the terms may contemplate any of the broader, and/or multiple meanings found in common use, dictionaries, technical dictionaries, and/or in actual use in the technical arts, as well as any broadening made throughout this disclosure. As such, some of these features may be mutually contradictory, in that they cannot be simultaneously present in a single embodiment. Similarly, some features are applicable to one aspect of the system, and inapplicable to others. In addition, the disclosure includes other systems not presently claimed. Applicant reserves all rights in those presently unclaimed systems including the right to claim such systems, file additional applications, continuations, continuations in part, divisions, and/or the like thereof. As such, it should be understood that aspects of the disclosure such as advantages, embodiments, examples, features, functional, logical, organizational, sequence, structural, temporal, topological, and/or other aspects are not to be considered limitations on the disclosure as defined by the claims or limitations on equivalents to the claims.

The use of the terms purchase, purchases, purchasing, purchased, sell, sale, sales, selling, sold, and/or the like as used herein are obviously not intended to indicate an actual acquisition in exchange for value and should not be restricted to such use. These terms are simply used for convenience as a way to describe the concept of determining and calculating which assets are incorporated or removed and the circumstances surrounding such incorporation or removal. The use of numbers or values is not intended to restrict the system in any way. Any numbers used are hypothetical. No weight should be given to their use and/or selection except as to assist with understanding the system. It is possible that in the operation of the apparatus, method, and system, numbers may be rounded, deemed relatively equal, roughly estimated, and/or the like in order to allow the system to operate properly and smoothly.

Book Income Indices System Controller

FIG. 1 is of a block diagram illustrating non-limiting embodiments of aspects of a Book Income Indices System (BIIS) controller 101. In this embodiment, the BIIS controller 101 may serve to process, store, search, serve, identify, instruct, generate, match, and/or update recordings, expirations, and/or other related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. A computer operating system, which, typically, is software executed by a CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, which is commonly facilitated through database software. Information technology systems provide interfaces that allow users to access and operate various system components.

In one embodiment, the BIIS controller 101 may be connected to and/or communicate with entities such as, but not limited to: one or more users from user input devices 111; peripheral devices 112; a cryptographic processor device 128; and/or a communications network 113.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

A BIIS controller 101 may be based on common computer systems that may comprise, but are not limited to, components such as: a computer systemization 102 connected to memory 123.

Computer Systemization

A computer systemization 102 may comprise a clock 130, a CPU 103, a read only memory (ROM) 106, a random access memory (RAM) 105, and/or an interface bus 107, and most frequently, although not necessarily, are all interconnected and/or communicating through a system bus 104. Optionally, the computer systemization may be connected to an internal power source 186. Optionally, a cryptographic processor 126 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or connected through another device that is connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron and/or Opteron; IBM and/or Motorola's PowerPC; Intel's Celeron, Itanium, Pentium, Xeon, and/or XScale; and/or the like processor(s). The CPU interacts with memory through signal passing through conductive conduits to execute stored program code according to conventional data processing techniques. Such signal passing facilitates communication within the BIIS controller and beyond through various interfaces. Should processing requirements dictate a greater amount of speed, parallel, mainframe and/or super-computer architectures may similarly be employed. Alternatively, should deployment requirements dictate greater portability, smaller Personal Digital Assistants (PDAs) may be employed. Alternatively, any device capable of performing similar or comparable functions may be employed.

Power Source

The power source 186 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 186 is connected to at least one of the interconnected subsequent components of the BIIS controller thereby providing an electric current to all subsequent components. In one example, the power source 186 is connected to the system bus component 104. In an alternative embodiment, an outside power source 186 is provided through a connection across the Input Output (I/O) interface 108. For example, a USB and/or IEEE 1394 connection carries both data and power across the connection and is therefore a suitable source of power.

Interface Adapters

Interface bus(ses) 107 may accept, connect, and/or communicate to a number of interface adapters, conventionally although not necessarily in the form of adapter cards, such as but not limited to: Input Output interfaces (I/O) 108, storage interfaces 109, network interfaces 110, and/or the like. Optionally, cryptographic processor interfaces 127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 109 may accept, communicate, and/or connect to a number of storage devices such as, but not limited to: storage devices 114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 110 may accept, communicate, and/or connect to a communications network 113. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 110 may be used to engage with various communications network types 113. Such communications networks 113 may provide, for example, input and/or output from and/or to a user, and/or the like. For example, multiple network interfaces may be employed to allow for the communication over broadcast, multicast, and/or unicast networks.

Input Output interfaces (I/O) 108 may accept, communicate, and/or connect to user input devices 111, peripheral devices 112, cryptographic processor devices 128, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a/b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 111 may be card readers, dongles, finger print readers, gloves, graphics tablets, joysticks, keyboards, mouse (mice), remote controls, retina readers, trackballs, trackpads, and/or the like.

Peripheral devices 112 may be connected and/or communicate with I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the BIIS controller may be embodied as an embedded, dedicated, and/or monitor-less (i.e., headless) device, wherein access would be provided over a network interface connection.

Cryptographic units such as, but not limited to, microcontrollers, processors 126, interfaces 127, and/or devices 128 may be attached, and/or communicate with the BIIS controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 123. However, memory is a fungible technology and resource, thus, any number of memory embodiments may be employed in lieu of or in concert with one another. It is to be understood that a BIIS controller and/or a computer systemization may employ various forms of memory 123. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 123 will include ROM 106, RAM 105, and a storage device 114. A storage device 114 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

Module Collection

The memory 123 may contain a collection of program and/or database modules and/or data such as, but not limited to: operating system module(s) 115 (operating system); information server module(s) 116 (information server); user interface module(s) 117 (user interface); Web browser module(s) 118 (Web browser); database(s) 119; cryptographic server module(s) 120 (cryptographic server); BIIS module(s) 135; and/or the like (i.e., collectively a module collection). These modules may be stored and accessed from the storage device(s) and/or from storage devices accessible through an interface bus. Although non-conventional software modules such as those in the module collection, typically, are stored in a local storage device 114, they may also be loaded and/or stored in memory such as: peripheral devices, RAM, remote storage facilities through a communications network, ROM, various forms of memory, and/or the like.

Operating System

The operating system module 115 is executable program code facilitating the operation of a BIIS controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Palm OS, Microsoft Windows 2000/2003/3.1/95/98/CE/Millenium/NT/XP (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the BIIS controller to communicate with other entities through a communications network 113. Various communication protocols may be used by the BIIS controller as a subcarrier transport mechanism for interaction, such as, but not limited to: multicast, TCP/IP, UDP, unicast, and/or the like.

Information Server

An information server module 116 is stored program code that is executed by the CPU. The information server may be a conventional Internet information server such as, but not limited to Apache Software Foundation's Apache, Microsoft's Internet Information Server, and/or the like. The information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on a BIIS controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other modules in a module collection, including itself, and/or facilities of the like. Most frequently, the information server communicates with the BIIS database 119, operating systems, other program modules, user interfaces, Web browsers, and/or the like.

Access to the BIIS database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the BIIS. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the BIIS as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program module, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface module 117 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X-Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Web Browser

A Web browser module 118 is stored program code that is executed by the CPU. The Web browser may be a conventional hypertext viewing application such as Microsoft Internet Explorer or Netscape Navigator. Secure Web browsing may be supplied with 128-bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from BIIS enabled nodes. The combined application may be nugatory on systems employing standard Web browsers.

Cryptographic Server

A cryptographic server module 120 is stored program code that is executed by the CPU, cryptographic processor 126, cryptographic processor interface 127, cryptographic processor device 128, and/or the like. Cryptographic processor interfaces will allow for expedition of encryption and/or decryption requests by the cryptographic module; however, the cryptographic module, alternatively, may run on a conventional CPU. The cryptographic module allows for the encryption and/or decryption of provided data. The cryptographic module allows for both symmetric and asymmetric (e.g., Pretty Good Protection (PGP)) encryption and/or decryption. The cryptographic module may employ cryptographic techniques such as, but not limited to: digital certificates (e.g., X.509 authentication framework), digital signatures, dual signatures, enveloping, password access protection, public key management, and/or the like. The cryptographic module will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the BIIS controller may encrypt all incoming and/or outgoing communications and may serve as a node within a virtual private network (VPN) with a wider communications network. The cryptographic module facilitates the process of “security authorization” whereby access to a resource is inhibited by a security protocol wherein the cryptographic module effects authorized access to the secured resource. In addition, the cryptographic module may provide unique identifiers of content, e.g., employing MD5 hash function to obtain a unique signature for a digital audio file. A cryptographic module may communicate to and/or with other modules in a module collection, including itself, and/or facilities of the like. The cryptographic module supports encryption schemes allowing for the secure transmission of information across a communications network to enable a BIIS module to engage in secure transactions if so desired. The cryptographic module facilitates the secure accessing of resources on BIIS and facilitates the access of secured resources on remote systems; i.e., it may act as a client and/or server of secured resources. Most frequently, the cryptographic module communicates with information servers, operating systems, other program modules, and/or the like. The cryptographic module may contain, communicate, generate, obtain, and/or provide program module, system, user, and/or data communications, requests, and/or responses.

BIIS Database

A BIIS database module 119 may be embodied in a database and its stored data. The database is stored program code, which is executed by the CPU; the stored program code portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the BIIS database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the BIIS database is implemented as a data-structure, the use of the BIIS database 119 may be integrated into another module such as the BIIS module 135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the BIIS Database module 119 includes several tables 119a-e. A users table 119a includes fields such as, but not limited to: a user name, address, user_id, and/or the like. The user table may support and/or track multiple entity accounts on a BIIS. An accounts table 119b includes fields such as, but not limited to: account_id, admin_user_id (a user given administrative status to control the account), account_level, account_info, account_portfolio_data and/or the like. A bond_valuation table 119c includes fields such as, but not limited to: bond_id, bond_value, bond_date and/or the like. A book_income_valuation_matrix table 119d includes fields such as, but not limited to: bond_id, bond_date_range, and/or the like. A bond_index table 119e includes fields such as, but not limited to: bond_valuation_matrix, index_rules., index_holdings, index_performance_results, index_characteristics, e.g., where index rules drive the holdings. This embodiment is one of many of possible embodiments of BIIS Database module 119 and is not exhaustive and/or exclusive.

In one embodiment, the BIIS database may interact with other database systems. For example, employing a distributed database system, queries and data access by BIIS modules may treat the combination of the BIIS database, an integrated data security layer database, as a single database entity.

In one embodiment, user programs may contain various user interface primitives, which may serve to update the BIIS. Also, various accounts may require custom database tables depending upon the environments and the types of clients a BIIS may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database modules 119a-e. The BIIS may be configured to keep track of various settings, inputs, and parameters via database controllers.

A BIIS database may communicate to and/or with other modules in a module collection, including itself, and/or facilities of the like. Most frequently, the BIIS database communicates with a BIIS module, other program modules, and/or the like. The database may contain, retain, and provide information regarding other nodes and data.

BIIS

A BIIS module 135 is stored program code that is executed by the CPU 103. The BIIS affects accessing, obtaining and the provision of information, services, transactions, and/or the like across various communications networks.

The BIIS enables methodologies for the performance measurement of a book income portfolio. The BIIS coordinates with the BIIS database to generate indices.

A BIIS module enabling access of information between nodes may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scripts, SQL commands, web application server extensions, WebObjects, and/or the like. In one embodiment, the BIIS server employs a cryptographic server to encrypt and decrypt communications. A BIIS module may communicate to and/or with other modules in a module collection, including itself, and/or facilities of the like. Most frequently, the BIIS module communicates with a BIIS database, operating systems, other program modules, and/or the like. The BIIS may contain, communicate, generate, obtain, and/or provide program module, system, user, and/or data communications, requests, and/or responses.

Distributed BIIS

The structure and/or operation of any of the BIIS node controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The preferred configuration of the BIIS controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The BIIS controller 101 enables the implementation of a BIIS and the performance measurement of a Book Income Index (BII), including the generation, operation, processing, calculating, and/or the like of indices in accordance with such performance measurement. Once performance monitoring needs have been assessed, the BIIS controller may be implemented to resolve these needs enabling the administration of processes inline with those discussed herein and inline with a BIIS as discussed herein.

It is to be understood that the logical and/or topological structure of any combination of the module collection and/or the present system as described in the figures and throughout herein are not limited to a fixed execution order and/or arrangement, but rather, any disclosed order is exemplary and all functional equivalents, regardless of order are contemplated by the disclosure. Furthermore, it is to be understood that such structures are not limited to serial execution, but rather, any number of threads, processes, services, servers, and/or the like that may execute asynchronously, simultaneously, synchronously, and/or the like are contemplated by the disclosure.

Establishing a Book Income Index

Indexing is a common practice in many environments and a common practice in investment markets. An index provides a statistical composite for measuring changes in variable data, such as for example, but not limited to, a financial market, commodity value, production output, and/or the like. There are innumerable examples of indices, such as the Dow Jones Industrial Average, the Consumer Price Index, the Merrill Lynch Global Emerging Markets Sovereign Plus Index, and/or the like. An index may be as narrow or as broad as desired to measure a preferred set of characteristics and/or data.

Indices also have a variety of uses, many of which are known. One such use of an index is as a benchmark, providing a tool for comparison or point of reference or standard by which something may be measured. For example, a producer of a commodity may wish to compare the price of their product to the price of other commodities in the market. Another example may be the use of an index as a point of reference by which the performance of a securities portfolio may be measured over time. In doing so, an index may be constructed of designated securities that fit a given profile inline with desired preferences for the index. For example, an index may be constructed with holdings that meet the policy guidelines established for a portfolio. A use of such an index might provide a point of reference by which to measure the value of a portfolio manager's selection of portfolio holdings within its established guidelines. This index may be used to provide any defined set of data for comparison of similar data generated by the portfolio. For example, the performance statistics of a portfolio may be compared against the performance statistics of a comparable index used as a benchmark for the portfolio.

A Book Income Index (BII) is no different and provides all of the benefits of an index, but in terms of assets recorded on an historical cost-based accounting method. A BIIS as described herein enables the compilation of one or more book income indices and for the implementation, operation, and/or the like of such book income indices. A BII may measure and/or track financial data and/or changes in financial data including changes in values as well as changes in values recorded on an historical cost-based accounting method.

A BII may begin with the selection of constituent assets. The determination of constituent assets depends upon the needs for indexing and/or purpose of the index. The underlying constituents may be any variety of assets meeting a set of desired characteristics. The constituents of a standard market-based index may, in fact, be sufficient in meeting these needs or desired characteristics. It may be, however, that a more customized index is necessary, taking into account certain performance monitoring needs and/or preferences unaccounted for in standard market-based indices. In this case, a customized index may be created inline with these particular needs and/or preferences. For example, an index may be customized to take account of policy guidelines, duration needs, asset allocation decisions, or other performance monitoring needs and/or concerns.

For example, if the performance monitoring needs pertain to the change in market value of corporate high yield bonds over a three month period, a standard market-based index may exist providing the composite of assets to monitor over the three month period. However, if the performance monitoring needs pertain to a certain subset of bonds meeting specific maturity date needs or other guidelines, an index may be customized to meet these needs.

The constituents of a BIIS may be selected and/or determined and form a base-line BII. This base-line index acts much like any index and/or BII. A base-line index may provide a basis for recording, maintaining, monitoring, and/or the like the holdings established for the BIIS. A base-line index acts like a foundation for the BIIS, from which a BII may be derived allowing for further manipulation, processing, calculation, and/or the like without affecting the base-line index.

For example, if a BIIS incorporates a base-line index, book income indices may be created within the BIIS depicting mirror images of the base-line index at a given point in time or incorporating a subset of the data existing in the base-line index. These additional indices may be manipulated in accordance with performance monitoring needs and monitored as separate indices without affecting the base-line index.

Determining the Value of a Book Income Index

The methodology in determining the value of holdings in a BII varies from the methodology used in determining, for example, the value of holdings in a total return index. Unlike a total return index, which is marked to market at any given point or on any set basis, the assets in a BII may be recorded on a marked to market basis and/or on an historical cost-based accounting method.

For purposes of illustration, a BII of bond holdings may be used to understand the construction and/or valuation of a BII. For example, in one embodiment, on its inception date, an index may acquire its initial holdings at market yields and prices. Thereafter, holdings that are retained in the index are recorded and maintained at a constant book yield, which is the market yield of the constituents on the index inception date. Book prices on each subsequent valuation date may then be derived based on the book yield and a settlement date equal to the valuation date. Similarly, issues that enter the index after the inception date are acquired at their market yields and prices on their respective dates of entry into the index. Thereafter, the book yields of these issues are held constant and are the basis for calculating book prices.

Given these book price valuations, the ordinary income for a given constituent/index may be calculated as follows:

$$Ordinary Income Percentage = \frac{\begin{matrix}\begin{matrix}( change in book price ) + \\ ( change in accured interest ) +\end{matrix} \\ ( coupons recieved )\end{matrix}}{beginning book value}$$

Indices tend to be dynamic, changing over time, incorporating new constituents and removing existing constituents. A constituent may be removed from an index for a variety of reasons including, but not limited to, for example, the constituent may have been redeemed, or may no longer meet the qualification requirements of an index, and/or the like. For example, if the index is a bond index, the bond may no longer meet the maturity requirements, the bond rating may have been downgraded or upgraded, the bond may have been called or matured, and/or the like.

Whatever the reason for removal, an index may also account for any “realized” capital gains or losses resulting from the “sale” or removal of these constituents from an index at their points of exit, which may account for any appreciation or depreciation in the market value of the constituent being removed as compared to the constituent's book value on the date of removal. Capital gain, capital loss, and/or capital gain/loss percentage may be calculated. The capital gain/loss percentage of a constituent/index may be calculated as follows:

$$Capital Gain / Loss Percentage = \frac{\begin{matrix}( market price on date of exit ) - \\ ( book price on date of exit )\end{matrix}}{beginning book value}$$

The book income return percentage may be summarized as follows:
Book Income Return Percentage=Ordinary Income Percentage+Capital Gain/Loss Percentage
Calculating Book Prices

The holdings of a BII may consist of any number of assets including, for example, but not limited to, fixed yield, non-optionable securities. For most of these securities the calculation of book prices usually follows a direct path. For example, the book price may be obtained by performing a yield to price calculation using the book yield and a settlement date equal to, for example, the current book valuation date or any other set date for calculation. The book yield may be established at the constituent's point of entry into the index and may be held constant thereafter until it departs the index. For optionable securities, such as callable bonds or U.S. mortgages, however, it may be necessary to revaluate the book yield over time.

For example, one embodiment may involve the use of call/put bonds. On their original date of entry into an index, call/put bonds may be recorded and maintained at their yield-to-worst with a notation of the associated workout redemption date and redemption value. Thereafter, book prices may be derived by performing a yield to price calculation using the original purchase yield-to-worst, workout redemption date, and workout redemption value along with a settlement date equal to the book valuation date. If a bond is not redeemed on its originally estimated workout redemption date, then a new yield-to-worst and workout redemption date may then be calculated using the current book price (for example, as of the originally estimated workout redemption date) and the remaining schedule of redemption dates and values.

Another illustrative example involves the use of U.S. mortgage pass-through securities. Standard accounting procedures for U.S. mortgage securities require that the book yield of a mortgage pass-through security be updated regularly to take account of actual cash flows received since the date of purchase and new projections for future cash flows. In one embodiment, this may be accounted for. For example, a bond valuation database may update the full cash flow schedule of every mortgage security on a set or regular basis, combining the actual cash flows from the date of entry into the index with the newly forecast schedule of future cash flows based on updated assumptions. This amended cash flow schedule, together with the original purchase price, may be used to derive an updated book yield as of the new book valuation date. The revised book yield and the newly projected schedule of future cash flows may then be used to derive a new book price.

Various accounting methods may be used in the valuation of an index, portfolio, benchmark portfolio, security, and/or the like. In one embodiment, the accounting methods used to value a portfolio may be the same as the principals used to value a benchmark index for that portfolio.

Factoring in the Timing of Cash Flows

In one embodiment of the BIIS, it may be desirable to consider cash flows into and out of an index subsequent to the date of inception of the index. It may be desirable to factor in the amount and timing of cash flows into and out of an index. These index cash flows may, for example, reflect cash flows into and out of a portfolio being benchmarked. The point in time at which an index acquires and/or loses a holding or holdings may have significant impact upon the book income metrics of the index and its holdings. For example, the date an index acquires a holding may affect the book yield of the holding, the overall book yield of the index currently, and the reported ordinary income and recognized gains and losses going forward.

For example, a portfolio that acquired the bulk of its holdings in December 1996, due to an influx of cash for example, will likely have different book yields when compared to a portfolio that acquired the bulk of its holdings in December 2002. This is due to the fact that the book yields available to the portfolio manager in December 1996 were different than those available in December 2002. The same is obviously true for an index. Therefore, an index that acquired the bulk of its holdings in, for example, December 1996 will likely have different characteristics, including book yields, when compared to an index that acquired the bulk of its holdings in, for example, December of 2002. Hence, an index that acquired the bulk of its holdings in December 1996 is not a suitable point of comparison for a portfolio that acquired the bulk of its holdings in 2002. A negative cash flow, as well as the timing of a negative cash flow, may have similar effects.

To illustrate the magnitude of this difference, consider four different book income indices, each fully invested in the broad U.S. Treasury market. FIG. 2 illustrates a chart of the market yield of the Merrill Lynch U.S. Treasury Index and various book yields assuming a full acquisition of the holdings of the Merrill Lynch U.S. Treasury Index at different points in time and subsequent replication of all index re-balancing transactions thereafter. Line 200 charts the market yield of the Merrill Lynch U.S. Treasury Index. Lines 201, 202, 203, and 204 chart the book yields of four book income indices with inception dates marked at points 211, 212, 213, and 214, respectively.

These dates may coincide with the initial funding date of a portfolio, be set hypothetically, correspond to certain events, and/or be set for any number of reasons. In one hypothetical example, these dates may correspond with the initial funding of four portfolios, each with no subsequent deposits or withdrawals: portfolio A initially funded in December 1996, portfolio B initially funded in December 1998, portfolio C initially funded in December 2000, and portfolio D initially funded in December 2002. It may be desirable in some instances to accommodate for alignment of the inception date of an index to the initial funding date of a portfolio for purposes of performance monitoring, creating hypothetical scenarios, establishing benchmarks, and/or the like.

In FIG. 2, the market yield of the Treasury Index 200 declined almost 250 basis points between 1996 and 2004, illustrated by range 230. Assuming an index 201 has an inception date 211 of December 31, 1996, the book yield of the index 201 would be equal to the market yield for the index 200 on that date 211. The book yield of this index 201 declined during the same period, though not as much as the market yield of the index 200. The book yield of index 201 decreased by 182 basis points, illustrated by range 231. One likely cause of this is that the index 201 maintains many of the holdings that were acquired in Dec. 31, 1996, at point 211, and these holdings are carried at their 1996 book yield levels, which are higher than the market yields of those securities in 2004. On Dec. 31, 2002, at point 214, around 40% of the index 201 was comprised of constituents acquired back in 1996, at point 211.

By Jun. 30, 2004, at point 215, the book yield gap between the index 201 with an inception date of Dec. 31, 1996, at point 211, and the index 204 with an inception date of Dec. 31, 2002, at point 214, was 122 basis points, illustrated by range 235. All other things being equal, it stands to reason that portfolios A and D should also have significantly different book yields, given their distinct inception dates and the state of the market index 200 as it existed on each inception date. According to FIG. 2, the market yield of the index 200 on Dec. 31, 1996, at point 211, was different than the market yield of the index 200 on Dec. 31, 2002, at point 214.

For the 18 months ending Jun. 30, 2004, at point 215, the average book yield of the index 201 with a Dec. 31, 1996 inception, at point 211, fell 71 basis points, illustrated by range 232, while the average book yield of the index 204 with a Dec. 31, 2002 inception date, at point 214, actually rose by 23 basis points, illustrated by range 234.

We would therefore expect that the book yields of hypothetical portfolios A and D—both invested in exactly the same securities—should also move in opposite directions during this measurement period.

Listed below is a chart illustrating the changes in book yields of the indices discussed with respect to FIG. 2:

U.S. Treasury Index Book Yield

| | Market | Index | Index | Index | Index | |
|---|---|---|---|---|---|---|
| Change in Yield: | Yield | 201 | 202 | 203 | 204 | '96 vs '02 |
| Last 6 months | 0.58 | −0.11 | −0.05 | −0.04 | 0.14 | 0.25 |
| Last 12 months | 1.13 | −0.33 | −0.20 | −0.17 | 0.29 | 0.61 |
| Last 18 months | 0.81 | −0.71 | −0.53 | −0.51 | 0.23 | 0.94 |

Index 202, with an inception date of Dec. 31, 1998, at point 212, and index 203, with an inception date of Dec. 31, 2000, at point 213, finished with very similar book yields by pure coincidence. This simple illustration, of course, does not take into account the fact that deposits and withdrawals to and from the portfolio after its initial funding may occur and would also likely affect book yield levels. This is addressed below.

Establishing a Base-Line Index

As discussed above, a base-line index may be created to provide a foundation for the BIIS to operate from. A base-line index is just one type of index, operating in the same manner as an index would operate. A base-line index may provide a basis for other indices to be derived from it, allowing multiple indices stemming from the same base-line index. Each derived index and its holdings may then be manipulated, monitored, processed, calculated, and/or the like as could be done with any index. A benefit of a base-line index is that any action performed on or with an index derived from the base-line index may not impact the base-line index.

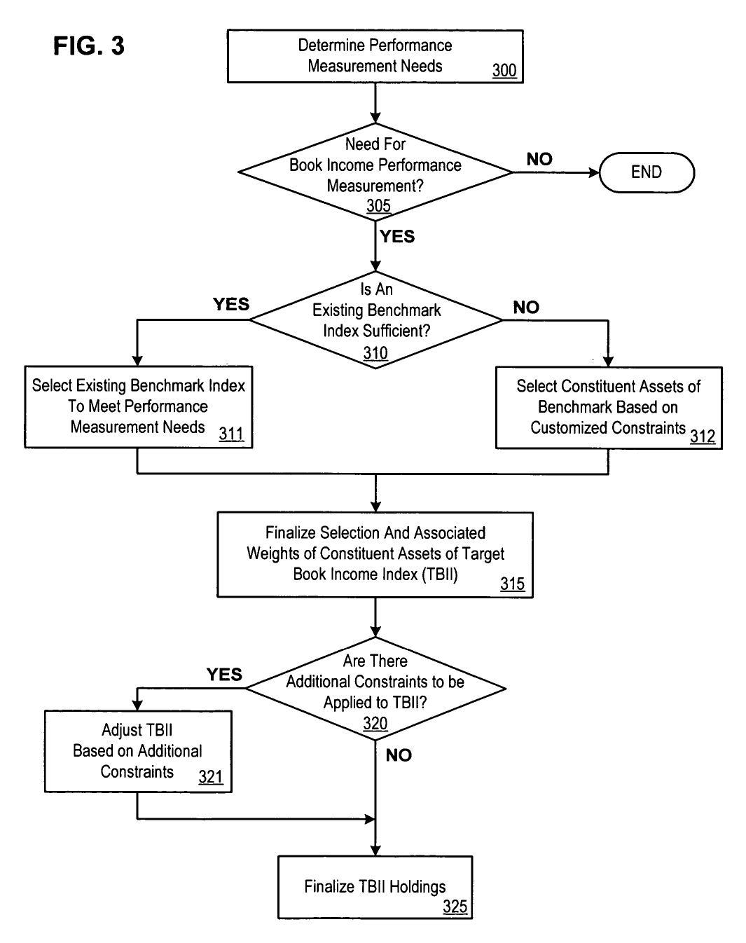

FIG. 3 provides a data logic flow diagram for the creation of a base-line index or Target Book Income Index (TBII). This base-line index or TBII may then be used with a BIIS. While it is not necessary that a TBII be created exactly as depicted in FIG. 3, or that a base-line TBII be created at all, this illustration provides a useful example for the creation of one. Similar methods may be used inline with this example.

The first step in this process entails determining the performance measurement needs 300. This may involve a number of sub-processes and decisions outlining what preferences and/or needs should be meet by the performance monitoring. For example, a user should determine what the frequency of the performance monitoring is, the level of detail to be measured, the extensiveness of the data necessary, the characteristics of constituents whose performance is to be measured, whether the performance measurement is for use with an investment portfolio, how the performance is to be measured and/or monitored, and/or any number of variables relevant to the decision and determination of performance measurement.

Once these determinations 300 have been made, it should be decided if the performance measurement needs 300 involve the performance of book income assets accounted for on an historical cost-based accounting method 305. If they are not, there is no need to continue with this process. If book income performance measurement 305 is involved, it may next be determined whether an existing benchmark index exists 310 that might be sufficient to meet the performance measurement needs determined 300 previously. As stated elsewhere herein, the order of steps discussed herein are not necessarily restrictive. In many cases steps may be taken out of order, where they do not render the process inoperable or illogical, without departing from the scope and/or spirit of the disclosure.

A positive response to query 310, leads to the selection of an index 311. If an existing benchmark index may be used to meet the performance needs 300, this index may be selected 311 for use as a TBII. If it is determined 310 that existing indices are insufficient to meet the performance needs 300, a customized TBII may be created 312. This customized TBII may be created using a variety of methods to define and/or determine the constituents of the index.

Regardless of how the TBII was formed, whether via an existing benchmark index 311 or via a customized selection of constituents 312, the selection of constituents should be finalized and the associated weights of each constituent asset in the TBII established 315.

Once a TBII has been established, it should be determined whether there are additional constraints that are applicable to the TBII 320. There are a variety of additional constraints that may be applicable to a TBII depending upon the performance measurement needs and/or preferences. For example, buy and hold requirements may be imposed for one or more of the constituents of a TBII. If there are additional applicable constraints, the TBII should be modified in accordance with these constraints 321. If there are no additional applicable constraints, this process may continue without further deliberation. At this point, the TBII may be finalized for implementation into a BIIS 325.

Determination of BII Inception Date Holdings

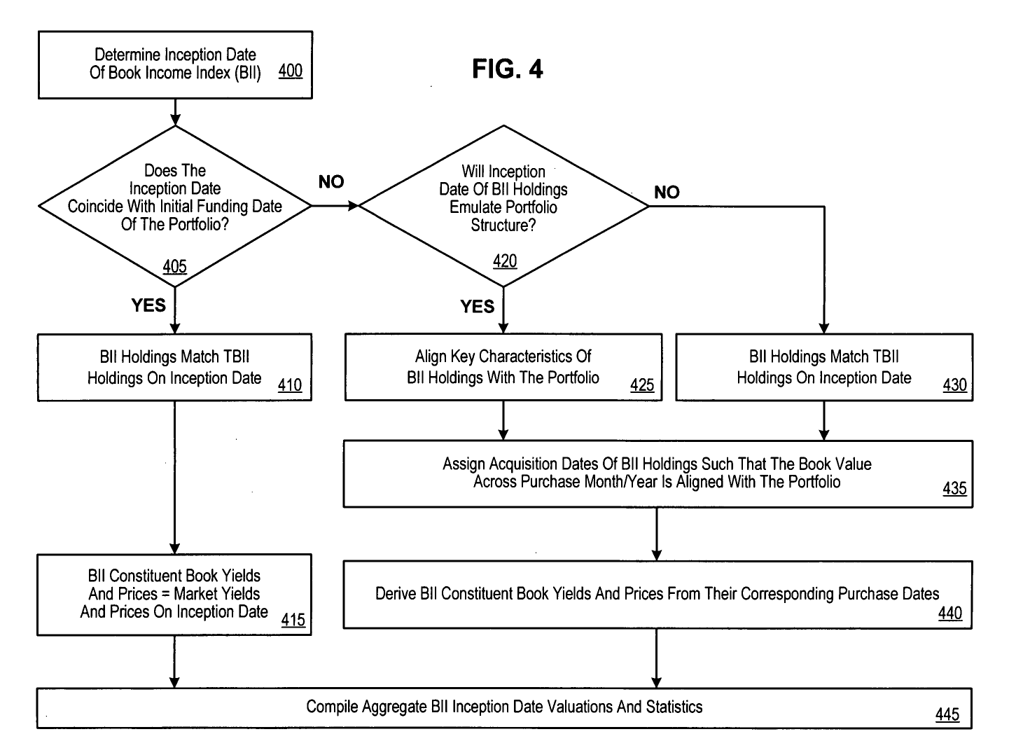

FIG. 4 illustrates various processes as examples for determining and establishing the inception date holdings of a BII.

A BII inception date is the date at which the BII is set to begin performance monitoring. The initial BII structure on that date must be established including, but not limited to, the initial size of the BII, what holdings make up the BII, the weightings of the holdings, the purchase dates and associated book yields of the holdings, and/or the like. So, the first step in this illustration is to determine 400 the inception date of this hypothetical BII.

A common use of an index, as discussed above, is as a performance benchmark, providing a point of reference or standard by which the performance of a portfolio may be measured, compared, and/or contrasted. For example, a portfolio of fixed income assets may be benchmarked against a fixed income index with characteristics inline with the policy guidelines for the portfolio. Here, a TBII, with characteristics inline with the policy guidelines for the portfolio, may be used as a fixed income index.

If the BII inception date coincides with the initial funding date of this portfolio 405, the holdings of the BII may be determined and/or established 410, reflecting the current holdings of the TBII on the date of the BII's inception and the portfolio value on that date. This incorporates the characteristics of the current TBII holdings as they existed in the market as of the date of the BII's inception, including the values, yields, prices, weightings and/or other characteristics of the TBII holdings. So, on the inception date, book yields and prices of the BII constituents will be equal to the market yield and prices of the BII constituents on that date 415.

At this point the aggregate valuations, statistics, metrics, and/or the like may be compiled 445. This may involve a determination and/or calculation of any number of statistics that may be desired as part of the performance monitoring.

If the inception date of the BII does not coincide with the initial funding date of the portfolio 405, the next question is whether the structure of the holdings of the BII at the BII's inception date are to emulate the structure of the portfolio 420. There are several reasons for emulating the portfolio structure at the start of the performance measurement period. One reason is if a new internal or external portfolio manager was recently assigned responsibility for management of the portfolio and the performance measurement preferences was to provide statistics relevant to this particular manager. A second reason is if the policy guidelines were recently revised and/or the TBII was adjusted. A third reason is if the index is intended to measure the performance of current period investment decisions.

If the BII is to emulate the portfolio 420, steps must be taken to align key characteristics of the BII and its holdings with the characteristics of the portfolio 425. Examples of this might entail matching portfolio characteristics such as asset class allocations, duration, and book yield to name a few. In addition, the size of the index at inception of the BII may be scaled to the size of the portfolio on that date.

In addition to the alignment of other characteristics, the acquisition or “purchase” dates of the inception-date BII holdings may be aligned with the purchase dates of the portfolio holdings 435. This alignment may involve assigning acquisition dates to each of the BII holdings such that the distribution of the book values of BII holdings across purchase periods closely matches the corresponding distribution of the book values of the portfolio.

Once acquisition dates have been assigned to each of the BII holdings, the initial book yields and book prices of the BII constituents may be determined based on their corresponding “purchase” or acquisition dates 440. The aggregate valuations, statistics, metrics, and/or the like may now be compiled 445.

If the holdings of the BII at the BII's inception are not to be structured to emulate portfolio structure 420, the BII holdings may be determined and/or established reflecting the current holdings of the TBII on the BII's inception date 430.

The acquisition or “purchase” dates of the inception-date BII holdings may be aligned with the purchase dates of the portfolio holdings 435. This alignment may involve assigning acquisition dates to each of the BII holdings such that the distribution of the book values of BII holdings across purchase periods closely matches the corresponding distribution of the book values of the portfolio.

Once acquisition dates have been assigned to each of the BII holdings, the initial book yields and book prices of the BII constituents may be determined based on their corresponding “purchase” or acquisition dates 440. The aggregate valuations, statistics, metrics, and/or the like may now be compiled 445.

Rebalancing a BII with Cash Flows

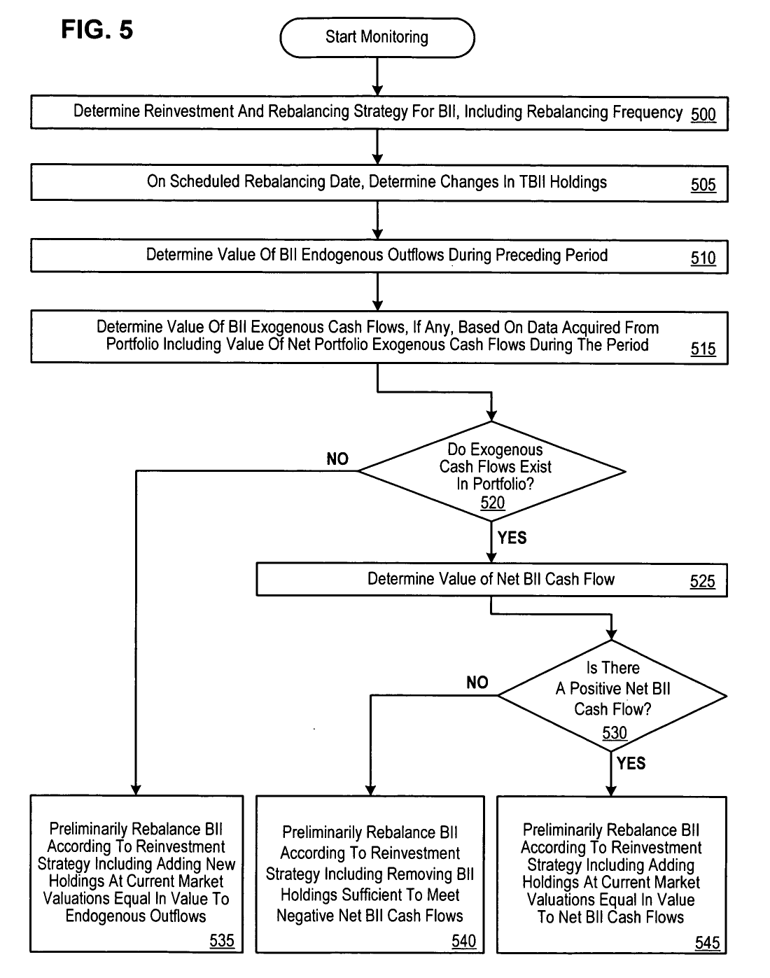

FIG. 5 illustrates a process for rebalancing a BII and how a BIIS may incorporate endogenous and/or exogenous cash flow, describing various hypothetical processes for recognizing cash flow that is both endogenous and exogenous to the BII.

During a period of performance monitoring, it may be desirable to recognize an influx and/or departure of value into and/or out of a BIIS, which would result in an increase and/or decrease in the value of a BII or plurality of book income indices, the value of this influx and/or departure being generated outside of the BIIS and not internally. This may be referred to as exogenous cash flow, incorporating exogenous inflows and exogenous outflows. For example, this might be analogized as a deposit and/or withdrawal of funds to and/or from an account. This may be beneficial in a situation where a BII is, for example, used as a performance monitor benchmark for a portfolio, to emulate the cash inflows and/or outflows of the portfolio, such as deposits and/or withdrawals. Such an embodiment would provide a BII that may incorporate the effect of cash flows as such cash flows would impact a portfolio.

A BII is comprised of constituents reflecting a number of real or hypothetical assets existing in the market. An index, of course, may not necessarily own or physically hold an asset, but may merely maintain a representation of the asset as it exists in the market. This representation may then be processed, manipulated, and/or the like. The assets, which are listed as corresponding constituents in a BII, in many cases, issue a distribution of value from time to time or on a regular basis. This may come in a variety of forms including, but not limited to, a dividend payment of cash, stock, products, or property, interest payments, coupon payments, partial repayment of principal, and/or the like. This distribution may be of earnings or interest distributed to the owners of the asset. When assets with corresponding index components issue a payment of this nature, the value of this payment may be contended with in the index. The value of these issued payments of constituents in an index may be considered endogenous outflows.

It is also common for an asset or assets to mature and/or no longer meet the qualifications for being in an index for a variety of reasons, as discussed further below. When this happens, the corresponding constituents in an index may be removed from the index and their value contended with. The value of matured and/or removed constituents may also be considered endogenous outflows. While it is not necessary that endogenous outflows caused by issued payments of assets be treated similarly to endogenous outflows caused by maturing or removed assets, for simplicity, they will typically be treated generally as endogenous outflows herein.

These endogenous outflows may be reflected in a BII. It may be said that these endogenous outflow values are generated internally to a BII because the value stems from the constituents currently held by the BII. There are a number of ways in which endogenous outflows may be reflected in a BII and a variety of ways in which the endogenous outflows may impact a BII. For example, when an asset matures, the corresponding BII constituent may be removed from the BII. In addition to its removal, its corresponding value, regardless of how the value is recorded, should be accounted for. This value may be accounted for in a variety of ways in line with the performance measurement preferences including, but not limited to, a reinvestment of the value into the BII, a possible reduction of BII value corresponding to the outflow of the value of the removed constituent, and/or the like.

Accordingly, a BIIS may recognize endogenous outflows in a variety of ways in order to meet or be in line with performance monitoring preferences and/or needs. Endogenous outflows may be “reinvested” into the BII, removed from the BII, and/or the like. In terms of a BII, this may be nothing more than a processing and/or manipulation of metrics, values, and/or data in general pertaining to the holdings of the BII relating to the endogenous outflows. The use of the term reinvest is not intended to require an actual purchase for value, but is used for convenience of illustration. The reinvestment of endogenous outflows may be performed using a variety of methods and at any time, in line with performance monitoring preferences and the discussion herein.

Rebalancing a BII or multiple book income indices acts much like the rebalancing of a portfolio, realigning the weightings of constituents in the index and recognizing and/or updating any desired values or characteristics at a given point in time. For example, a rebalancing of a BII might allow for the addition of a constituent into the BII that recently met the qualifications of the BII but was not incorporated previously. A rebalancing might also allow for the removal of a constituent that no longer qualifies for incorporation into the BII or where the corresponding asset matured. Rebalancing may also provide the opportunity to contend with endogenous outflows and/or exogenous cash flow, collectively cash flow. The ability to rebalance an index may provide for more accurate and/or more flexible performance measurement.

FIG. 5 illustrates a hypothetical rebalancing process for a BIIS. This illustration is of a BIIS incorporating a BII and a TBII to derive the BII from and rebalance the BII against. The structure and/or composition of the TBII is not addressed here, but may encompass any applicable alternative. The structure and/or procedure of the actual rebalancing steps are also not addressed here, but may encompass any applicable alternative. This BII is used as a benchmark for a portfolio and, accordingly, the BII may be constructed and/or modified in accordance with performance measurement requirements for this portfolio. While it is, of course, not necessary to benchmark a portfolio in practicing the steps of a rebalancing procedure, this illustration nevertheless provides an applicable hypothetical example for practicing the rebalancing steps of a BIIS. For example, inputs may be established hypothetically to test an index, environment, and or other characteristic.

The process illustrated in FIG. 5 begins performance monitoring by making determinations regarding the reinvestment and rebalancing strategy for a BII 500. This includes, but is not limited to, determinations regarding what is reinvested, how it will be reinvested, when it will be reinvested, what will be reinvested in, and/or the like. These deliberations also include a determination of the rebalancing strategy 500, which is discussed in greater detail below. This determination 500 concerns how, when, and how frequently the BII will be rebalanced and what will be rebalanced. For example, it may be determined that the BII will be rebalanced weekly, removing the value of any endogenous outflow and reinvesting this value back into the BII through the addition of constituents to the BII that were issued during the week at their market value upon addition to the BII. There are a variety of considerations involved in these decision and options for implementing them. Many of these are discussed and/or suggested herein.

In this scenario, a TBII exists and it is assumed that the established reinvestment and rebalancing strategy 500 was set to incorporate all endogenous outflows applicable to the BII, based on the BII holdings, and all exogenous cash flows applicable to the BII, based on the cash flows experienced by a portfolio.

On the scheduled rebalancing date, the TBII may be examined to determine what changes have occurred with the TBII holdings 505. This determination may entail ascertaining a variety of data, values, characteristics, and/or the like applicable to the TBII and/or as a result of the rebalancing of the TBII according to its rules of construction. In particular this determination may entail ascertaining what constituents have left and/or entered the TBII. This information may be used below when the BII is rebalanced.

The value of endogenous outflows applicable to the BII is also useful when rebalancing a BII and may be determined based on the holdings of the BII 510. This value may reflect endogenous outflows of the assets corresponding to BII holdings, where such outflows were generated after the inception of the BII, as in this case, or subsequent to the last rebalancing. Determining BII endogenous outflows 510 may, for example, include endogenous outflows generated by the assets reflected as holdings in the BII, along with the outflows generated by the removal of any BII holdings reflecting the departure of TBII constituents as determined upon an examination of the TBII 505.

Because this BII is used as a benchmark for a portfolio, information may also be acquired from the portfolio to assist with benchmarking the portfolio 515. For example, this may include information about the portfolio, including whether it experienced any exogenous inflow and/or outflow during the preceding period. If, for example, the portfolio experienced a deposit after the last rebalancing or inception date of the index, this data may be useful for application in the benchmark BII.

If this BII were not used as a benchmark, the value of exogenous cash flow might be determined in other ways. For example, if a hypothetical scenario were constructed for testing purposes, data from this scenario may be acquired or chosen arbitrarily and used during the BII rebalancing process.

If it is determined that no exogenous cash flow exists in the portfolio 520, based on the strategies determined for this BII 500, there would be no exogenous cash flow value applicable to the BII and the BII may be rebalanced based on the endogenous outflows alone, if any exist, and no determinations or procedures need be made regarding exogenous cash flows.

If this is the case, the BII may be preliminarily rebalanced 535 on the scheduled rebalancing date according to the reinvestment strategy established 500. This rebalancing 535 would typically incorporate the addition of new holdings to the BII, based on the examination of the TBII 505, acquired at the current market valuations on the date of rebalancing. The overall value of holdings added to the BII in this case may be equal to the value of endogenous outflows determined for the BII 510. By examining the TBII 505, an updated status of the constituents as well as the status of what is currently a part of the TBII at examination will provide the information necessary to rebalance the BII. For example, holdings that were a not part of the TBII at the previous rebalancing, but which were added to the TBII prior to this rebalancing, may be incorporated into the BII during this rebalancing and through this process added to the BII at the market valuations on the day it was added to the BII.

As discussed in greater detail below, there are a variety of methodologies in choosing how constituents are added to the BII. Such a decision may include what constituents are acquired, how much is acquired, the weight distribution of added constituents, and/or the like. This may, for example, be determined as part of the reinvestment strategy determination 500, as in this example. How the BII is rebalanced may depend upon the dynamics of the portfolio being benchmarked, where applicable, the preferences of performance measurements, the goals of the BIIS, the dynamics of the market being measured, and/or the like.

This rebalancing is referred to here as a preliminary rebalancing. Further modifications and rebalancing adjustments may be necessary to provide for additional rebalancing constraints and/or performance measurement preferences.

If it is determined that exogenous cash flow exists in the portfolio 520, based on the strategies determined for this BII 500, this exogenous cash flow value may be reflected as exogenous cash flow in the BII. Such exogenous cash flows may reflect inflows, outflows, or both. Each inflow and outflow may be taken care of individually, reflecting an inflow and an outflow separately. These inflows and outflows may also be taken care of together as a net cash flow. In this example, the value of net BII cash flow is determined 525. Here, net BII cash flow produces a final value for use in rebalancing the BII and is based on a sum of BII inflows and BII outflows. Net BII cash flow is a value that may incorporate any or all of the values of endogenous outflows, exogenous inflows, exogenous outflows, and/or any combination of the three as is applicable. Although each of these values may be incorporated into a BII and dealt with separately, a net BII cash flow value provides a single value calculated from the sum of all applicable inflows and outflows for incorporation and further processing if applicable within a BIIS.

So, for example, the value of net BII cash flow may be determined 525 by accounting for any BII exogenous inflow and subtracting any BII exogenous outflow. Depending upon the preferences established 500, the endogenous outflows may also be added to the net BII cash flow.

If the net BII cash flow is determined to be negative 530, the BII may be preliminarily rebalanced 540 on the scheduled rebalancing date according to the reinvestment strategy established 500. This rebalancing 540 would incorporate the removal of BII holdings with an overall value of removed constituents roughly equal to, or greater than, the value of the negative net BII cash flows. This may be described as a sale of holdings to meet a net outflow.

As discussed in greater detail below, there are a variety of methodologies in choosing how constituents are removed from the BII. The selection of which holdings are removed may be determined as part of the reinvestment strategy 500 or, at least, prior to the removal of the constituents. A pro-rata share, for example, may be removed, previously designated constituents may be removed, or constituents meeting certain criteria may be removed.

This rebalancing may only be a preliminary rebalancing if further modifications and rebalancing adjustments are necessary to provide for additional rebalancing constraints and/or parameters.

If the net BII cash flow is determined to be positive 530, the BII may be preliminarily rebalanced 545 on the scheduled rebalancing date according to the reinvestment strategy established 500. This rebalancing 545 would incorporate the addition of new holdings to the BII, based on the examination of the TBII 505, acquired at the current market valuations on the date of rebalancing. The overall value of holdings added to the BII in this case may be equal to the value of net BII cash flow determined for the BII 525, which, in this case incorporates exogenous and endogenous cash flows. As discussed herein, there are a variety of methodologies in choosing how constituents are added to the BII. This rebalancing may again be only preliminary if further modifications and rebalancing adjustments are necessary.

The process outlined above with respect to FIG. 5 depicts three conditions leading to alternate paths for rebalancing. This process may occur on every rebalancing date for this BII until performance measurement is complete or stopped and the variables present at each rebalancing, including what, if any, exogenous and/or endogenous cash flows exist, may effect which of the rebalancing options 535, 540, or 545 is appropriate. Over time, this cycle may continue and the BII may continue to evolve reflecting the TBII.

Applying Additional Constraints

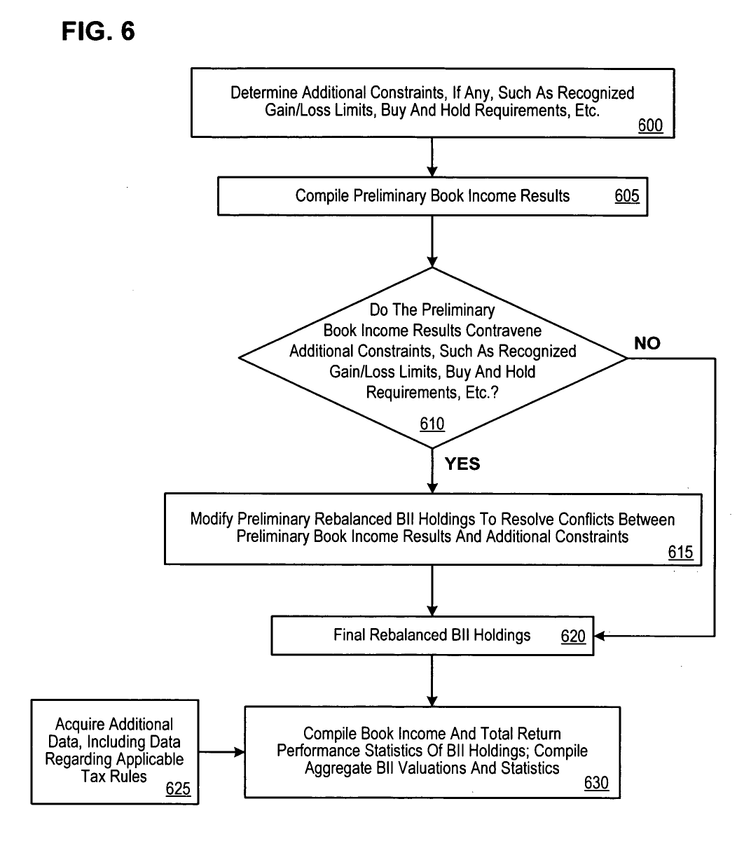

FIG. 6 illustrates a process for taking steps to apply additional constraints to a BII after the preliminary rebalancing. In a BII, it may be desirable to impose additional constraints that may be applicable and/or desirable in a BIIS. As discussed herein, performance measurement preferences may vary significantly and, as such, it may prove beneficial to take additional steps subsequent to a preliminary rebalancing to further bring a BII in line with performance measurement preferences.

For example, as discussed in greater detail below, it may be desirable to set certain gain/loss limits for a BII to prevent the recognition of a gain or a loss outside of set limits or require the recognition of a certain gain or loss. This may prove useful in the operation of a BII used as a benchmark for a portfolio where the portfolio has such gain/loss constraints in place. The operation of a BIIS with similar constraints may provide a benchmark that is more inline with the portfolio and may provide more useful or more applicable data as a result.

Another example of an additional constraint is a buy and hold requirement. This constraint may require that certain BII constituents, once acquired by the BII, remain in the BII through subsequent rebalancing cycles. These constituents may only be removed from the BII in certain limited circumstances including, for example, if the constituents have matured or have otherwise been redeemed.

FIG. 6 illustrates a hypothetical application of additional constraints within a BIIS. If it is determined that additional constraints are applicable to a BII, at some point prior to the actual application of additional constraints, these constraints must be determined 600. For example, if recognized gain/loss constraints or buy and hold requirements exist for the BII, they must be determined and established.

Preliminary book income results may be compiled 605. These results encompass any number of values, metrics, statistics, and/or the like and, here, are applicable to book income and the determination and/or possible application of the additional constraints. If these preliminary book income results contravene the applicable additional constraints 610, the BII should be modified to bring the BII inline with the applicable constraints. This idea is equally applicable where constraints may not be based on book income results. For example, if the BII was in a state that contravened any applicable additional constraints, the BII should be modified to bring the BII inline with the applicable constraints.

Starting with a BII that has been preliminarily rebalanced, where the preliminary book income results were found to contravene the applicable constraints 610, the BII holdings may now be modified to resolve any conflicts between the preliminary book income results and/or the BII and any applicable additional constraints 615. For example, if a constraint placed on the recognized gains is not meet by the preliminary book income results, a pro-rata share of holdings that would generate losses may be removed from the BII and their losses recognized in the BII, bringing the recognized gains in line with the gain constraint. The cash flows resulting from these additional removals may be reinvested in the same securities, or other securities, at current market yields and prices, in accordance with the reinvestment and rebalancing strategy. It may be said that the preliminary book income results are produced to test against any and all applicable constraints and if the results do not fit within the applicable constraints, the BII may be modified accordingly to bring its book income results in line with the applicable constraints.

Once the BII holdings have been modified 615, the final rebalanced BII holdings may be determined and established 620.

If the preliminary book income results do not contravene the applicable additional constraints 610, the final rebalanced BII holdings may be determined and established 620 without further modification relating to applicable constraints.

Additional data may be acquired to further assist in compiling statistics 625. This data may include data regarding applicable tax rules, data from the portfolio where applicable, data from the TBII where applicable, data regarding the performance measurement preferences, and/or the like. Information regarding tax rules applicable to the BII may prove useful in determining, processing, and/or producing any information from the BII for tax purposes. For example, the status of effective tax rates on different types and sources of taxable income may alter results produced and so forth.

Once the BII has been rebalanced and any applicable modifications made, valuations, statistics, metrics, and/or the like may be determined, calculated, compiled, and/or the like 630. This may occur in any of a variety of ways and may include the compilation of book income and total return performance statistics of the BII holdings, and/or aggregate BII valuations and statistics. This may also include the calculation of valuations, statistics, metrics, and/or the like on a pre-tax basis, on a post-tax basis, accounting for tax rules, and/or any basis in line with the performance measurement needs and/or preferences.

Rebalancing a BII and Applying Additional Constraints

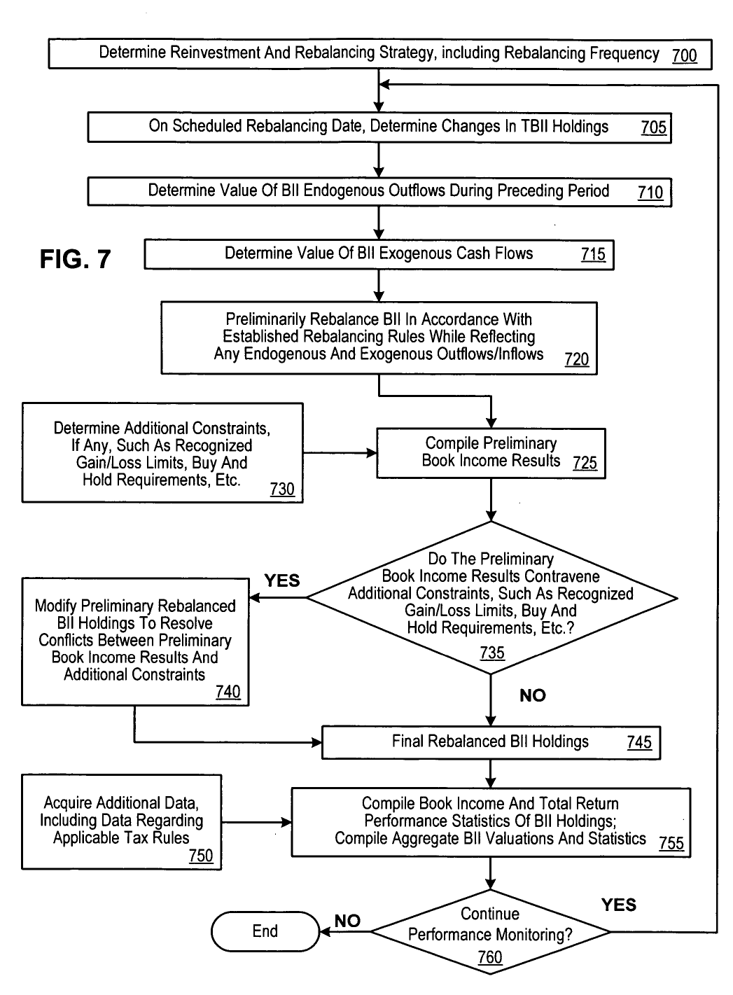

FIG. 7 illustrates a rebalancing embodiment incorporating the consideration of additional constraints. This illustrative process begins by making determinations regarding the reinvestment and rebalancing strategy of the BII 700, including, but not limited to, determinations regarding what is reinvested, how it will be reinvested, when it will be reinvested, what it will be reinvested in, how, when, and how frequently the BII will be rebalanced, what will be rebalanced, and/or similar considerations concerning reinvestment and rebalancing of the BIIS.

This illustration is of a BIIS incorporating a BII and a TBII, to derive the BII from and rebalance the BII against. In this scenario, it is assumed that the established reinvestment and rebalancing strategy 700 was set to incorporate all endogenous and exogenous cash flows applicable to the BII holdings.

On the scheduled rebalancing date, the TBII may be examined to determine what changes have occurred with the TBII holdings 705. The value of endogenous outflows applicable to the BII may then be determined 710, based on the holdings of the BII. This value may reflect endogenous outflows of the assets corresponding to BII holdings where such outflows were generated after the inception of the BII, as in this case, or the last rebalancing. Determining BII endogenous outflows 710 may, for example, include endogenous outflows generated by the assets reflected as holdings in the BII, along with the outflows generated by the removal of any BII holdings reflecting the departure of TBII constituents as determined upon an examination of the TBII 705.

In addition to the determination of endogenous outflows, it may be determined 715 whether there are any exogenous cash flows applicable to the BII and what the value is of such exogenous cash flows.

Once these values are determined, exogenous and endogenous cash flows, the BII may be preliminarily rebalanced 720 in accordance with the established reinvestment and rebalancing strategy 700 reflecting the value of any endogenous outflow determined 710 and the value of any exogenous outflows/inflows determined 715.

A determination 730 should be made as to whether there are additional constraints applicable to the BII and what the details of these additional constraints are. Following this determination 730 and the preliminary rebalancing of the BII holdings 720, the preliminary book income results may be compiled 725.

If the preliminary book income results contravene the applicable constraints 735, the BII holdings may be modified to resolve any conflicts between the preliminary book income results and any applicable additional constraints 740. This may involve a removal of BII constituents and reinvestment in the same, or other, constituents at current market yields and prices, or it may involve some other form of resolution. After modification 740, the final rebalanced BII and its holdings may be established 745.

If the preliminary book income results do not contravene the applicable constraints, the final rebalanced BII and its holdings may be established 745 without further modifications.

After acquiring additional data 750, including data regarding applicable tax rules, book income and/or total return performance statistics may be compiled 755, as well as aggregate BII valuations and statistics, based on the final rebalanced BII holdings 745.

After rebalancing is complete and the metrics, valuations, statistics, and/or the like are compiled 755, the performance measurement may continue and further rebalancings may occur with further metrics, valuations, statistics, and/or the like generated and compiled. If the performance measurement is to continue 760, the performance monitoring would continue until the next scheduled rebalancing date, where the TBII may be examined 705 to determine if any changes have occurred since the last rebalancing and the process outlined above with respect to FIG. 7 may be repeated or a process in a similar fashion to that outlined above may occur. This process of rebalancing, applying additional constraints, and calculating metrics, valuations, statistics, and/or the like may continue until the performance measurement is complete, stopped, or unable to continue. If the performance measurement is not to continue 760, this process may end.

Segmenting the Index into Index Purchase Lots

One embodiment of a BII may be comprised of a series of subsidiary book income indices for a given base-line index and may provide for the separate tracking of each subsidiary BII in the series. Instead of a single BII providing performance measurement, a series of multiple book income indices may be used to provide performance measurement. Further, a series of book income indices may be used, which are all derived from a single base-line index. Each subsidiary BII in this series may derive characteristics, including its holdings, from the characteristics of the base-line index. Such a series of book income indices may be beneficial in providing more applicable, customizable, and accurate performance measurement.

A series may be comprised of a number, at least more than one, of subsidiary book income indices each having an inception date. These inception dates may be the same or different from one another, set at regular intervals or randomly selected or determined based on other circumstances. While it is not necessary that each subsidiary BII have a different inception date from any other subsidiary BII, the examples below describe various examples of a series of subsidiary book income indices using a base-line market index where each subsidiary BII has its own distinct inception date for convenience and illustrative purposes.

As discussed above, embodiments of the BIIS may incorporate an influx and/or departure of value into and/or out of a BII. Embodiments of the BIIS may incorporate an inflow and/or outflow of value into and/or out of one or more of the subsidiary book income indices in the series. The inflow and/or outflow could also be reflected in just one of the subsidiary indices. For example, a series of subsidiary book income indices with inception dates set on a monthly basis could incorporate subsequent inflows and/or outflows of value into and/or out of each of the subsidiary indices at subsequent rebalancings.

It is not necessary, of course, that a BII be used as a performance monitor benchmark for a portfolio in order to reflect an influx and/or departure of value into and/or from the index. The index may incorporate such influx and/or departures in value for any number of reasons including to better monitor trends in a market, to meet certain hypothetical characteristics, to meet certain other performance needs, and/or the like. These examples are offered for illustrative purposes. It is of course understood that such structures and/or embodiments are not limited to the examples discussed, but rather, any execution of the principles discussed is contemplated herein.

There are other benefits to the use of subsidiary BII series. For example, in one embodiment, it may be valuable to use a series of subsidiary indices to accommodate the alignment of the inception date of an index to the initial funding date of a portfolio as described above. Other benefits may be that monitoring a series of subsidiary indices may more closely emulate a desired scenario, provide greater flexibility as compared to a single index, provide the ability to accommodate additional cash flows into and/or out of an index, allow for the recognition of set constraints on an index and/or portfolio, provide greater customization, better reflect market circumstances and/or performance measurement needs in general, and/or the like.

Each BII series may comprise subsidiary book income indices with a range of inception dates for each subsidiary index. In one embodiment, these inception dates may be, but are not necessarily, set at regular intervals, such as, for example, monthly, weekly, daily, bimonthly, semi-annually, and/or the like. It is possible, however, that the inception dates are not set on a regular basis, but are random, specifically chosen, and/or any number of methods for creating a range of inception dates for the subsidiaries of a series.

The use of subsidiary book income indices are not limited to the embodiments discussed herein, but may be practiced in a variety of ways and/or created using a variety of structures and/or systems inline with the principles discussed herein. These subsidiary book income indices may be referenced using a variety of names or terms as discussed herein, such as “subsidiary book income index,” “subsidiary index,” “purchase lot,” “index lot,” “purchase date lot,” “index purchase lot,” and/or the like.

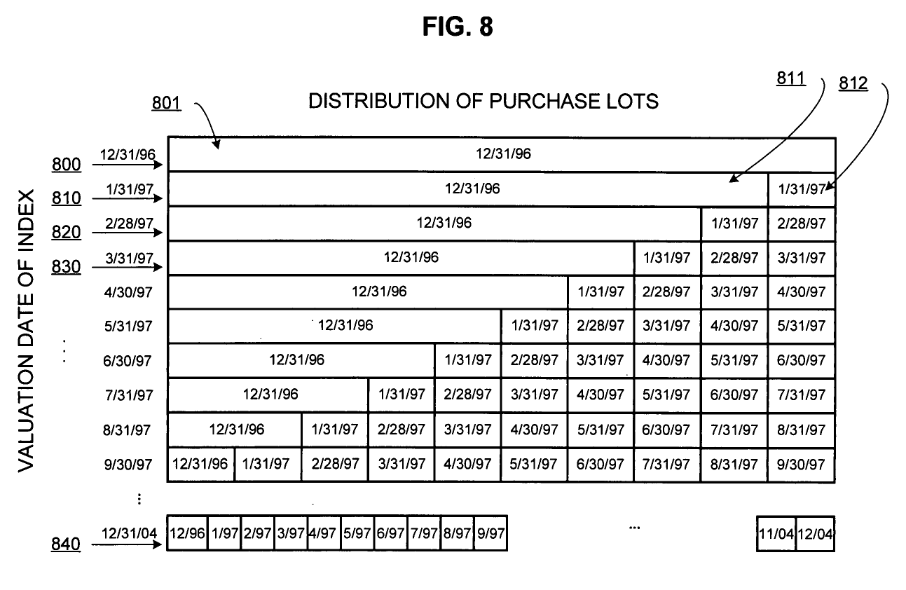

For illustrative purposes, an embodiment of a series of subsidiary book income indices for a market index may be comprised of a number of subsidiary indices with inception dates set on a monthly basis. FIGS. 8-11 help illustrate some of the concepts relating to an index comprising series of subsidiary book income indices.

FIG. 8 illustrates a series of subsidiary book income indices for a base-line market index with inception dates for each subsidiary index scheduled monthly starting at Dec. 31, 1996 and updated on subsequent valuation dates. FIG. 8 illustrates how a BII series may be distributed as new subsidiary indices are added to an existing series.

On Dec. 31, 1996, the index series is comprised of a single purchase date lot 801 that exactly matches the constituency of the base-line market index, as shown in row 800. This is because the index acquires the entire constituency of the base-line index on its inception date. It is not necessary that an index acquire the entire constituency of its base-line index, but such an assumption is made here for illustrative purposes.

In one embodiment, the holdings acquired by the index are tracked as a distinct buy and hold index purchase lot over the life of the index. There are circumstances, as discussed herein, where holdings may be removed from an index and, until these holdings depart from an index, they are tracked as distinct buy and hold acquisitions.

On Jan. 31, 1997, a rebalancing of the index may occur. By Jan. 31, 1997, a number of the holdings reflected in the Dec. 31, 1996 purchase lot 801 may have exited the base-line market index. Those that have remained continue to be monitored as part of the Dec. 31, 1996 purchase lot 811.

During the month of January 1997, in addition to constituents exiting the base-line index, some assets that were not constituents of the base-line index may now meet the criteria for incorporation in the base-line index. It is common that the holdings of a base-line index will continue to change during performance monitoring, acquiring and divesting itself of holdings. This will be discussed in greater detail below.

At rebalancing, a new purchase lot 812 may be created. The holdings of this new purchase lot 812 are acquired with updated characteristics as of Jan. 31, 1997. This may be in contrast to the characteristics of the holdings of the purchase lot 811 acquired on Dec. 31, 1996.

This Jan. 31, 1997 purchase lot 812 may, but not necessarily, be comprised of holdings that differ from the Dec. 31, 1996 purchase lot 811. For example, the Jan. 31, 1997 purchase lot 812 may be comprised of constituents of the base-line index at the Jan. 31, 1997 rebalancing. This new purchase lot 812 may be comprised of the entire base-line index as it existed on Jan. 31, 1997, only newly acquired base-line index constituents, or of holdings that meet established characteristics, and/or any number of desired rebalancing preferences.

On Jan. 31, 1997, as shown in row 810, this index series is comprised of two purchase lots: the Dec. 31, 1996 series/Dec. 31, 1996 index purchase lot 811 and the Dec. 31, 1996 series/Jan. 31, 1997 index purchase lot 812.

At each monthly rebalancing, another index purchase lot is created. Each purchase lot comprises holdings acquired on the date of the rebalancing when it was created with the characteristics of such holdings on that date. Over time, this cycle continues and the index purchase lot distribution is divided into increasingly smaller segments, as shown in FIG. 8 by rows 800, 810, 820, 830 and through row 840.

No significance should be placed on FIG. 8's illustration of index purchase lots at Dec. 31, 2004. This is just a randomly chosen date. The rebalancing process and creation of new purchase lots may continue into perpetuity or end at any point. There is also no significance to the size of the illustrated index purchase lots in FIG. 8, except to illustrate how the series of subsidiary indices may develop over time. This example also assumes that there will be value with which to create an index purchase lot at the rebalancing date. It is possible that there may be no index purchase lot created for any given rebalancing date.

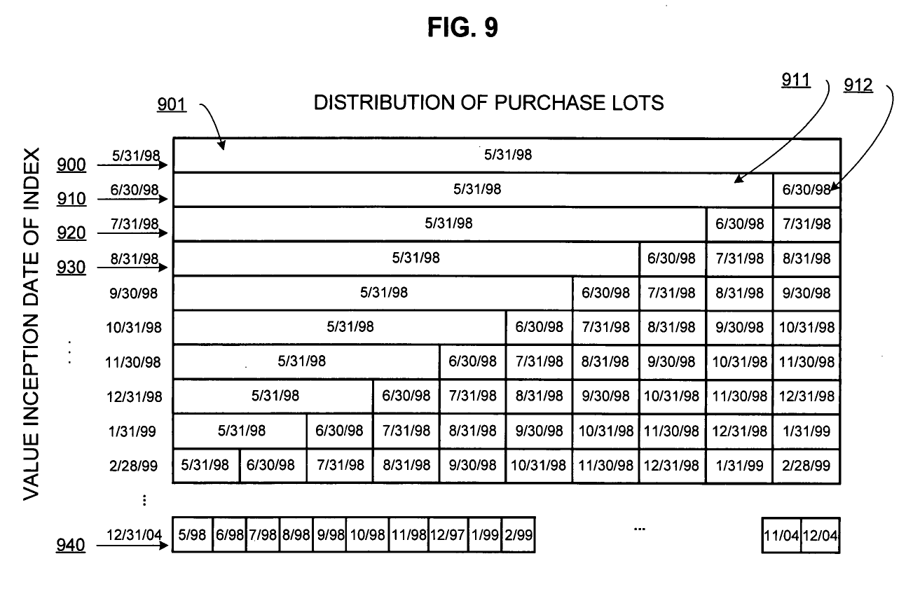

Lot distribution as depicted in FIG. 8 is a function of the index book value inception date. Therefore, a BII series with an inception date of May 31, 1998 as shown in FIG. 9 would be segmented differently than a similar BII series with an inception date of Dec. 31, 1996 as shown in FIG. 8 when viewed on a valuation date of Dec. 31, 2004.

FIG. 9 illustrates a series of subsidiary book income indices for a base-line market index similar to that of FIG. 8, beginning with a the May 31, 1998 series/May 31, 1998 index purchase lot 901 as illustrated in row 900. At the Jun. 30, 1998 rebalancing, the holdings that remain in the May 31, 1998 series/May 31, 1998 index purchase lot 901 will continue to be monitored as the May 31, 1998 series/May 31, 1998 index purchase lot 911, while the May 31, 1998 series/Jun. 30, 1998 index purchase lot 912 is created based on the updated base-line market index as of the Jun. 30, 1998 rebalancing. This is illustrated at row 910. Over time this cycle continues, as index purchase lots are created at each monthly rebalancing reflecting the current market condition of the May 31, 1998 index, as shown in FIG. 9 by rows 900, 910, 920, and 930 until the rebalancing and/or monitoring is discontinued, represented in FIG. 9 as Dec. 31, 2004 at row 940.

The term “current” is used frequently throughout this disclosure. Typically, depending upon the context of the use, “current” is used to reflect the status of a term as up to date with the date being referenced. For example, updating an index to the current market values as of Jan. 31, 2004 would indicate that the index should be updated to reflect the current market conditions as they existed on Jan. 31, 2004. It is to be understood that “current” is used for the sake of clarity, as an aid to the reader, and the system should not be limited to and/or by a narrow reading of this term. The use of this term may incorporate any of a number of meanings inline with the context of its use and the spirit of this disclosure.

Although the examples described herein involve adjusting the value of BII holdings and/or the BII according to current market conditions on a set date, it is conceivable that such readjustment of metrics may be based on any set of market conditions, statistics, values, metrics, and/or the like.

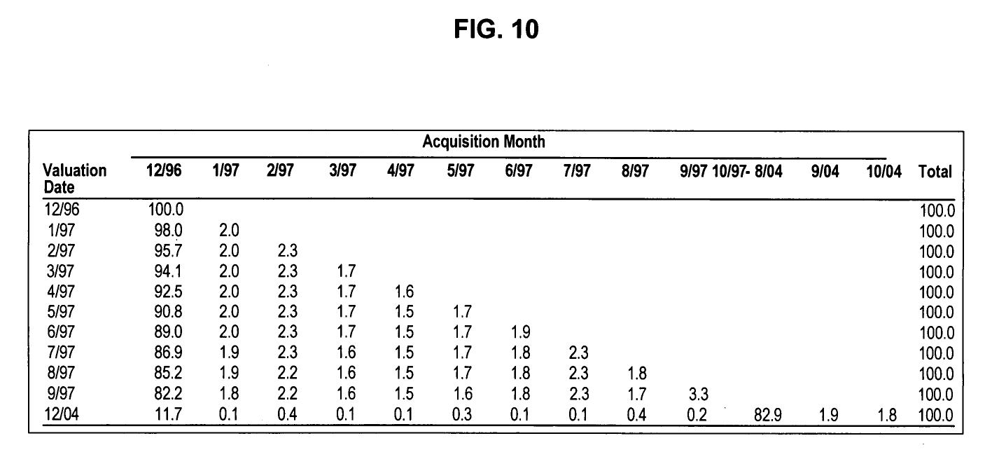

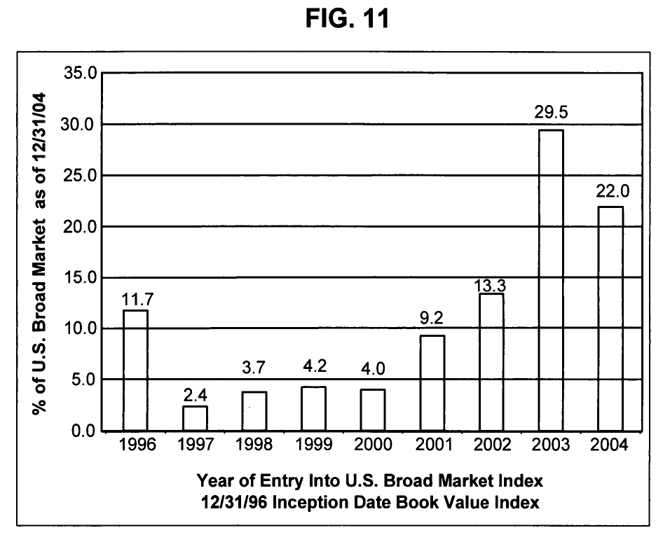

In one embodiment of the system, when each index purchase lot is created, the holdings of each newly added purchase lot may be comprised solely of new constituents that have been added to the base-line index subsequent to any previous rebalancing date. FIGS. 10 and 11 illustrate how the constituents of a BII series with an inception date of Dec. 31, 1996 might be distributed over time. The benefit of such illustrations is to demonstrate how a hypothetical BII series may be segmented into a number of purchase lots and how the distribution of such purchase lots and, indeed, holdings of the BII in general, might appear at a given valuation date.

For example, in FIG. 10, if the examples outlined above were practiced using a broad investment grade bond index, such as the Merrill Lynch U.S. Broad Market Index, as the base-line index, starting with an inception date of Dec. 31, 1996, the BII series as of Dec. 31, 2004 would be comprised of 97 separate BII purchase lots, with the largest allocation attributed to bonds acquired at the original book value inception date of Dec. 31, 1996. This varies depending upon the valuation date referenced, as shown in FIG. 10.

FIG. 11 provides an illustration depicting an apportionment of the holdings of the broad investment grade bond index on Dec. 31, 2004 according to the year of entry into the index, where the inception date of the book income index series is Dec. 31, 1996. In contrast to FIG. 10, when aggregated based on purchase year, the twelve 2003 purchase months combined to account for the largest share of the broad investment grade bond index at Dec. 31, 2004.

The illustrations portrayed in FIGS. 10 and 11 involve purchase date-specific building blocks.

Tracking the Bond-Level Details

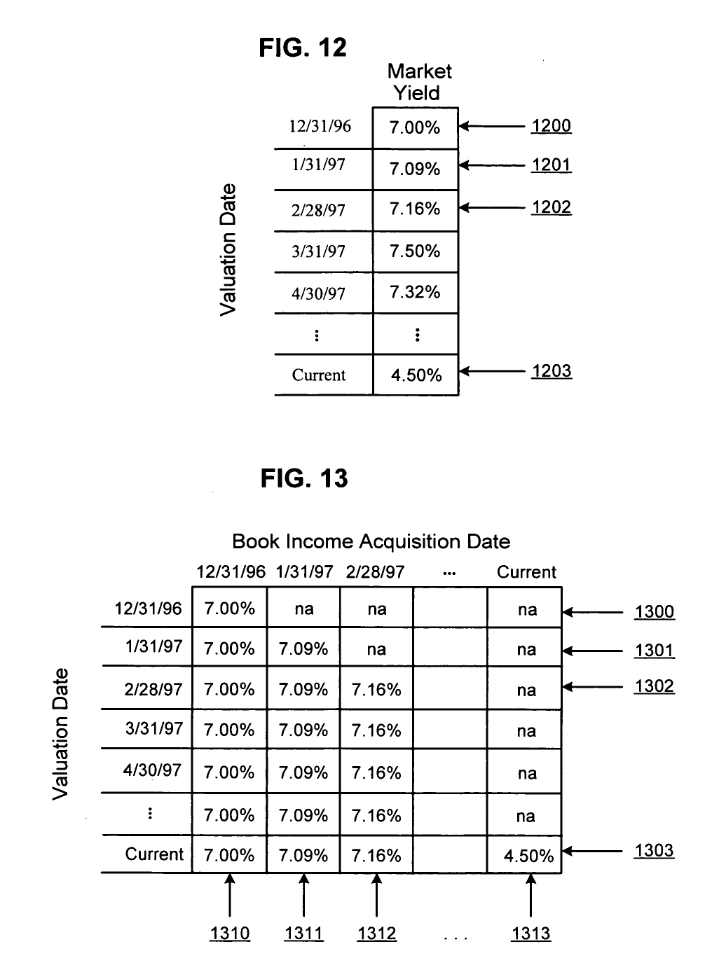

As discussed above, compiling a BII may differ from compiling a total return index in a number of ways. A total return index framework requires only a one-dimensional valuation structure—for every valuation date there is only one market yield and one market price for every asset. For example, FIG. 12 provides a chart of hypothetical market yields of a single fixed income security at various valuation dates set, for this example, a month apart. At Dec. 31, 1996, the market yield for the security was 7.00%, as illustrated in row 1200. As this is a one-dimensional valuation structure, each security will have but one market price, and therefore, one market yield, associated with each valuation date. Thus, as in row 1201, at Jan. 31, 1997, the market yield for the security was 7.09%. The market yield for the security in Feb. 28, 1997 was 7.16, as illustrated in row 1202. This continues until row 1203, where the current market yield for the security was indicated as 4.50%. If tracking the market value of an index, portfolio, single security, group of securities, and/or the like from a single inception date is desired, a one dimensional structure might be useful.

Depending on the accounting treatment applied to the assets in the portfolio, it may be desirable to account for index constituents on an historical cost-based accounting method. If an index is accounted for on an historical cost-based accounting method, it may be necessary to record book yields, and therefore book values and recognized gains/losses, for individual constituents in the index based on their dates of acquisition by and removal from the index. In order to account for constituent acquisition and removal dates, a valuation table may be represented, for illustration, by a two-dimensional structure. For example, FIG. 13 provides a chart of a hypothetical scenario for valuing a fixed income security based on a series of possible acquisition dates. The first row 1300 illustrates the valuation of the security at an assumed acquisition date of Dec. 31, 1996. On this date, the security is acquired at a book yield of 7.00%, which equals its market yield on that date as illustrated in FIG. 12 at row 1200. This security, with a purchase date of Dec. 31, 1996, will maintain a book yield of 7.00% as long as it remains in the index, as illustrated in column 1310. If this security was acquired on Jan. 31, 1997, it would be recorded at a book yield of 7.09%, which equals the market yield on that date as illustrated in FIG. 12 at row 1201. The security will remain at a book yield of 7.09% as long as it remains in the index, as illustrated in column 1311. If this security was acquired on Feb. 28, 1997, it would be recorded at a book yield of 7.16%, which equals its market yield on that date as illustrated in FIG. 12 at row 1202. The security will remain at a book yield of 7.16% as long as it remains in the index, as illustrated in column 1312. If the security was acquired by the index on the current date, as illustrated in column 1313, it would be recorded at a book yield of 4.50%, which equals its market yield on that date, as illustrated in FIG. 12 row 1203.

Another dimension may be added to this analysis, involving the status of a constituent in an index. It is common for a security that was once incorporated in an index to no longer exist in that index. This may occur for a variety of reasons as discussed above. It is also common for a security to enter an index for similar reasons. Similarly, due to the flexibility of indexing and the innumerable examples and types of indices, it is also common for indices to encompass one or more of the same constituents as another index or other indices. As the characteristics of a security change over the course of its life, it is possible that the security will enter and depart from a number of indices. The entry and departure dates of each entry and/or departure will vary from index to index and from security to security.

For example, a bond may appear in more than one index or in numerous indices. A bond may exist at any given point within, for example, an index for BBB rated bonds, an index for investment grade rated corporate bonds, and an index for bonds in an industrial sector. Further, as the characteristics of a bond change over the course of its life, it may enter and depart a variety of indices. For example, as a bond is downgraded from BBB to high yield, the characteristics of the bond have changed and, thus, it will likely depart from some indices, such as, for example, an index for BBB rated bonds and an index for investment grade corporate bonds and will enter an index of high yield bonds.

A bond rating is an evaluation of the probability of defaulting based on an analysis of the issuer's financial condition and profit potential as judged by an outside rating service. Typical examples of the numerous rating services that exist are Standard & Poor's, Moody's Investors Service, Fitch's Investors Service, and/or the like. Typically, these rating services rate a bond in a range from AAA, which is highly unlikely to default, to D, which is in default. Bonds rated BB or below in this case are considered high yield, while bonds rated BBB or above are considered investment grade.

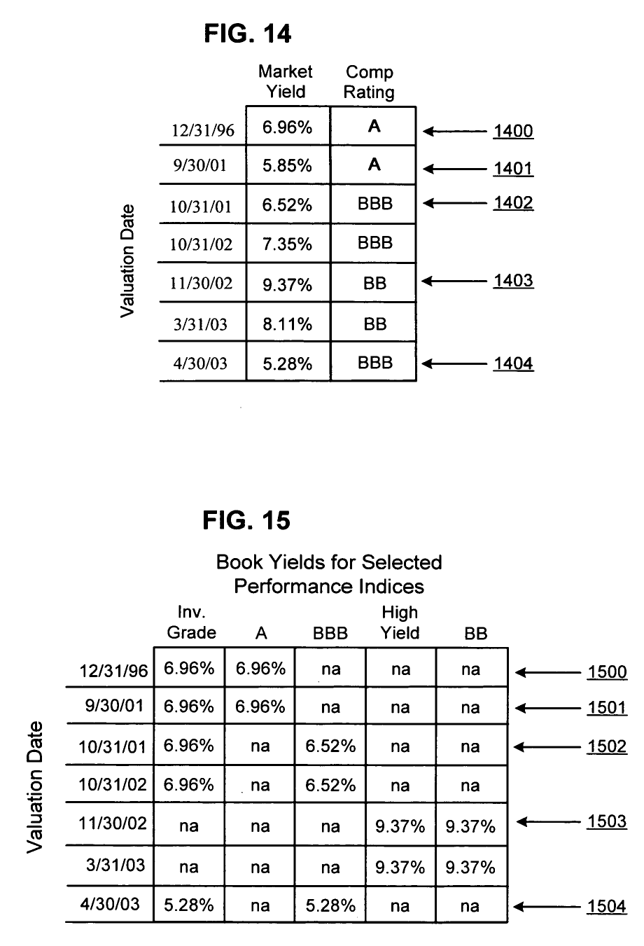

FIGS. 14 and 15 illustrate the path of a hypothetical corporate bond as it passes through several indices over its life. The rating of this hypothetical bond changes over time, which changes what indices it will qualify for and, thus, be a part of. The bond was originally issued in December 1996 at a market yield of 6.96% with an A rating, as illustrated in row 1400. This bond would therefore qualify for inclusion in both an investment grade corporate index and an index for A rated bonds. This bond maintained its rating at Sep. 30, 2001, but the market yield of the bond changed, reduced to 5.85%, as illustrated in row 1401. The book yield of this bond, however, if it was acquired at Dec. 31, 1996 would stay constant at 6.96%.

Following a downgrade to BBB in October 2001, the bond would likely drop out of an A rated bond index (where an appreciation or depreciation of the bond may be recognized) and enter a BBB rated bond index with a book yield equal to the Oct. 31, 2001 market yield of 6.52%. This is illustrated in row 1402. This bond would remain in the investment grade corporate index, however, at the original Dec. 31, 1996 book yield.

A further downgrade to BB in November 2002 caused the bond's removal from the investment grade corporate and BBB rated bond indices (where an appreciation or depreciation of the bond may be recognized) and its entry into a high yield corporate bond index and BB grade bond index, as illustrated in row 1403. Again, the book yield for this bond's entry into these indices would be at the Nov. 30, 2002 market yield of 9.37%.

Finally, in April 2003, the bond was upgraded to a BBB rating triggering its removal from the high yield corporate and BB rated bond index (where an appreciation or depreciation of the bond may be recognized) and its reentry into the investment grade corporate and BBB rated bond indices at a book yield equal to the Apr. 30, 2003 market yield of 5.28%, as illustrated in row 1404.

FIG. 15 provides a different illustration of the example discussed above and illustrated in FIG. 14, where rows 1500, 1501, 1502, 1503, and 1504 coincide with rows 1400, 1401, 1402, 1403, and 1404 respectively. FIG. 15 represents the book yields of the bond as it entered and/or departed from the various indices discussed above. FIGS. 14 and 15 are just two illustrations of embodiments of a BIIS. Similar embodiments may also be created inline with the teachings herein.

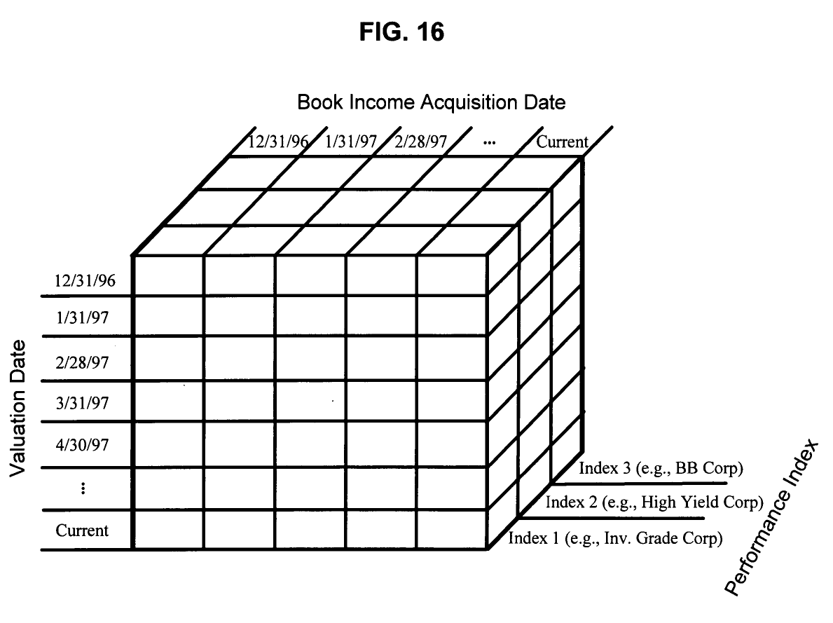

A security that enters and/or departs from an index or indices may also be accounted for. Further, this system accommodates for the change in book value of a security as it enters an index at the market yield at the date of entry. As the book values and book yields of a security are likely to change depending on the acquisition date, the point at which a security enters a given index may be significant. For example, FIG. 16 illustrates a three-dimensional book income bond valuation database. This illustration is of a matrix of book valuation data for every bond in a given index universe organized by: (1) book valuation date, (2) three hypothetical indices of which the bond may be member over its life, and (3) each monthly acquisition date series for each of those indices. As described above, a security may enter and/or depart from a number of indices over its life. FIG. 16 may be used to track a security through its entry and/or departure from indices, as well as the necessary book valuation data associated with each of those entry dates. While FIG. 16 provides only an illustration used to show a few of the considerations in monitoring the book income and values of securities, it is useful in assisting with understanding how a bond may be traced as it passes through several indices over its life, while accommodating for the bond valuation date and book income acquisition date.

Accounting for the Components of a Book Income Index

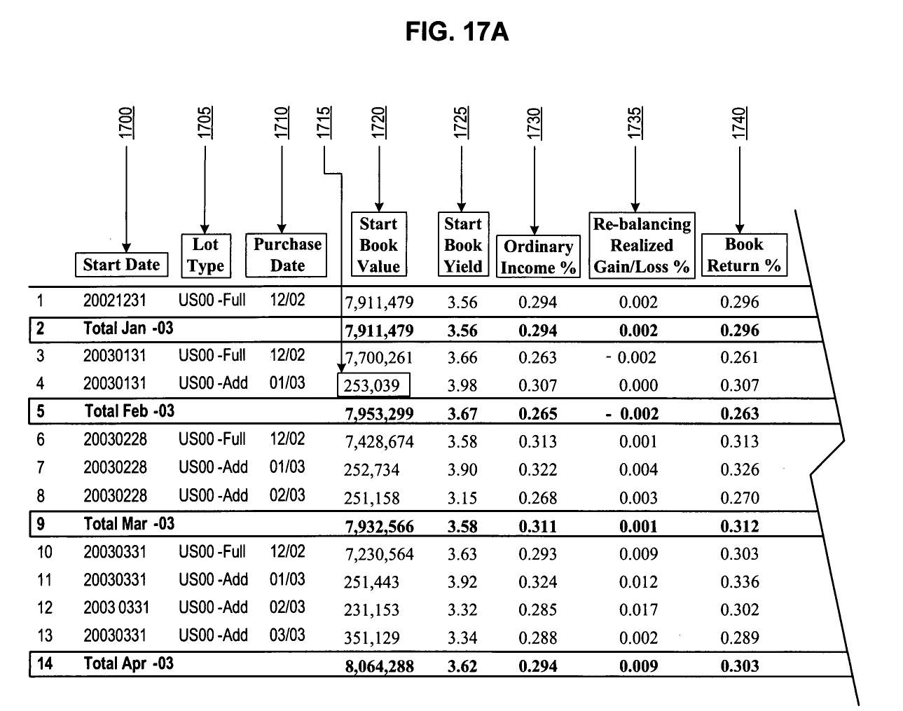

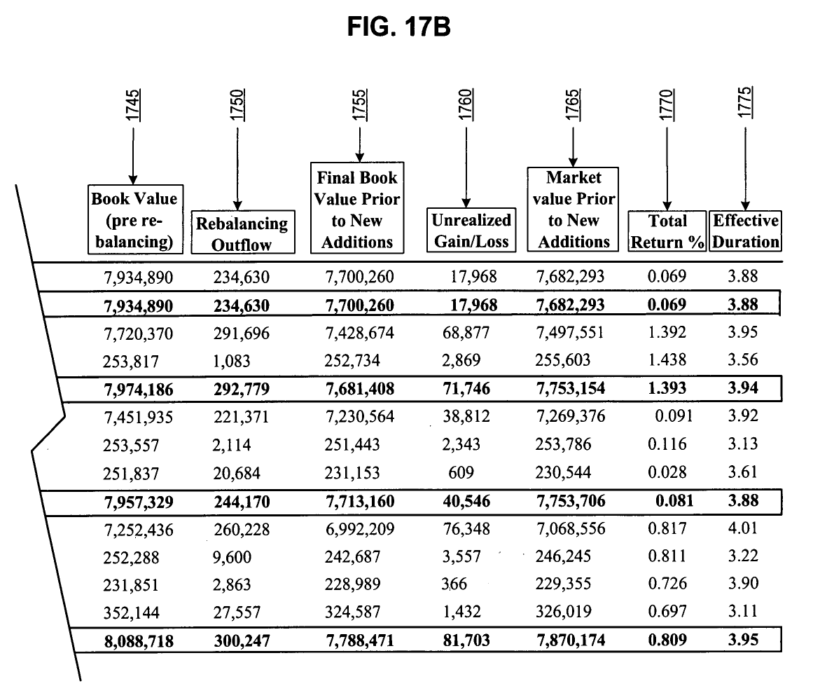

To illustrate how the performance of a BIIS may be monitored, a detailed accounting of the components of a hypothetical BII based on a broad investment grade bond index with an inception date of Dec. 31, 2002 has been provided in FIGS. 17A and 17B. This is an illustration, however, and, accordingly, the principles discussed herein are universally applicable in a number of contexts including, but not limited to, a variety of securities to be indexed, a variety of indices, a variety of statistics to be monitored, any established rebalancing period, or any other variable as discussed herein or otherwise known in the industry.

Although this illustration reviews one hypothetical example, the principles described herein are not necessarily limited to the applications described and are applicable to any variety of indices. In this hypothetical illustration, the index begins on Dec. 31, 2002, shown in column 1700 of FIG. 17A, with a purchase of the entire the broad investment grade bond index (the “base-line market index”) at current market yields, weights, and prices, which is designated as “US00-Full” in column 1705 of FIG. 17A. The purchase date of this purchase of the base-line market index occurred on Dec. 31, 2002, which is represented in column 1710 of FIG. 17A. Thus, the starting book value of this BII, shown in column 1720, is $7,911,479 and the starting book yield, shown in column 1725, is 3.56%. At this point the book value and book yield of the hypothetical BII is equal to the market value and market yield of this index, which should only occur once and at this point.

This hypothetical BIIS is to be rebalanced on a monthly basis and, as such, the series of bonds purchased on Dec. 31, 2002 is rebalanced on Jan. 31, 2003. Column 1740 of FIG. 17A illustrates the book return percentage as of the date of rebalancing for each series of constituents purchased. For the Dec. 31, 2002 series of bonds, the book return percentage at the Jan. 31, 2003 rebalancing was calculated as 0.296%, as illustrated in column 1740. The book return percentage is represented as the sum of the ordinary income percentage, illustrated in column 1730 of FIG. 17A, and the percentage of capital gains or losses attributed to constituents removed from the index at the rebalancing date, illustrated in column 1735 of FIG. 17A. For the Dec. 31, 2002 series of bonds, the ordinary income percentage for the Jan. 31, 2003 rebalancing was 0.294%, as illustrated in column 1740, and the percentage of capital gains or losses attributed to bonds removed from the Dec. 31, 2002 series at the Jan. 31, 2003 rebalancing date was 0.002%, as illustrated in column 1735 of FIG. 17A.

It may be common that rebalancing turnover will constitute a comparatively small percentage of the total outstanding value of an index and, accordingly, capital gain/loss returns related to rebalancing may, but not necessarily, also tend to be small for most indices in most months. Circumstances do exist, however, where the resulting capital gain/loss returns from rebalancing may be a more significant value. For example, there may be the departure of a very large issuer of a constituent in the index due to, for example, a downgrade or upgrade of their credit rating, which could cause the rate of capital gain/loss return from a subsequent rebalancing to be significantly higher than the average rebalancing rate of capital gain/loss return. Another example may occur where a significant number of constituents are removed due to a change in selection rules for the underlying base-line market index or for any number of reasons as discussed herein or otherwise known in the industry. Similar examples also exist that would effect the value of an index and/or rebalancing-related capital gain/loss returns.

Column 1745 of FIG. 17B shows the end of period book value of the constituents while taking account of any rebalancing turnover. For the Dec. 31, 2002 series of bonds, the book value at the end of the period, which is the rebalancing date but prior to rebalancing, was $7,934,890. Dividing the pre-rebalancing book value, column 1745 of FIG. 17B, by the starting book value, column 1720 of FIG. 17A, results in the book return percentage for the rebalancing period.

The next step in this hypothetical reduces the pre-rebalancing book value, as illustrated in column 1745, of each series of constituent purchases by the rebalancing outflows, illustrated in column 1750. Examples of rebalancing outflows may be redemptions of or interest payments for securities in an index, coupon payments for bonds in a bond index, and any variety of cash outflows that would result from the rebalancing of a set of constituents. In FIG. 17B, the pre-rebalancing book value of the Dec. 31, 2002 series of bonds in column 1745, $7,934,890, is reduced by the value of rebalancing outflows from the bonds in the Dec. 31, 2002 series at Jan. 31, 2003 in column 1750, which is $234,630. This reduced value is the final book value of the series prior to the addition of any new constituents and is illustrated in column 1755. In this hypothetical example, the final book value prior to new additions for the Dec. 31, 2002 series is $7,700,260, as shown in column 1755. The final book value prior to new additions is also the start book value for the same series in the next rebalancing period. For example, in this hypothetical illustration, the final book value prior to new additions for the Dec. 31, 2002 series is $7,700,260, as shown in column 1755. The market value of the Dec. 31, 2002 series at the rebalancing date before any new additions was determined to be $7,682,293, as shown in column 1765.

As described above, the first row of FIGS. 17A and 17B represents the Dec. 31, 2002 series of constituent purchases. Because this is the initiating month and there has been no rebalancing of constituents, at this point, the entire BIIS is comprised of a single series. In this case, the Dec. 31, 2002 series. This is represented in the second row of FIGS. 17A and 17B, which is the equal to the values and statistics calculated and determined for the Dec. 31, 2003 series.

On the start date of the next rebalancing period for the BII, illustrated in column 1700 of FIG. 17A, the book value of the first series of purchased constituents of the base-line market index is equal to the final book value of the constituents prior to the addition of new constituents on the rebalancing date, illustrated in column 1755 of FIG. 17B. For example, the final book value prior to new additions of the Dec. 31, 2002 series was $7,700,261, as shown in column 1755. This value becomes the start book value, column 1720 of FIG. 17A, of the Dec. 31, 2002 series for the next rebalancing period beginning on the start date of Jan. 31, 2003, illustrated in column 1700. The third row of FIGS. 17A and 17B illustrates this. On Jan. 31, 2003, shown in column 1700, the series of bonds of the broad investment grade bond index, shown in column 1705, initially purchased on Dec. 31, 2002, shown in column 1710, the start book value was $7,700,261, shown in column 1720, and the start book yield was 3.66%, shown in column 1725, for the rebalancing period starting on Jan. 31, 2003 and ending at the next rebalancing.

The process as described above is repeated at each rebalancing of the index. The process described above with regards to the Dec. 31, 2002 series and the Jan. 31, 2003 rebalancing is repeated in the next rebalancing period. In this example, the next rebalancing occurs on Feb. 28, 2003. So, for the Dec. 31, 2002 series of bonds, the book return percentage at the Feb. 28, 2003 rebalancing was calculated as 0.261%, as illustrated in column 1740. This value is comprised of the sum of the ordinary income percentage and the rebalancing realized gain/loss percentage. The ordinary income percentage at rebalancing was calculated to be 0.263%, as illustrated in column 1730 and the percentage of capital gains or losses attributed to bonds removed from the Dec. 31, 2002 series at the Feb. 28, 2003 rebalancing date was calculated to be −0.002%, as illustrated in column 1735 of FIG. 17A. Column 1745 of FIG. 17B shows the end of period book value of the Dec. 31, 2002 series of bonds purchased, which was $7,720,370 at the rebalancing date of Feb. 28, 2003, but prior to rebalancing. This pre-rebalancing book value may then be reduced by the outflows resulting from rebalancing shown in column 1750, at a value calculated to be $291,696. This results in a final book value prior to new additions of $7,428,674, which will become the start book value for this series in the next rebalancing period.

It should be apparent that the value of a series of constituents purchased on a given date will likely decrease over time as its constituents drop out of the market index. This is not to say that the value of each series will always decrease, but that over a long term, the value should progressively shrink.

At each rebalancing, an additional series of constituents is created based on the market yields, weights, and prices of the new constituents added to the market index as of the date of rebalancing. In this hypothetical, the fourth row of FIGS. 17A and 17B represents this additional series, incorporating all constituents added to the market index as of the Jan. 31, 2003 rebalancing date, illustrated in column 1705, at their respective values and yields at Jan. 31, 2003. The purchase date for this series is Jan. 31, 2003, as shown in column 1710. The result is two separate series that are monitored separately going forward; the Dec. 31, 2002 series and the Jan. 31, 2003 series. Together these two series comprise the holdings of the BII for the next rebalancing period of February.

On Jan. 31, 2003, the start book value of the Jan. 31, 2003 series was $253,039, shown at 1715 in FIG. 17A, which is equal to the aggregate market value of the new constituents added to the BII on that date. The process as described above is repeated with regards to this series as it was applied to the Dec. 31, 2002 series. The first rebalancing of this series will occur on Feb. 28, 2003. The book return percentage at Feb. 28, 2003 of the Jan. 31, 2003 series was calculated to be 0.307%, as shown in column 1740. The ordinary income percentage was calculated to be 0.307%, as shown in column 1730, and the realized gain/loss percentage was calculated to be 0.000%. Column 1745 of FIG. 17B shows the end of period book value of the Jan. 31, 2003 series, which was $253,817 at the rebalancing date of Feb. 28, 2003, but prior to rebalancing. This value may then be reduced by the rebalancing outflows, which has a calculated value of $1,083, shown in column 1750, resulting in a final book value prior to new additions of $252,734, shown in column 1755. This value will become the start book value for this series in the next rebalancing period.

The fifth row of FIGS. 17A and 17B represents the BII as it existed in February 2003, column 1700, which was comprised of the Dec. 31, 2002 series and the Jan. 31, 2003 series.

The total market value of a marked-to-market index may be determined using the sum of the total market value of the BII prior to additions, column 1765, and the start book value of the series of new constituents created on that date. For example, the total market value prior to additions at the end of January was $7,682,293, shown in column 1765, plus the start book value of the newly added Jan. 31, 2003 series with a value of $253,039, shown at 1715, will equal the total market value of a marked-to-market index.

With each passing rebalancing, the BII adds an additional series of purchased constituents to its holding. Thus, as in our example, at each monthly rebalancing, the existing series are rebalanced, values and/or statistics are calculated and/or determined, and a new series of constituents is added to the BII for subsequent monitoring and rebalancing. This is represented in FIGS. 17A and 17B. The Dec. 31, 2002 series continues to be represented in the sixth row and again in the tenth row of FIGS. 17A and 17B. The Jan. 31, 2003 series continues to be represented in the seventh and eleventh rows. Each series will continue to be monitored and regularly rebalanced until the indexing is complete or until there are no longer constituents in the series to be monitored and rebalanced. The eighth and twelfth rows represent additional series of purchased constituents to the holdings of the BIIS, which are separately monitored and rebalanced as discussed above in this illustration.

FIG. 17B provides additional statistics that are calculated for each series and the total BII. Column 1770 shows the results of calculating the total return percentage for each series of constituents and, ultimately, for the sum of all series. Column 1775 shows the results of calculating the effective duration of the constituents of each series and BII. Of course, calculating total return percentage and effective duration are only a few of the calculable statistics, data, and/or values which may be observed, monitored, examined, compiled, recorded, determined, stored, and/or reported, and/or the like. The process described above may be configured to incorporate any number of values or statistics to be observed, monitored, examined, determined, recorded, stored, and/or recorded.

BookMark Performance Statistics

In addition to the multi-dimensional bond valuation matrix described above in FIGS. 12-16, book income indices may incorporate the observation, monitoring, examination, compilation, recordation, storage, and/or reporting, and/or the like of an expanded set of performance metrics. As discussed above, there are many examples of these performance statistics or metrics. Among these may be the average book yield of the index, basic return measures, including, for example, but not limited to, ordinary income return percentage, capital gain/loss return percentage and book income return percentage, total return percentage, and/or the like. These metrics may be observed, monitored, examined, compiled, recorded, determined, stored, and/or reported, and/or the like on both a pre-tax and post-tax basis.

In one embodiment, the ordinary and capital gain/loss return measures may be tracked at the constituent level. This may assist in calculating post-tax results while taking into account specific tax information, including, but not limited to, specified hypothetical tax rates, investor-specific tax rates, applicable tax laws, and/or the like. For example, a U.S. property and casualty portfolio may be able to exclude 85% of ordinary income on its municipal securities holdings, resulting in an effective tax rate on municipal security ordinary income in a property and casualty portfolio of 5.25% (35%×15%), instead of 35%.

In addition to pre-tax and post-tax yield and return metrics, unrealized gains and/or losses of an index may be tracked over time. For example, in FIG. 17B, the unrealized gain or loss, shown in column 1760, is equal to the difference between the total book value of the index, shown in column 1755, and its total market value, shown in column 1765. Since each index may have a different total book value, the net unrealized gain or loss may vary for each subsidiary inception date index of a given total return index. The ability to track unrealized gains and losses for each inception date series provides the ability to build gain/loss recognition constraints into the construction of a customized base-line index, as discussed below.

Custom Indices—Constituent Selection

The selection and retention of index constituents in an index is determined by the index qualification rules. For most well-recognized, published indices, these rules are targeted at defining a segment or subdivision of a greater market. There are a variety of examples of such targeted indices, as discussed above, including, but not limited to, a U.S. broad investment grade bond index, a non-U.S. biotechnology stock index, a broad investment grade bond index, an emerging market sovereign bond index, and/or the like. For many indices, qualification rules are targeted at defining a segment or subdivision of the market and the weightings of the constituents in each index may be, for example, but is not necessarily, a function of outstanding market capitalization of the qualifying constituents in the index. Index constituent weightings may be constructed in a variety of ways in line with the teachings discussed herein including, but not limited to, giving each constituent equal weighting at inception, specifying certain weightings and/or ranking, and/or the like.

While there may be a large variety of indices, there is also a large range in uses for these indices and an even greater range of performance monitoring needs, guidelines, concerns, factors, considerations, parameters, and/or the like. For example, a market cap index may be useful to the mutual fund industry. Mutual funds typically do not need to fund specific liabilities and, hence, tend not to be duration constrained, and their eligible investment guidelines can generally be tailored to fit the constraints of the market index against which they choose to measure themselves. Life insurance portfolios, on the other hand, have more specific duration needs—needs that are not likely met by market cap indices—not to mention the issue of tax considerations and the resultant implications for the taxable/tax-exempt allocation.

Constituent selection rules may be established from a variety of sources, including, but not limited to, the policy guidelines of the portfolio which is being benchmarked by the index, desired criteria to meet certain performance monitoring needs and/or preferences, and/or the like. For example, to the degree that parameters have been established within which a portfolio manager may operate, then similar conditions may be used in establishing a benchmark, such as, but not necessarily limited to, duration targets, allocations to major asset classes and issuer caps, to name just a few of the constraints that can be built into the construction of a custom index.

Thus, a benchmark BII may be created recognizing such constituent selection rules to meet performance measurement preferences, needs, and/or the like. In one embodiment, a total rate of return index may be constructed using established rules, guidelines, factors, considerations, parameters, and/or the like, that meet certain needs or risk parameters as discussed above. Once the basic total return index has been constructed, however, the index may then be tailored to meet unique book income performance constraints.

One benefit of measuring performance against a benchmark index is that it offers the ability to identify the value added that a portfolio manager has contributed through his or her investment decisions. Some portfolio managers have more flexibility than others when it comes to imparting their views on the composition of a portfolio, but virtually all of them are constrained to some degree by policy guidelines that define the boundaries within which they may operate. Thus, an index operating by similar guidelines might provide better performance measurement utility.

Custom Indices—Inflows and Outflows

In addition to considering the constituents which comprise an index, other types of customization may exist to tailor an index, such as a BII, to the performance measurement preferences. In one embodiment, a BII may be tailored to consider the timing of any inflows and/or outflows. The customization of a book value performance measurement standard, however, is more complex than simply aligning the start date of a benchmark index to the initial funding date of a portfolio. For example, it is common for a portfolio to experience one or more cash inflows and/or outflows over time. These cash flows may be endogenous cash flows, which are generated internally by the portfolio. Endogenous cash flows may be generated by, for example, but not necessarily limited to, interest payments, dividend payments, coupon payments, removed securities, maturing securities, and/or the like. The cash flows may also be exogenous cash flows, which may result from the deposit to or withdrawal from a portfolio. It is possible for a portfolio to experience endogenous cash flows, exogenous cash flows, both, or either.

Exogenous cash flows can significantly impact expected performance. For example, a large deposit or withdrawal at any given time can significantly alter the metrics and values measured, as discussed above, including, but not limited to the book yield of a portfolio, ordinary income going forward, and/or the like. Additionally, for example, a withdrawal can trigger a recognized capital gain or loss that may have an immediate impact on current and future results of the portfolio. If an index is used to monitor the performance of a portfolio, it may be desirable to consider the ramifications of such cash inflows and/or outflows in addition to the timing of such cash flows on the index. The impact that start dates may have on values such as book yield and book value may be significant, as discussed above. It is possible, of course, for an exogenous inflow and an exogenous outflow to occur during the same period. Although, there may be a number of ways to handle such a situation, one way may be to treat the two separately, first removing BII holdings to meet the exogenous outflow, then using the exogenous inflows to acquire new constituents. Another alternative is to cancel out exogenous inflows with exogenous outflows and use the net balance as a single exogenous cash inflow or outflow. Additionally, endogenous outflows may be canceled out by exogenous outflows.

Therefore, in one embodiment, a custom index may be constructed to facilitate performance measurement in the face of endogenous and/or exogenous cash flows. While it is not necessary that a BII be used as a performance monitoring benchmark for a given portfolio in order to incorporate a customization to cope with endogenous and/or exogenous cash flows, it is nevertheless an embodiment incorporating such customization techniques and is useful in illustrating one application of these techniques. As discussed above, there may be multiple uses of an index and, thus, the principles discussed herein are equally applicable to any use of an index. For example, a hypothetical scenario may be created involving exogenous cash flows. Other examples may be the administration of endogenous cash flows in any index, whether matched to a portfolio, selected from a list of established indices, custom-made, and/or the like. Therefore, it should be understood that the term cash flow as discussed herein is representative of any assigned or calculated numerical value used in terms of the BII and shall not be restricted to, but at least incorporate, a physical monetary amount. The embodiments discussed below provide further illustration of how a BII may incorporate the timing and amount of such endogenous and/or exogenous cash flows.

As discussed above, an index may be segmented into various purchase lots. These lots provide greater flexibility to facilitate the customization of an index. Such index lots, in one embodiment, may be used to create a custom index. In fact, in one embodiment, a custom index may be created which has been tailored to incorporate cash flow and the timing of cash flow through implementation of multiple purchase lots.

Administering Inflows and Outflows

There are a variety of methodologies for assembling index lots into a cash flow tailored custom index. One embodiment of the system is directed to the use of such index lots to cope with endogenous and/or exogenous cash flows and includes any desired form of reinvestment of the cash flows including a choice to reinvest all, none, or a portion of endogenous and/or exogenous cash flow. The use of the terms reinvest, reinvesting, reinvests, reinvestment, and/or the like are not intended to be restricted to an actual, physical investment of monetary funds, but is used for convenience as a way to describe a process of calculating certain values, whether internal and/or external to an index, fund, portfolio, and/or the like, and determining whether and how to reincorporate such values into an index. Below are just three examples of the many ways in which an index might invest endogenous and/or reinvest exogenous cash flow. These investment and reinvestment methodologies are intended to be illustrations of the possible investment or reinvestment of cash flow in an index, are representative only, and are not exhaustive and/or exclusive.

One method for reinvesting cash flows in an index entails the reinvestment of cash flow into the full base-line index. In this example, each constituent of the entire base-line index is purchased at the start date at the current market values, yields, prices, and/or the like at the point in time of the acquisition of such constituent. Thereafter, endogenous outflows and/or exogenous inflows may be used to purchase new lots comprised of constituents of the entire base-line index at the current market values, yields, prices, and/or the like at the point in time each new lot is purchased. For example, once the value of endogenous and/or exogenous cash flows for the index has been calculated, a purchase lot comprised of each constituent of the base-line index may be created with the proper market weightings, which may be determined as discussed above, where the newly created purchase lot as a whole has a value equal to, or similar to, the value of endogenous and/or exogenous cash flow.

It is not necessary, as discussed above, that the value of a new index purchase lot be equal to, or similar to, the value of endogenous and/or exogenous cash flow. However, in order to simplify illustration of the examples for possible reinvestment methodologies, it will be assumed that the BII will attempt to reinvest the entire value of endogenous and/or exogenous cash flow or as much of the entire value as is reasonably practical or desirable.

Exogenous outflows in this example may be removed from endogenous cash flows and/or from exogenous inflows. Exogenous outflows may also, in addition to or in the alternative, be met by removing constituents from all outstanding index lots on a pro-rata basis, or on the basis of some other form of allocation, sufficient in total value to meet the exogenous outflow.

One benefit of such a reinvestment methodology might be as a benchmark to a portfolio looking to measure the portfolio managers' selection skill relative to the full opportunity set as represented by outstanding issues in a given market index, where the portfolio is not concerned with the evolution or performance of the base-line index structure over time.

Another method for reinvesting cash flows in an index entails the reinvestment of cash flow into the new additions of a base-line index. In this example, after purchasing the entire base-line index at the start date at current market values, yields, prices, and/or the like, all endogenous cash flow may be used to purchase new lots comprised of constituents added to the base-line index since the date of the last rebalancing, or start date if a rebalancing has not occurred, at the current market values, yields, prices, and/or the like at the point in time each new lot is purchased. All exogenous inflows, in this example, may be used to purchase new lots comprised of constituents of the entire base-line index at the current market values, yields, prices, and/or the like at the point in time each new lot is purchased. Alternatively, it is possible that endogenous and exogenous cash flows may be used to purchase new lots comprised of constituents added to the base-line index.

Exogenous outflows in this example may be removed from endogenous cash flows and/or from exogenous inflows. Exogenous outflows may also, in addition to or in the alternative, be met by removing constituents from all outstanding index lots on a pro-rata basis, or on the basis of some other form of allocation, sufficient in total value to meet the exogenous outflow.

One benefit of such a reinvestment methodology might be as a benchmark to a portfolio looking to measure the portfolio managers' selection skill relative to the full opportunity set as represented by new issues entering a given market index, where the portfolio is not concerned with the evolution or performance of the base-line index structure over time, but is concerned with newer constituents of a base-line market index as compared to seasoned constituents of the index or at least more so than the previous methodology. Another benefit of this reinvestment methodology is that it may be able to more closely reflect the structure of the base-line index in comparison to the previous methodology.

Another method for reinvesting cash flows entails replicating the base-line index as scaled to endogenous and/or exogenous cash flow. In this example, after purchasing the entire base-line index at the start date at current market values, yields, prices, and/or the like, all endogenous cash flows and/or exogenous inflows may be used to purchase combinations of new lots comprised of constituents of the entire base-line index and new lots comprised of constituents added to the base-line index since the date of the last rebalancing, or start date if a rebalancing has not occurred, all at the current market values, yields, prices, and/or the like at the point in time each new lot is created. The ratio between or among the lots based on the full base-line index and the lots based on the new additions to the base-line index is scaled so as to keep the composition of the entire index in sync with the base-line index. It is of course understood that it may not be possible to completely mirror the base-line index, but, in this example, maintaining a composition in the entire index near to that of the base-line index is sufficient.

Exogenous outflows in this example may be removed from endogenous cash flows and/or from endogenous inflows. Exogenous outflows may also, in addition to or in the alternative, be met by removing constituents from all outstanding index lots on a pro-rata basis sufficient in total value to meet the exogenous outflow. If necessary, a larger pro-rata share of all outstanding lots may be removed to help meet exogenous outflows and the excess value of the removed constituents above the value of exogenous outflows, if any exists, may be reinvested back into a new lot comprised of constituents added to the base-line index so as to keep the entire index composition in sync with the base-line index.

Administering Capital Gain/Loss Constraints

One aspect of the BIIS involves how an index deals with capital gain or capital loss constraints. Capital gain/loss constraints for an index can significantly affect book income and total return performance of an index. Capital gain/loss constraints may be established for an index based on the gain/loss constraints of a portfolio to which the index is a benchmark, chosen as a performance measurement preference of an index of securities, as part of a hypothetical scenario to test the performance of an index of securities, and/or the like.

Capital gains and/or capital losses for any given period may be used to offset the other. The sale or removal of constituents from an index should generate what may be calculated as capital gains or losses. In order to meet capital gain/loss constraints, it may be necessary to sell certain constituents of an index in order to generate capital gains or losses. The removal of such constituents and their corresponding values, generating a capital gain or loss, may be used to offset other capital gains or losses to bring the index inline with the gain/loss constraints. Alternatively, there may be other mechanisms for achieving a gain/loss constraint, such as the reversal of a preliminary rebalancing removal.

Once the constituents of an index are sold, the proceeds from such a sale may be used to reinvest in the index. Such a reinvestment may constitute the purchase of securities to the index at current market values, yields, prices, and/or the like. Such a reinvestment may be in the same securities that were sold, in different securities, both, or neither.

For example, where an index is used as a benchmark to a portfolio, a book income-oriented portfolio manager may be constrained with respect to capital gain/loss recognition. These constraints may take the form of strict boundaries on gain or loss recognition, such as a constraint that recognized gains or losses are to be avoided, which can limit the portfolio manager's ability to buy and or sell securities. These constraints may also limit the portfolio manager's ability to keep pace with rebalancing turnover in a benchmark index. As such, gain/loss constraints may cause portfolio and its benchmark durations, and other risk characteristics, to drift apart over time, which may lead to severe anomalies in performance comparisons versus the benchmark index. These constraints may also take the form of mandated capital gain/loss targets, such as setting a level of capital gains or capital losses in a particular accounting period that a portfolio may meet. Where a portfolio manager has such, or similar, capital gain/loss constraints, it may be beneficial to customize the benchmark BII in a similar fashion to more closely reflect the circumstances of the portfolio.

The recognition of gains or losses may have an immediate impact on current period book returns. It may also have a future impact on ordinary income as the proceeds of securities sold in order to generate the required gains or losses in this case are reinvested at current market values, yields, prices, and/or the like, which can significantly affect the average book yield and other metrics of the portfolio.

One embodiment of the BII, where the index acts as a benchmark to a portfolio, may set the threshold for allowable capital gains and losses at zero causing the sale of a portion of index holdings in order to match the established limits. For example, if the routine rebalancing causes a gain or a loss, this may be offset by the sale, or removal, of constituents in the index that would allow for the appropriate loss or gain.

Another embodiment of the BII may establish small allowable limits for capital gains and/or losses in a BII, which may provide a range which allows for the typical rebalancing changes that may occur over time during performance monitoring to operate within, without requiring any sale or removal of index constituents to generate offsetting gains or losses. As discussed above, an index may naturally generate small capital gains or losses as part of the monthly rebalancing process as constituents drop out of the index. Occasionally, these rebalancing capital gains and losses can be more significant. For example, where there is a significant exogenous outflow from the index, or where a change in the qualifying rules for an index, such as an increase in minimum size filters, forces the departure of a significant portion of holdings from the index, capital gains or losses may be larger than those of a typical rebalancing of the same index. In these circumstances, the larger gains or losses that may be triggered by these events may be offset by the sale, or removal, of constituents in the index that would allow for the appropriate offsetting loss or gain.

In yet another embodiment of the BII, constraints may be set on the index requiring that certain gains/losses be recognized in any given performance period. The targeted gains or losses may be achieved by the sale, or removal, of constituents in the index that would allow for the appropriate gain or loss.

In one embodiment of the BII, where the sale, or removal, of constituents is necessary to meet certain capital gain/loss constraints, the holdings of the index may be grouped into two pieces: holdings with unrealized gains and holdings with unrealized losses. Once grouped, a sale of the holdings with the appropriate unrealized gain or loss may be conducted to achieve the target capital gain/loss constraint.

For example, if the rebalancing of an index generates capital gains above the threshold set by the capital gain constraint, the holdings of the index may be grouped according to unrealized gains and unrealized losses, and a sale of certain index holdings with unrealized losses may be used to offset the capital gains generated by the rebalancing.

This sale of index holdings may be performed in a number of ways and not necessarily limited to the examples discussed herein including, but not limited to, a sale of a pro-rata share of all holdings in the appropriate group (with unrealized gains or unrealized losses), a sale of holdings meeting some specified requirements like age, size, type, and/or the like, a sale of specified holdings that sufficiently meet the target capital gain/loss amount, and/or the like.

Applying Inflows and Outflows

The following examples illustrate a BII for a sample portfolio following each of the three rebalancing methodologies described above. Each example is a hypothetical situation used to illustrate how a BII might cope with an inflow or outflow of value or apply cash flow constraints. Each example describes a BII used as a benchmark to a portfolio. Each index will be constructed and customized in order to closely reflect the constraints placed on the portfolio, including portfolio deposits and withdrawals.

The hypothetical sample portfolio for which the index will be a benchmark will have an initial funding of a $100,000,000 deposit on Dec. 31, 2003 and includes a series of subsequent deposits and withdrawals. The base-line index in each example will be a broad investment grade bond index and the index will be rebalanced at the end of each month of performance monitoring, recognizing any exogenous cash flow reflecting deposits and withdrawals of the portfolio at the monthly rebalancings.

FIGS. 19-44B provide illustrations for the following hypothetical examples to assist in the explanation of these examples and the system disclosed. They of course are not exhaustive and/or exclusive and aspects of each may be used with aspects of another.

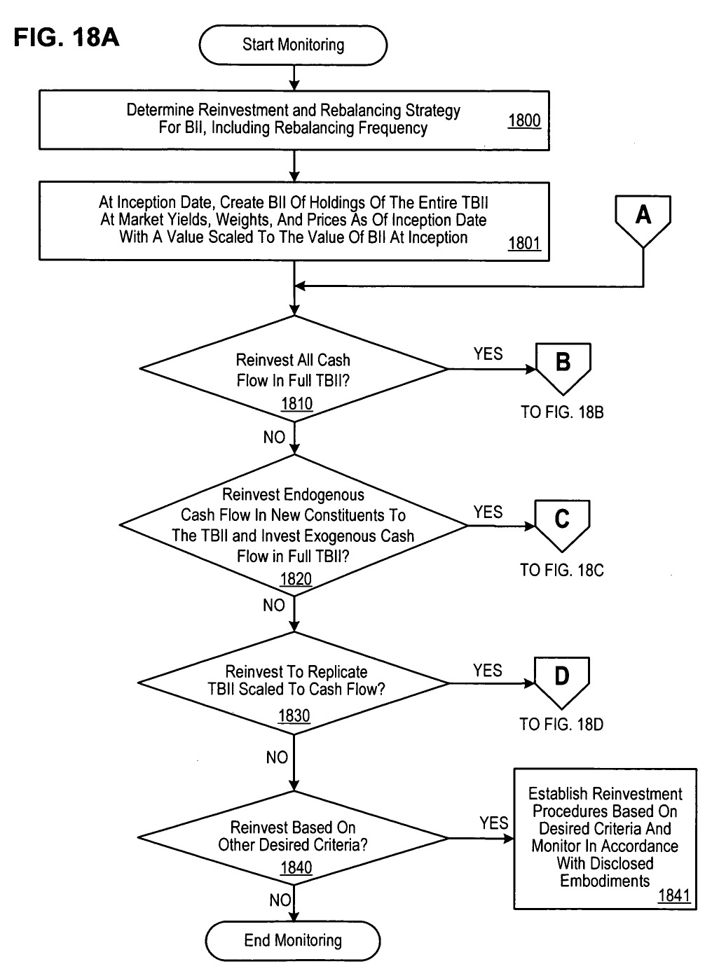

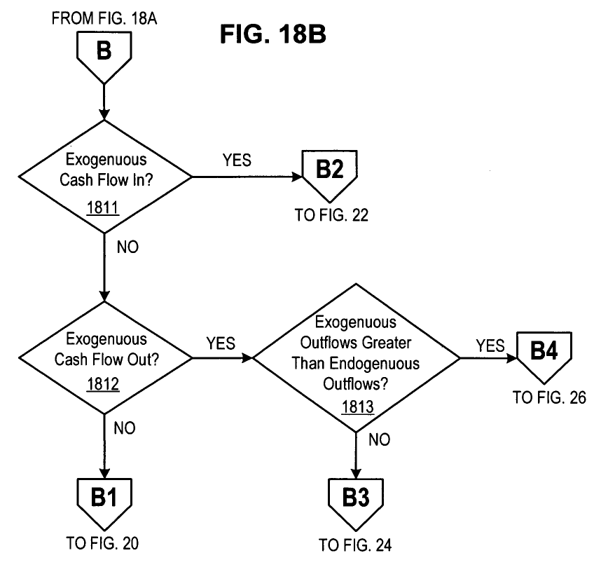

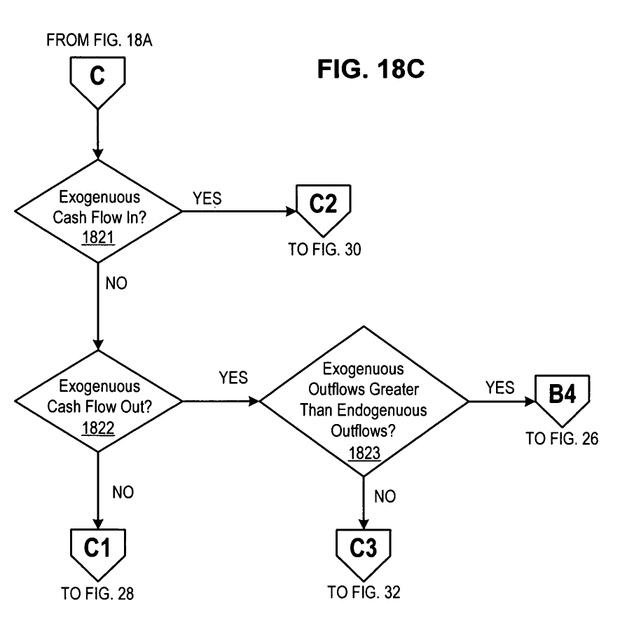

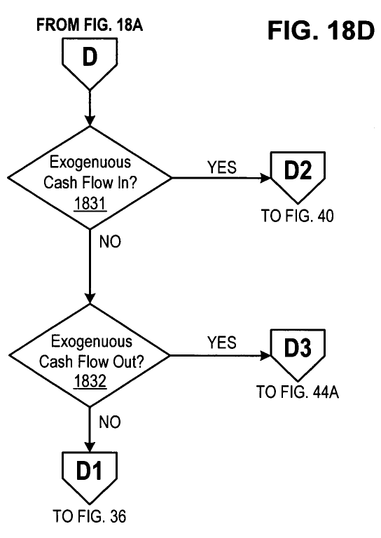

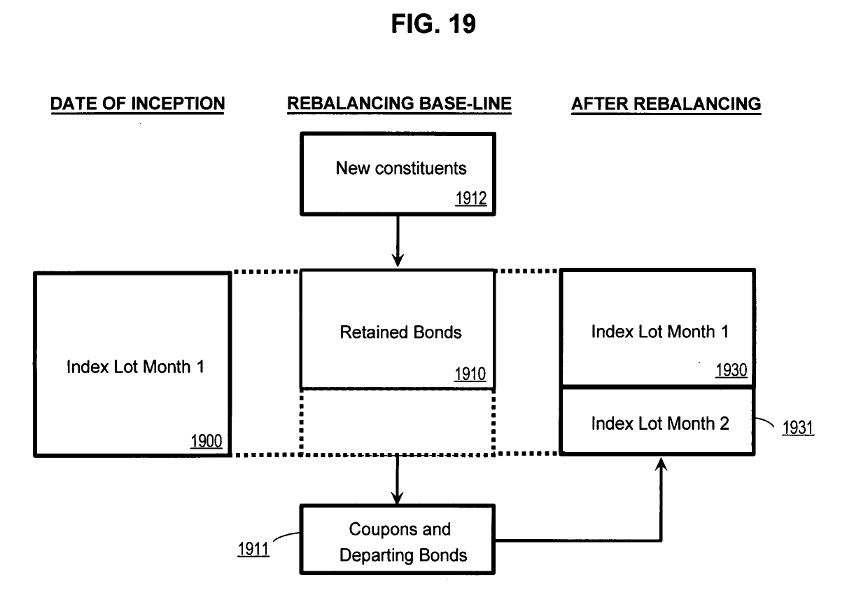

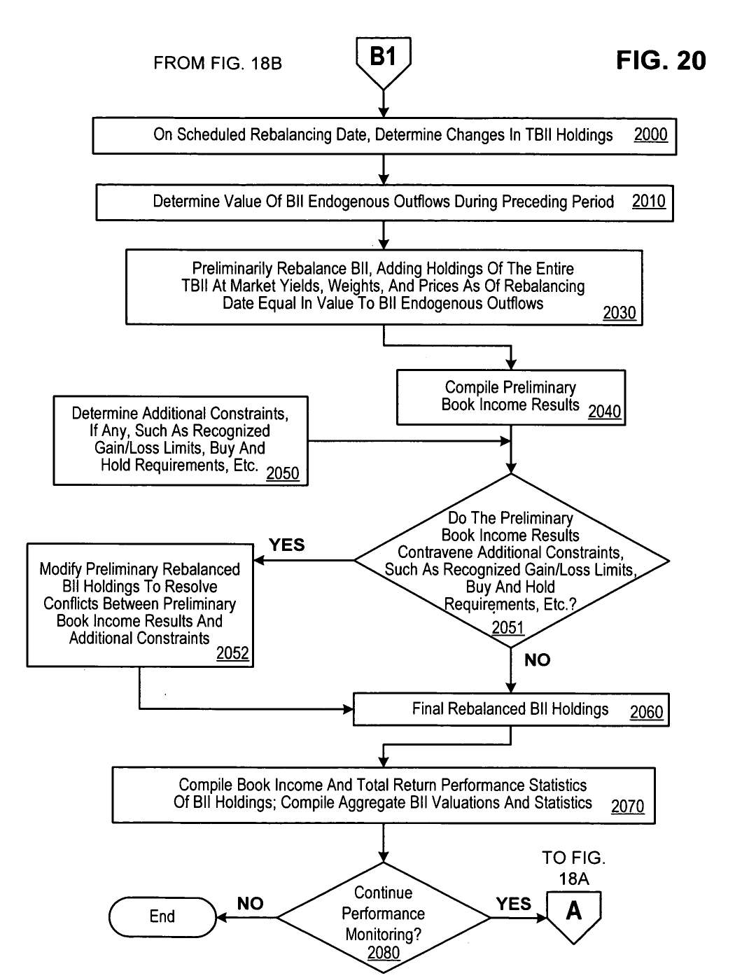

FIGS. 18A-18D provide a roadmap for FIGS. 19-44B, which follow. FIGS. 18A-18D are merely illustrations to assist in understanding the context of the hypothetical examples and correlating figures discussed below.

FIG. 18A provides a logic flow diagram with three of the rebalancing methodologies discussed herein as options for reinvestment and a fourth option for establishing a reinvestment strategy for subsequent performance monitoring. Once the decision has been made to start performance monitoring with an index, a determination may be made as to what rebalancing strategy is desired for the BII 1800. This determination 1800 may incorporate a number of sub-determinations, decisions, factors, inputs, and/or the like relating to the reinvestment strategy, including, but not limited to, rebalancing frequency, portfolio data, applicable or desired constraints, rebalancing methodology, and/or the like.

Once this determination 1800 has been made, the BII is created comprising all of the holdings of the base-line index equal to the full value of the BII at inception 1801. Each constituent is added to the BII at the current market yield, weight, price, and/or the like at the date it was added to the index. At this point, this would be the date of inception. The total market value of the BII is scaled to equal the book value of the portfolio on the inception date. The index will retain these holdings through all subsequent rebalancings for the duration of performance monitoring as long as they remain holdings of the base-line index.

Once a BII has been created, the determination of how to rebalance the index may be made. Query 1810 provides the option of reinvesting cash flows into the full base-line index at rebalancing as discussed above. If the result of this query is positive, and reinvestment into the full base-line index is desired, the next step in this logic flow diagram is to go to FIG. 18B, which illustrates additional considerations for rebalancing, as discussed below. If the result of this query is negative, the next step is to go to the next query.

Query 1820 provides the option of reinvesting endogenous cash flows into the new additions to the base-line index at the rebalancing and investing exogenous cash inflows into the full base-line index at rebalancing. If the result of this query is positive, and reinvestment of endogenous cash flow into new constituents of the full base-line index and investment of exogenous cash inflow into the full base-line index is desired, the next step in this logic flow diagram is to go to FIG. 18C, which illustrates additional considerations for rebalancing, as discussed below. If the result of this query is negative, the next step is to go to the next query.

Query 1830 provides the option of reinvesting cash flows in order to try to replicate the base-line index as scaled to endogenous and/or exogenous cash flow at rebalancing as discussed above. If the result of this query is positive, and replicating the base-line index is desired, the next step in this logic flow diagram is to go to FIG. 1 8D, which illustrates additional considerations for rebalancing, as discussed below. If the result of this query is negative, the next step is to go to the next query.

Query 1840 provides the option of reinvesting cash flows according to another rebalancing methodology, which was not provided in queries 1810, 1820, or 1830. If the result of this query is positive, the next step is to select a rebalancing technique based on the performance measurement preferences in line with, but not necessarily duplicating, the disclosed embodiments discussed herein and, ultimately monitor the performance of the BII according to the chosen rebalancing technique 1841. If the answer to this query is negative, reinvestment according to these hypothetical examples may not be applicable.

There is, of course, no significance that should be attached to the order chosen for the steps of FIG. 18A. It is merely an illustrative roadmap providing selected rebalancing methodology options.

FIG. 18B provides a logic flow diagram concerning exogenous and endogenous cash flows with respect to reinvesting such cash flows into the full base-line index at rebalancing. Depending upon whether there is an exogenous inflow, exogenous outflow, and/or endogenous cash flow, a BII may be constructed so as to recognize such cash flow and FIG. 18B provides an illustrative map to the various illustrative examples discussed herein concerning the reinvestment of cash flow into the full base-line index at rebalancing.

There is, again, no significance attached to the order chosen for the queries of FIGS. 18B, 18C, and 18D. It is merely an illustrative roadmap providing a guide to the various rebalancing methodology options discussed below. It is, of course, also expected that, although each of the examples outlined below are discussed separately, no significance should be placed on the discussion of various portions of the system separately from any other piece of the system. Many features discussed herein may be used in conjunction or combination with one another, as long as they do not contradict one another or cause the claimed system to be inoperable.

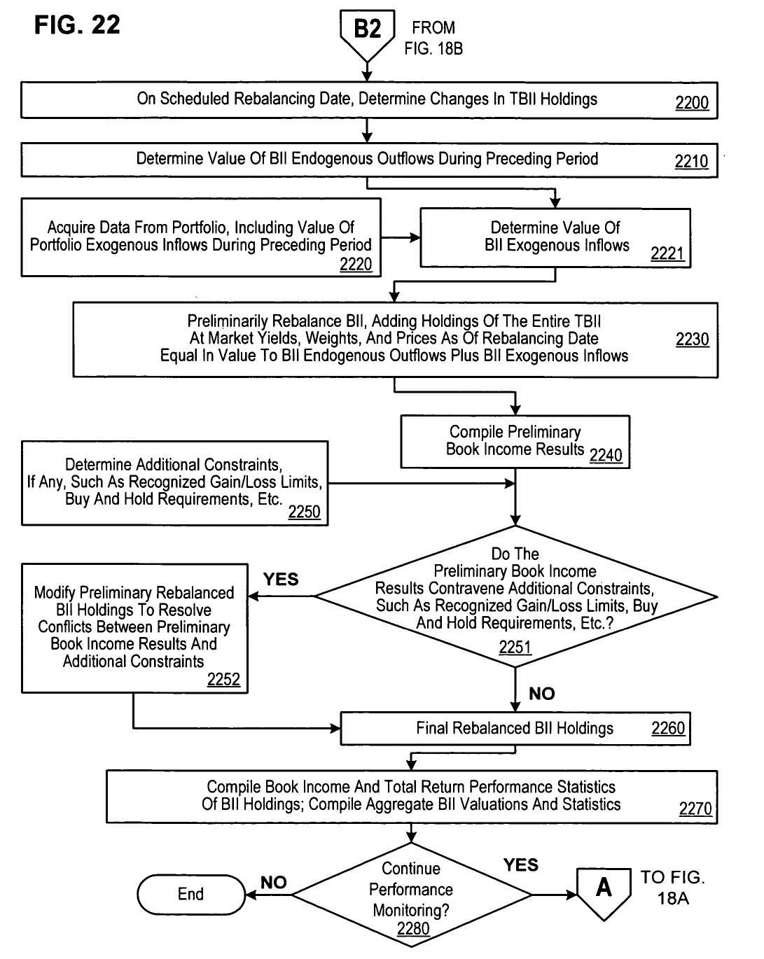

Query 1811 of FIG. 18B provides the opportunity to reflect any exogenous inflows in the index. If it is determined that an exogenous inflow exists and that it should be reflected in the index, a positive response to query 1811 will lead to FIG. 22, which provides an illustrative logic flow diagram for this hypothetical example and is discussed below. If it is determined that an exogenous inflow will not be reflected in the index, a negative response to query 1811 will lead to a determination of whether other cash flows exist and should be reflected in the index.

Query 1812 provides the opportunity to reflect any exogenous outflows in the index. If it is determined that an exogenous outflow exists and that it should be reflected in the index, a positive response to query 1812 will lead to a determination of how to reflect such an outflow with respect to endogenous outflows 1813. It is assumed for these examples that there are at least some endogenous outflows for the index. If exogenous outflows are not greater than endogenous outflows of the index, a negative response to query 1813 will lead to FIG. 24, which provides an illustrative logic flow diagram for this hypothetical example and is discussed below. If exogenous outflows are greater than the endogenous outflows of the index, a positive response to query 1813 will lead to FIG. 26, which provides an illustrative logic flow diagram for this hypothetical example and is discussed below. If it is determined that an exogenous outflow will not be reflected in the index, a negative response to query 1812 will lead to FIG. 20, which provides an illustrative logic flow diagram for this hypothetical example and is discussed below.

FIG. 18C provides a logic flow diagram concerning exogenous and endogenous cash flows with respect to reinvesting endogenous cash flows into the new additions of a base-line index at rebalancing and investing exogenous inflows into the full base-line index at rebalancing. Depending upon whether there is an exogenous inflow, exogenous outflow, and/or endogenous cash flow, a BII may be constructed so as to recognize such cash flow and FIG. 18C provides an illustrative map to the various illustrative examples discussed herein concerning the reinvestment of endogenous cash flows into the new additions of a base-line index at rebalancing and investing exogenous inflows into the full base-line index at rebalancing.

Query 1821 provides the opportunity to reflect any exogenous inflows in the index. If it is determined that an exogenous inflow exists and that it should be reflected in the index, a positive response to query 1821 will lead to FIG. 30, which provides an illustrative logic flow diagram for this hypothetical example and is discussed below. If it is determined that an exogenous inflow will not be reflected in the index, a negative response to query 1821 will lead to a determination of whether other cash flows exist and should be reflected in the index.

Query 1822 provides the opportunity to reflect any exogenous outflows in the index. If it is determined that an exogenous outflow exists and that it should be reflected in the index, a positive response to query 1822 will lead to a determination of how to reflect such an outflow with respect to endogenous outflows 1823. If exogenous outflows are not greater than endogenous outflows of the index, a negative response to query 1823 will lead to FIG. 32, which provides an illustrative logic flow diagram for this hypothetical example and is discussed below. If exogenous outflows are greater than the endogenous outflows of the index, a positive response to query 1823 will lead to FIG. 26, which provides an illustrative logic flow diagram for this hypothetical example and is discussed below. If it is determined that an exogenous outflow does not exist or will not be reflected in the index, a negative response to query 1822 will lead to FIG. 28, which provides an illustrative logic flow diagram for this hypothetical example and is discussed below.

FIG. 18D provides a logic flow diagram concerning exogenous cash flows with respect to reinvesting such cash flows in an attempt to replicate the base-line index as scaled to endogenous and/or exogenous cash flow at rebalancing. Depending upon whether there is an exogenous inflow, exogenous outflow, and/or endogenous cash flow, a BII may be constructed so as to recognize such cash flow and FIG. 18D provides an illustrative map to the various illustrative examples discussed herein concerning the reinvestment of cash flow in an attempt to replicate the base-line index.

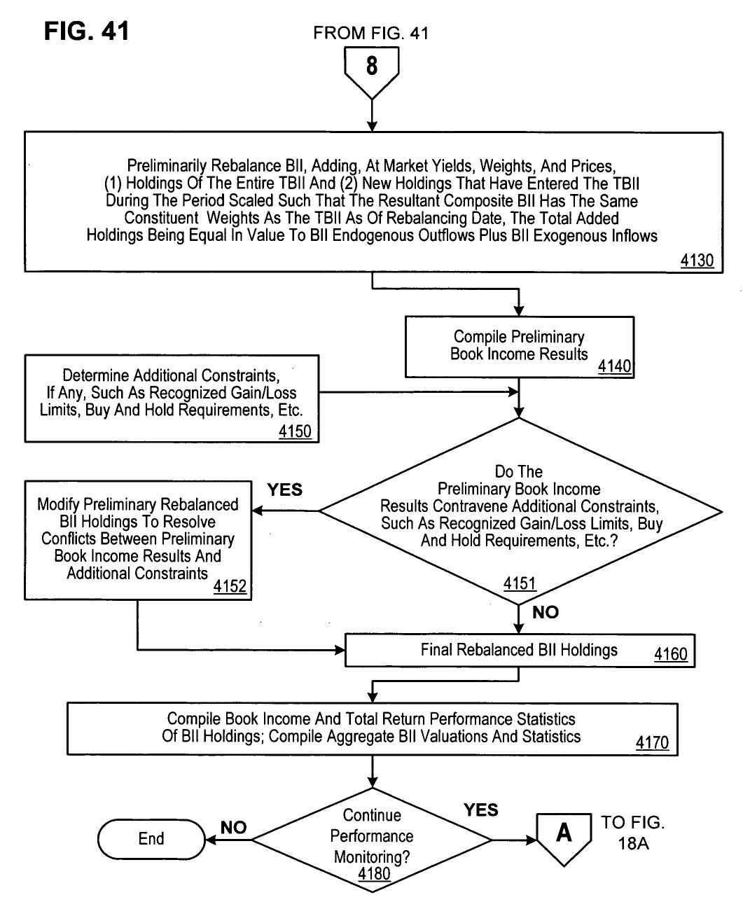

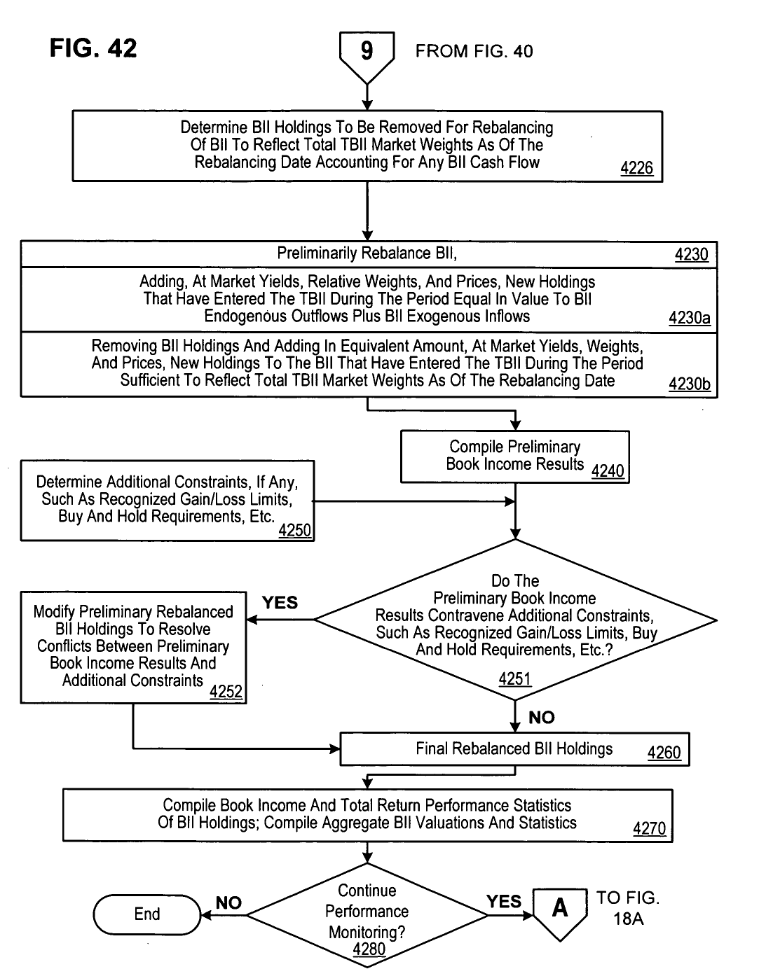

Query 1831 provides the opportunity to reflect any exogenous inflows in the index. If it is determined that an exogenous inflow exists and that it should be reflected in the index, a positive response to query 1831 will lead to FIG. 40, which provides an illustrative logic flow diagram for this hypothetical example and is discussed below. If it is determined that an exogenous inflow will not be reflected in the index, a negative response to query 1831 will lead to a determination of whether other cash flows exist and should be reflected in the index.

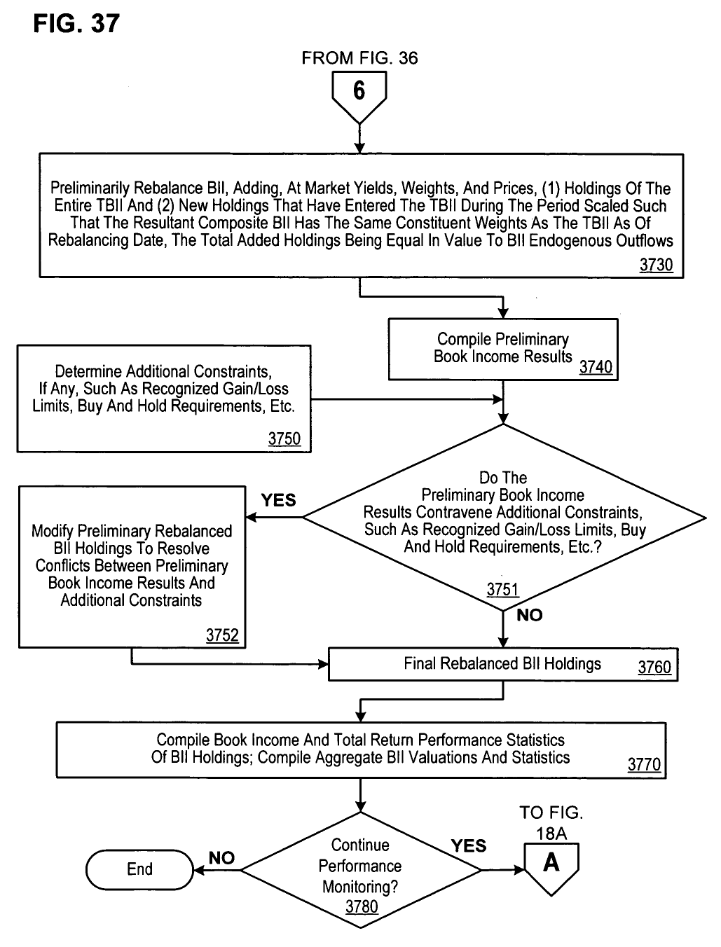

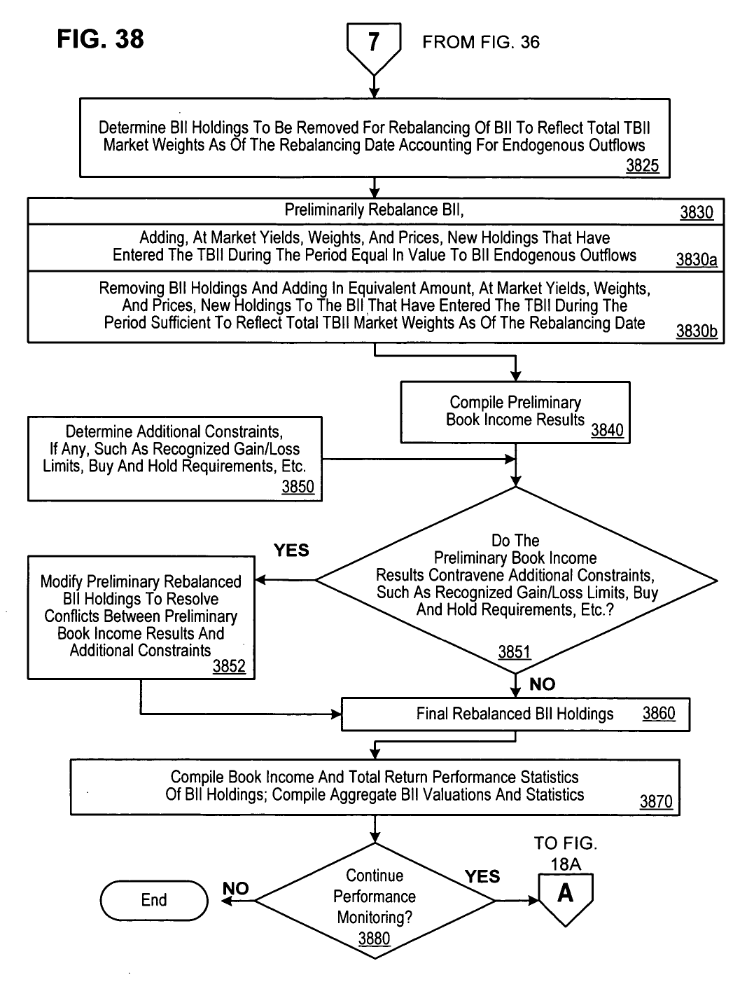

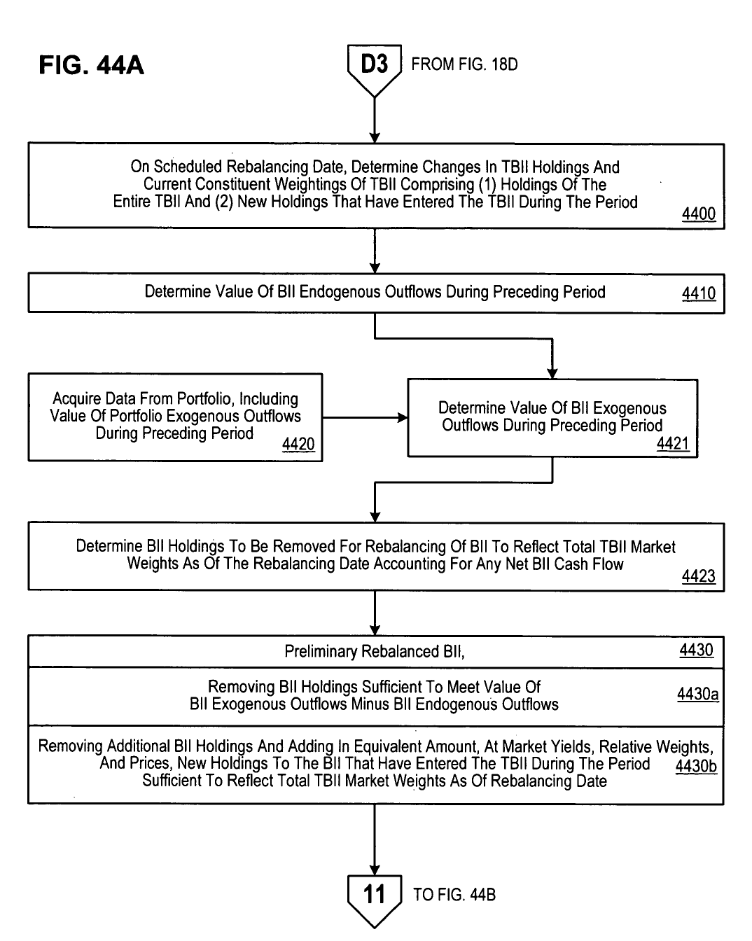

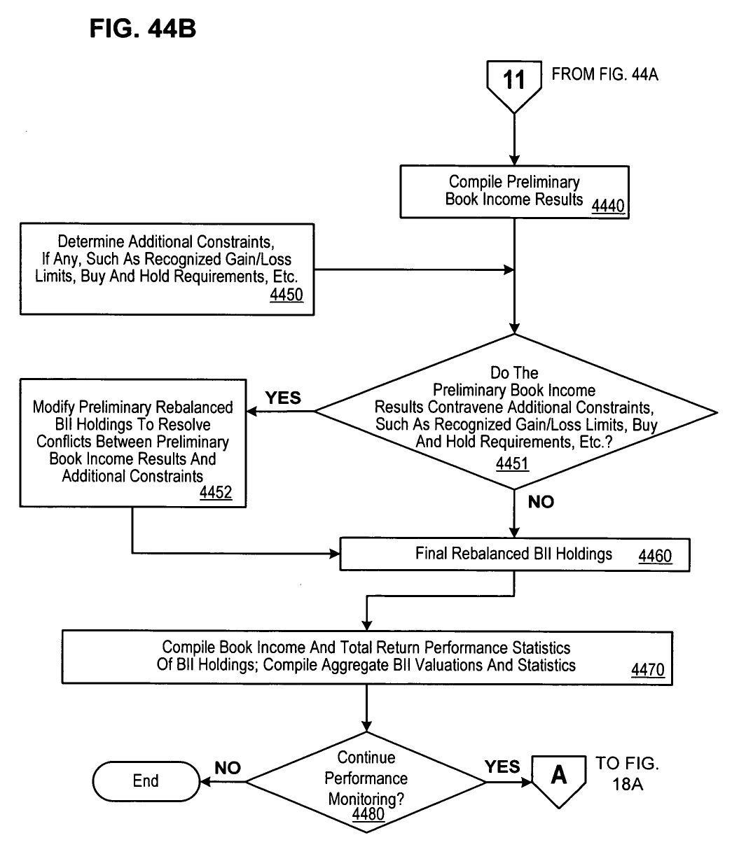

Query 1832 provides the opportunity to reflect any exogenous outflows in the index. If it is determined that an exogenous outflow exists and that it should be reflected in the index, a positive response to query 1832 will lead to FIG. 44A, which provides an illustrative logic flow diagram for this hypothetical example and is discussed below. If it is determined that an exogenous outflow will not be reflected in the index, a negative response to query 1832 will lead to FIG. 36, which provides an illustrative logic flow diagram for this hypothetical example and is discussed below.

FIGS. 18A-18D provide context to the examples discussed below and have provided an order for discussing each of the examples. Below is a discussion of these examples to illustrate various embodiments of the BII rebalancing and reinvestment under each of the three methodologies discussed above.

### EXAMPLE 1

### Investment of All Cash Flow in the Full Base-Line Index

This first example describes a hypothetical BII that rebalances monthly reflecting a base-line index and is used as a benchmark to a portfolio. At inception, the BII starts with an acquisition of the entire base-line index at market yields, weights, prices, and/or the like on the day of inception. This BII then uses the value of cash flow, endogenous and/or exogenous, to purchase new lots comprising the holdings of the entire base-line index, each with market yields, weights, prices, and/or the like on the day of acquisition into the index. The start date and initial value of this index coincides with the initial funding date and value of the portfolio. The index will then retain all of the bonds that remain in the base-line index through all subsequent rebalancings for the duration of the performance monitoring.

Upon rebalancing, endogenous outflows caused by rebalancing are then reinvested through a purchase of a lot comprising the entire base-line index at current market yields on the day of purchase (and rebalancing). Any index exogenous inflows, reflecting deposits into the portfolio, are invested in a similar fashion to endogenous outflows. Any index exogenous outflows, reflecting withdrawals from the portfolio, in excess of endogenous outflows from rebalancing are removed from all previously purchased index lots on a pro-rata basis. The value of endogenous outflows, in this example, will first be used to cover the value of any exogenous outflows. If there is a surplus of endogenous outflow above the value of any exogenous outflows, such surplus will be reinvested as discussed above. If the value of endogenous outflows is lower than the value of exogenous outflows, the deficit is removed from all previously purchased index lots on a pro-rata basis as discussed above.

The index will be investing in a standard, non-customized, base-line index encompassing the broad U.S. investment grade bonds market (“Base”) and involve a series of exogenous cash flows reflecting deposits to and withdrawals from the portfolio. An example of such an index may be the Merrill Lynch Broad Market Investment Grade Index. Below are descriptions of select periods during the performance monitoring of the index to provide an illustration of the performance of this index.

### EXAMPLE 1

### First Month—No Exogenous Cash Flow

The first lot of the BII is created on Dec. 31, 2003 with a value of $100,000,000 comprised of the entire holdings of a broad U.S. investment grade bond market index, referred to in these examples as the base-line index. During January, the BII, comprised of the initial lot purchased, generates a 0.310% ordinary income return and a 0.001% capital gain return. The small capital gain was caused by bonds exiting the base-line index and reflecting the exit of such bonds in the BII at the Jan. 31, 2004 rebalancing at market prices that were slightly higher, on average, than their book prices. These returns increased the book value of the index prior to removal of endogenous cash flow to a value of $100,311,440. Part of this value is comprised of endogenous outflows worth $2,131,945. This value may be removed from the initial purchase lot (Base-Full December 2003) and reinvested in current holdings of the base-line index. The result of reducing the book value of the initial purchase lot (Base-Full December 2003) by the net rebalancing endogenous outflow is a final book value of the initial purchase lot (Base-Full December 2003) of $98,179,495. This amount may then be carried forward to the next month as the February starting book value for this purchase lot (Base-Full December 2003).

The $2,131,945 value from endogenous outflows may then be invested in a new purchase lot (Base-Full January 2004) comprised of the holdings of the entire base-line index purchased at market values, yields, prices, and/or the like on Jan. 31, 2004. After the Jan. 31, 2004 rebalancing, the BII is comprised of two purchase lots or subsidiary book income indices, one created on Dec. 31, 2003 (Base-Full December 2003) with a value of $98,179,495 and the other created on Jan. 31, 2004 (Base-Full January 2004) with a value of $2,131,945.

FIG. 19 provides an illustrative representation to assist with describing this example. This illustrates a rebalancing of a BII to reflect the reinvestment of endogenous outflows where there are no exogenous inflows or outflows. Although this figure involves a single index purchase lot at inception, it is understood that this may be equally applicable to an index with multiple index purchase lots, but is shown with a single index purchase lot for ease of illustration. The block diagrams incorporated and discussed herein are not drawn to scale and are not intended to depict actual values or physical actions, but are used as an illustrative tool to assist with understanding the system.

The first BII lot 1900 (Base-Full December 2003) purchased on the Dec. 31, 2003 for $100,000,000 is shown on its inception date. On Jan. 31, 2004, the first lot 1900 (Base-Full December 2003) is rebalanced, retaining the bonds retained by the base-line index at rebalancing and releasing the bonds that have left the base-line index by the rebalancing date, represented as a rebalanced lot 1910. The value of released constituents and coupon payments 1911 reflects the bonds that have left the BII and the interest payments made by the assets in the market corresponding to the BII constituents. This represents the endogenous outflows 1911.

On the rebalancing date, Jan. 31, 2004, the value of the first index purchase lot 1900 may be adjusted to reflect the updated status of the base-line index, represented as the index purchase lot after rebalancing. This index purchase lot (Base-Full December 2003) has an initial updated value of $100,311,440, which is then reduced by endogenous outflows 1911 with a value of $2,131,945, reflecting the endogenous outflows of the base-line index. The resulting lot (Base-Full December 2003) 1910 has a reduced value of $98,179,495, which is carried forward as an index purchase lot 1930 for the application of additional constraints or possible subsequent rebalancings.

The value of endogenous outflows 1911 here is $2,131,945, reflecting the value of endogenous outflows calculated for the BII. This amount is reinvested in the entire base-line index on Jan. 31, 2004, which, at that point, would incorporate any new constituents 1912 that have entered the base-line index since Dec. 31, 2003, along with all existing securities that entered the base-line index on or before Dec. 31, 2003 that remain in the base-line index on Jan. 31, 2004, creating an additional index purchase lot 1931 with a value of $2,131,945. After rebalancing, this BII is comprised of two index purchase lots: the first index purchase lot 1930 created Dec. 31, 2003 (Base-Full December 2003) with a value of $98,179,495 and the second index purchase lot 1931 created on Jan. 31, 2004 (Base-Full January 2004) with a value of $2,131,945.

FIGS. 18A, 18B, and 20 provide yet another representation to assist with describing this scenario in the hypothetical example. Referring to the logic flow diagram of FIG. 18A, once performance monitoring commences on Dec. 31, 2003, a determination 1800 is made concerning what reinvestment and rebalancing strategy has been established for the BII. At this point in the example, it is determined that the index will be rebalanced monthly investing the value of all cash flow, endogenous and/or exogenous, in the full base-line index.

Once these determinations 1800 have been made concerning the BII, an index purchase lot, or subsidiary BII, may be created 1801 investing the entire value of the BII in the full base-line index at market yields, weights, prices, and/or the like. In this example, the index is comprised of one acquisition of the entire base-line index (Base-Full December 2003) on Dec. 31, 2003 with a value of $100,000,000.

After creating a BII 1801, the process of rebalancing may unfold. In this scenario, endogenous outflow is reinvested into an acquisition of the full base-line index at rebalancing. Thus, the answer to query 1810 of whether to reinvest all cash flows in the full base-line index is yes. Since this is the preferred reinvestment strategy, query 1810 leads to FIG. 18B. If this were not the case, a negative response to query 1810 would lead to subsequent queries in FIG. 18A leading to alternate reinvestment techniques.

FIG. 18B provides a map for determining which logic flow diagram may be applicable regarding BII cash flows. In this scenario, there are no exogenous cash flows. Thus, the answer to the query 1811 of whether there is exogenous cash inflow is negative, which leads to query 1812. Query 1812 applies to exogenous cash flow out, which is also not present in this scenario. A negative response to 1812 leads to FIG. 20.

Because an index may be rebalanced according to any number of rebalancing preferences and involve a number of circumstances, variables, inputs, and/or the like, this routine may be modified to assist with providing the proper logic flow diagram applicable to the set of circumstances, variables, inputs and/or the like for resolution.

FIG. 20 provides an illustrative representation of the rebalancing process with no exogenous cash flows. On Jan. 31, 2004 (the rebalancing date), the base-line index is examined to determine 2000 what changes have occurred since Dec. 31, 2003. This determination 2000 may involve what bonds entered or left the base-line index, and the prices, yields, values, and/or the like of bonds in the base-line index. Once the base-line index has been examined and the changes within it determined, the BII is examined. Using the updated data from the base-line index, the value of endogenous outflows for the BII since Dec. 31, 2003 may be determined 2010. Here, it is determined that the value of the first lot (Base-Full December 2003) has increased to $100,311,440 before the removal of endogenous cash flow and the value of endogenous outflows is $2,131,945.

Once these determinations 2000 and 2010 are made, the BII may be preliminarily rebalanced 2030. This rebalancing 2030 results in a reduced book value of the first lot (Base-Full December 2003) of $98,179,495 going forward into the application of additional constraints and/or the next rebalancing period if applicable. At this rebalancing 2030, the value of endogenous outflows $2,131,945 may be used to invest in the entire base-line index (Base-Full January 2004) at market yields, weights, prices, and/or the like of Jan. 31, 2004, adding such holdings to the BII.

Preliminary book income results may then be compiled and/or calculated 2040. The existence and application of additional constraints may now be determined 2050, such as whether to impose gain/loss limits, whether there are buy and hold requirements, and/or the like. It is, of course, not necessary that this step occur at this point in the process. The choice of taking these steps at this point in the process was merely one of convenience for representation. Once it is determined if and what additional constraints exist, it should be determined 2051 whether the preliminary book income results calculated 2040 contravene these constraints 2050. If the preliminary book income results compiled 2040 do contravene, the preliminarily rebalanced BII may be modified to resolve any conflicts 2052 with these constraints 2050. The steps involved in this modification are discussed in greater detail below. If the preliminary book income results compiled 2040 do not contravene, the BII is finalized 2060.

At this point, statistics may be calculated and compiled 2070 for the BII. There are numerous examples of the statistics, metrics, and/or the like that may be compiled, calculated, and/or the like, as discussed above, including, but not limited to compiling performance statistics and valuations of the index holdings. If performance monitoring is complete, a negative response to query 2080 will lead to the end of this process. If performance monitoring is to continue, a positive response will lead back to FIG. 18A.

### EXAMPLE 1

### Second Month—Exogenous Inflow No Exogenous Outflow

Performance monitoring may continue into a second month. The second month in this hypothetical example is similar to the first, except that the index begins the month comprised of two purchase lots to rebalance: the lot purchased on Dec. 31, 2003 (Base-Full December 2003) and the lot purchased on Jan. 31, 2004 (Base-Full January 2004). In addition, an exogenous inflow is added to the index at the end of the month.

During February, the BII gained in value. The index on Jan. 31, 2004 has a value of $100,311,440. This value consists of the sum of the values of the index purchase lots. The value of the first index purchase lot (Base-Full December 2003) is $98,179,495 and the value of the second index purchase lot (Base-Full January 2004) is $2,131,945. On Feb. 29, 2004, the book value prior to the removal of endogenous cash flow of the index and each index purchase lot is calculated. The value of the index as a result of this calculation is $100,614,589. This value consists of the sum of the values of the index purchase lots. The value of the first index purchase lot (Base-Full December 2003) is $98,476,540 and the value of the second index purchase lot (Base-Full January 2004) is 2,138,049.

Upon rebalancing, the net endogenous outflows generated by the first and second lots are calculated, having values of $2,856,177 and $63,169, respectively, for a sum of $2,919,346 for the value of endogenous outflow for the index. The result of removing the value of endogenous outflows from each index purchase lot (Base-Full December 2003) and (Base-Full January 2004) in the index is a reduced value of each index purchase lot of $95,620,364 and $2,074,880, respectively. These values are carried forward for both index purchase lots to the next month as the March starting book values for purchase lots (Base-Full December 2003) and (Base-Full January 2004).

In February, $2,000,000 was deposited into the portfolio. In order to maintain consistent metrics, this may be reflected by an exogenous inflow of $2,000,000 into the BII. So, on Feb. 29, 2004, the $2,919,346 value calculated from February's rebalancing endogenous outflow and the $2,000,000 exogenous inflow value may be combined and reinvested into the BII through a new index purchase lot (Base-Full February 2004) comprised of holdings of the base-line index at current market values, yields, prices, and/or the like and having a starting book value of $4,919,346. After the Feb. 29, 2004 rebalancing, the BII is comprised of three index purchase lots: the first (Base-Full December 2003) with a value of $95,620,364, the second (Base-Full January 2004) with a value of $2,074,880, and the third (Base-Full February 2004) with a value of $4,919,346.

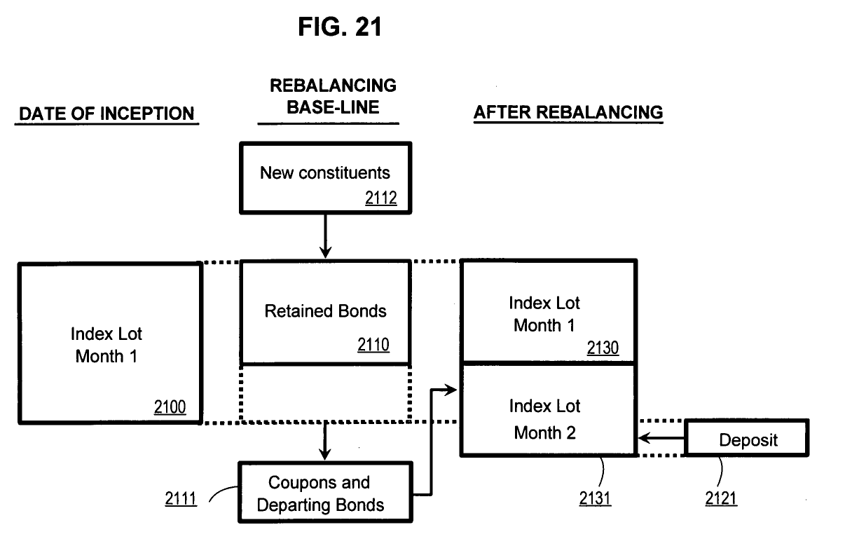

FIG. 21 provides an illustrative representation to assist with describing this example. This illustrates the rebalancing of endogenous outflows with an exogenous inflow. Although this figure involves a single index purchase lot at inception, it is understood that this may be equally applicable to an index with multiple index purchase lots, but is shown with a single index purchase lot for ease of illustration. For example, in the scenario outlined above, there are two index purchase lots; however, FIG. 21 depicts only a single purchase lot on the date of inception instead of the two index purchase lots as described in the scenario above. This is only for ease of explanation of the concept. This concept is equally applicable to the two index purchase lots as described above or any number of index purchase lots as described herein.

The first BII lot 2100 is shown at the beginning of the monitoring period. At the end of the monitoring period, the first lot 2100 is rebalanced, retaining the bonds retained by the base-line index at rebalancing and releasing the bonds that have left the base-line index by the rebalancing date, represented as a rebalanced lot 2110. The value of released constituents and coupon payments 2111 reflects the bonds that have left the BII and the interest payments made by the assets in the market corresponding to the BII constituents and comprise the endogenous outflow 2111.

An exogenous inflow 2121 is added to the index in this example. This inflow value 2121 may be combined with the value of endogenous outflow 2111. This total value of cash flow in, from endogenous outflows 2111 and exogenous inflow 2121, is invested into the entire base-line index on the rebalancing date, incorporating any new constituents 2112 that have entered the base-line index after the beginning of the performance monitoring period but on or before the current rebalancing date along with all securities that entered the BII on or before the inception date and remain in the base-line index by the rebalancing date.

Thus, after rebalancing, this BII is comprised of two index purchase lots: the constituents retained from the first index lot 2130 and the second index lot 2131 acquired at rebalancing and containing all the constituents of the base-line index at the rebalancing date. If the index were comprised of two index purchase lots on the date of inception, as described above, there would be an another index purchase lot in addition to the initial index purchase lot 2100 and there would be another index purchase lot after rebalancing in addition to the rebalanced initial index purchase lot 2130 and newly created index purchase lot 2131. Further, as described above, the newly created index purchase lot 2131 might be comprised of endogenous outflows from the additional index purchase lot not shown.

FIGS. 18A, 18B, and 22 provide yet another representation to assist with describing this scenario in the hypothetical example. Referring to the logic flow diagram of FIG. 18A again, at this point (“A”) in the scenario performance monitoring has already commenced and determinations 1800 have been made and the BII has been created 1801.

In this scenario, all cash flow is reinvested into the full base-line index at rebalancing. This will result in a positive response to the query 1810 of whether to reinvest all cash flow in the full base-line index, which will lead to FIG. 18B. If this were not the case, a negative response would lead to subsequent queries in FIG. 18A leading to alternate rebalancing techniques.

In this scenario, there is an exogenous inflow causing the answer to query 1811 in FIG. 18B of whether there is exogenous cash inflow to be positive, which leads to FIG. 22.

Because an index may be rebalanced according to any number of rebalancing preferences and involve a number of circumstances, variables, inputs, and/or the like, this routine may be modified to assist with providing the proper logic flow diagram applicable to the set of circumstances, variables, inputs and/or the like for resolution.

FIG. 22 provides an illustrative representation of the rebalancing process with an exogenous cash inflow. On Feb. 29, 2004 (the rebalancing date), the base-line index is examined to determine 2200 what changes have occurred since Jan. 31, 2004. This determination 2200 may involve what bonds have entered or left the base-line index, and the prices, yields, values, and/or the like of bonds in the base-line index. Once the base-line index has been examined and the changes within it determined 2200, the BII is examined. Using the updated data from the base-line index, the value of endogenous outflows for the BII since Jan. 31, 2004 may be determined 2210. Here, for example, it is determined that the book value prior to the removal of endogenous cash flow of the index has increased to $100,614,589 and the value of endogenous outflows is $2,919,346.

Data may be acquired 2220 regarding any data necessary for the BII. For example, in this case, the portfolio may be examined and, through this examination it may be discovered that there was a portfolio deposit in the amount of $2,000,000. This deposit may be reflected in the index as an exogenous inflow. It may be that there is no data acquired here. In this example, the value of the BII exogenous inflow is determined 2221, based on the information acquired 2220 from the portfolio, to be $2,000,000.

The BII is preliminarily rebalanced 2230. At this rebalancing 2230, the value of endogenous outflows ($2,919,346) plus the value of the exogenous inflow ($2,000,000) may be combined ($4,919,346) and used to invest in the entire base-line index at market yields, weights, prices, and/or the like of Feb. 29, 2004, adding such holdings to the BII.

Preliminary book income results may then be compiled and/or calculated 2240. The existence and application of additional constraints may now be determined 2250, such as whether to impose gain/loss limits, whether there are buy and hold requirements, and/or the like. Once it is determined if and what additional constraints exist, it should be determined 2251 whether the preliminary book income results calculated 2240 contravene these constraints 2250. If the preliminary book income results compiled 2240 do contravene, the preliminarily rebalanced BII may be modified to resolve any conflicts 2252 with these constraints 2250. The steps involved in this modification are discussed in greater detail below. Once the index has been modified 2252, it may be finalized 2260. If the preliminary book income results compiled 2240 do not contravene, the BII is finalized 2260.

At this point, statistics may be calculated and compiled 2270 for the BII. There are numerous examples of the statistics, metrics, and/or the like that may be compiled, calculated, and/or the like, as discussed above, including, but not limited to compiling performance statistics and valuations of the index holdings. If performance monitoring is complete, a negative response to query 2280 will lead to the end of this process. If performance monitoring is to continue, a positive response will lead back to FIG. 18A.

### EXAMPLE 1

### Third Month—Exogenous Outflow No Exogenous Inflow

Performance monitoring may continue into an additional month. The third month in this hypothetical example involves an exogenous outflow removed from the value of the index. The index begins the month comprised of three index purchase lots: the lot purchased on Dec. 31, 2003 (Base-Full December 2003), the -lot purchased on Jan. 31, 2004 (Base-Full January 2004), and the lot purchased on Feb. 29, 2004 (Base-Full February 2004). In addition, an exogenous outflow is removed from the index at the end of the month.

The BII on Feb. 29, 2004 has a value of $102,614,590, consisting of the sum of values of the three index purchase lots that comprise the index. The lots (Base-Full December 2003), (Base-Full January 2004), and (Base-Full February 2004) each have values of $95,620,364, $2,074,880, and $4,919,346.

On Mar. 31, 2004, the index is rebalanced again. During March, the BII gained in value to reach a value of $102,955,706 on the rebalancing date, with the first index purchase lot (Base-Full December 2003) having a value of $95,940,126, the second index purchase lot (Base-Full January 2004) having a value of $2,081,639, and the third index purchase lot (Base-Full February 2004) having a value of $4,933,941. Upon rebalancing the index, endogenous outflows are calculated: the first index purchase lot's (Base-Full December 2003) endogenous outflow having a value of $1,891,764, the second index purchase lot's (Base-Full January 2004) endogenous outflow having a value of $40,633, and the third index purchase lot's (Base-Full February 2004) endogenous outflow having a value of $98,538. The total value of endogenous outflow for the index is $2,030,935. The value of each endogenous outflow is then removed from the value of each corresponding index purchase lot and the final values are then carried forward for all three lots to the next month as the April starting book values: $94,048,362 for (Base-Full December 2003), $2,041,006 for (Base-Full January 2004), and $4,835,403 for (Base-Full February 2004).

In March, a $1,000,000 withdrawal was removed from the portfolio. This withdrawal is reflected as an exogenous outflow from the BII of $1,000,000. Because the value of exogenous outflow is lower than the total value of endogenous outflows, there is no need to remove value from the index purchase lots. The exogenous outflow, in this example, is deducted from the value of endogenous outflows. Thus, the total endogenous outflow value of $2,030,935 is reduced by the exogenous outflow value of $1,000,000, resulting in a net total endogenous outflow value of $1,030,935 for reinvestment into the index. This net endogenous outflow is reinvested into the index through a new index purchase lot (Base-Full March 2004) comprised of holdings of the base-line index at current market values, yields, prices, and/or the like and having a starting book value of $1,030,935. After the Mar. 31, 2004 rebalancing and the addition of another index purchase lot, the BII is comprised of four purchase lots: the first lot (Base-Full December 2003) with a value of $94,048,362, the second lot (Base-Full January 2004) with a value of $2,041,006, the third lot (Base-Full February 2004) with a value of $4,835,403, and the fourth lot (Base-Full March 2004) with a value of $1,030,935.

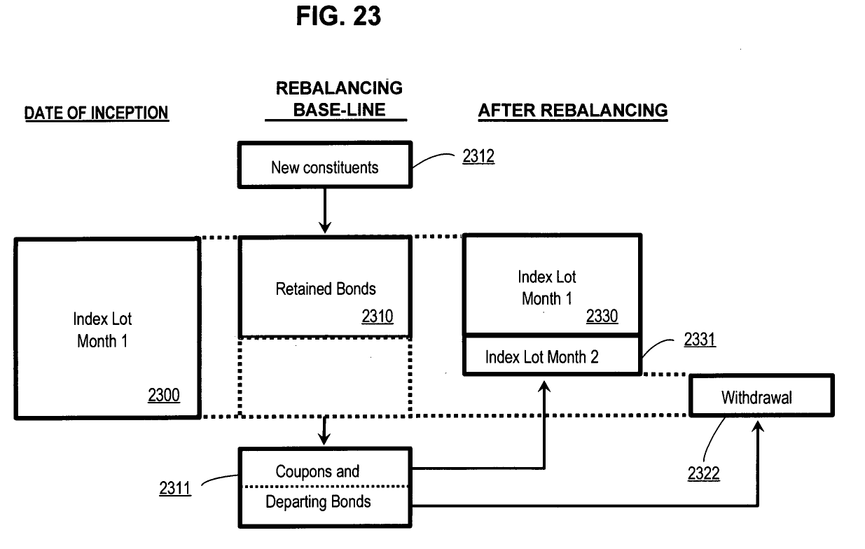

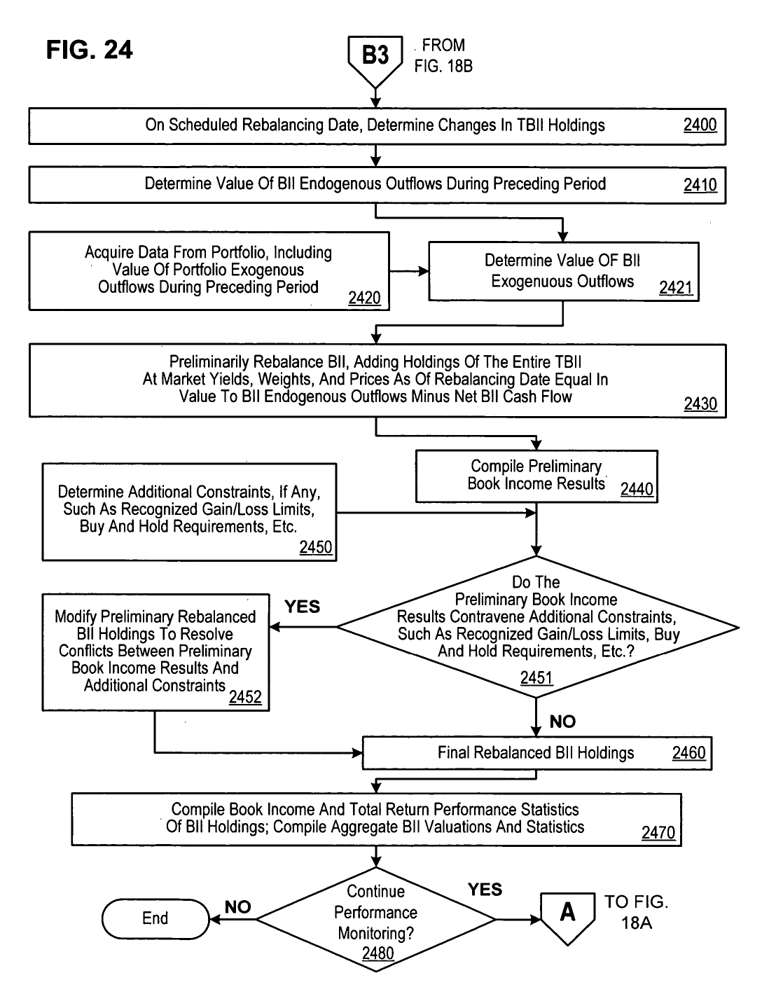

FIG. 23 provides an illustrative representation to assist with describing this example. This illustrates the rebalancing of endogenous outflows with an exogenous outflow. Although this figure involves a single index purchase lot at inception, it is understood that this may be equally applicable to an index with multiple index purchase lots, but is shown with a single index purchase lot for ease of illustration. For example, in the scenario outlined above, there are three index purchase lots at the beginning of the performance measurement period; however, FIG. 23 only depicts a single purchase lot on the date of inception instead of the three index purchase lots as described in the scenario above. This is only for ease of explanation of the concept. This concept is equally applicable to the three index purchase lots as described above or any number of index purchase lots as described herein.

The first BII lot 2300 is shown at the beginning of the monitoring period. At the end of the monitoring period, the first lot 2300 is rebalanced, retaining the bonds retained by the base-line index at rebalancing and releasing the bonds that have left the base-line index by the rebalancing date, represented as a rebalanced lot. The value of released constituents and coupon payments 2311 reflects the bonds that have left the BII and the interest payments made by the assets in the market corresponding to the BII constituents and comprise the endogenous outflow 2311. The rebalanced lot after removal of endogenous outflows is represented as 2310.

A withdrawal is removed from the portfolio and, therefore, an exogenous outflow is removed from the BII. Here, a portion of the endogenous cash flow 2311 is removed from the BII and applied to the exogenous outflow 2322. The remainder of the endogenous outflow may then be reinvested into a new index purchase lot 2331 comprised of the entire base-line index on the rebalancing date, which would incorporate any new constituents 2312 that have entered the base-line index subsequent to previous rebalancings. Thus, after rebalancing, this BII is comprised of two index purchase lots: the first index purchase lot 2330 and the newly acquired index purchase lot 2331.

If the index were comprised of three index purchase lots on Feb. 29, 2004, as described above, there would be additional index purchase lots before and after rebalancing, each acting in a similar fashion as illustrated in FIG. 23.

FIGS. 18A, 18B, and 24 provide yet another representation to assist with describing this scenario in the hypothetical example. Referring to the logic flow diagram of FIG. 18A again, at this point (“A”) in the scenario performance monitoring has already commenced and determinations 1800 have been made and the BII has been created 1801.

In this scenario, all cash flow is reinvested into the full base-line index at rebalancing. This will result in a positive response to the query 1810 of whether to reinvest all cash flow in the full base-line index, which will lead to FIG. 18B. If this were not the case, a negative response would lead to subsequent queries in FIG. 18A leading to alternate rebalancing techniques.

In this scenario, there is only an exogenous outflow. Thus, the answer to query 1811 in FIG. 18B of whether there is exogenous cash inflow is negative, which leads to query 1812. Query 1812 asks whether there is an exogenous cash outflow. As there is in this example, the next question is whether the exogenous outflow is greater than endogenous outflows for the index 1813. If the exogenous outflows are greater than endogenous outflows, FIG. 26 outlines the logic flow diagram for this scenario. If the exogenous outflows are not greater than endogenous outflows, FIG. 24 outlines the logic flow diagram for this scenario. As this example involves an exogenous outflow that is not greater than the endogenous outflow for the index, FIG. 24 is applicable here.

Because an index may be rebalanced according to any number of rebalancing preferences and involve a number of circumstances, variables, inputs, and/or the like, this routine may be modified to assist with providing the proper logic flow diagram applicable to the set of circumstances, variables, inputs and/or the like for resolution.

FIG. 24 provides an illustrative representation of the rebalancing process with an exogenous cash outflow. On Mar. 31, 2004 (the rebalancing date), the base-line index is examined to determine 2400 what changes have occurred since Feb. 29, 2004. Once the base-line index has been examined and the changes within it determined 2400, the BII is examined. Using the updated data from the base-line index, the value of endogenous outflows for the BII since Feb. 29, 2004 may be determined 2410. Here, for example, it is determined that the book value of the index prior to the removal of endogenous cash flow has increased to $102,955,706 and the value of endogenous outflows is $2,030,935.

Data may be acquired 2420 regarding any data necessary for the BII. For example, in this case, the portfolio may be examined, and through this examination, it may be discovered that there was a portfolio withdrawal in the amount of $1,000,000. This withdrawal may be reflected in the index as an exogenous outflow. It may be that there is no data acquired here. In this example, the value of exogenous outflow is determined 2421, based on the information acquired 2420 from the portfolio, to be $1,000,000.

The BII is preliminarily rebalanced 2430. At this rebalancing 2430, the value to be reinvested, if any, is calculated. The value of endogenous outflows ($2,030,935) minus the value of exogenous outflow ($1,000,000) results in a value of $1,030,935 for investment in the entire base-line index at market yields, weights, prices, and/or the like of Mar. 31, 2004, adding such bonds to the BII.

Preliminary book income results may then be compiled and/or calculated 2440 and the existence and application of additional constraints may be determined 2450. Once it is determined if and what additional constraints exist 2450, it should be determined 2451 whether the preliminary book income results calculated 2440 contravene these constraints 2450. If the preliminary book income results compiled 2440 do contravene, the preliminarily rebalanced BII may be modified to resolve any conflicts 2452 with these constraints 2450. The steps involved in this modification are discussed in greater detail below. Once the index has been modified 2452, it may be finalized 2460. If the preliminary book income results compiled 2440 do not contravene, the BII may be finalized 2460.

At this point, statistics may be calculated and compiled 2470 for the BII. There are numerous examples of the statistics, metrics, and/or the like that may be compiled, calculated, and/or the like, as discussed above, including, but not limited to compiling performance statistics and valuations of the index holdings. If performance monitoring is complete, a negative response to query 2480 will lead to the end of this process. If performance monitoring is to continue, a positive response will lead back to FIG. 18A.

### EXAMPLE 1

### Seventh Month—Exogenous Outflow Greater Than Endogenous Outflow No Exogenous Inflow

Looking ahead in this hypothetical scenario, an exogenous outflow may exist that cannot be covered using the value of endogenous outflows. Although this poses some different variables to practicing the typical monthly rebalancing in this example, the rebalancing is carried out in a very similar fashion to the others. In the seventh month of this hypothetical example, the index begins the month comprised of seven purchase lots to rebalance and an exogenous outflow is removed from the value of the index at the end of the month that is larger than the value of endogenous outflows calculated for the index during the month.

The BII on Jun. 30, 2004 has a value of $113,517,698, consisting of the sum of values of the seven lots that comprise the index. During July, the book value of the index prior to removal of endogenous cash flows rose to $113,894,587. The endogenous outflows are calculated with a total value of $2,914,950.

The values for each index lot are shown below:

| | | Book Value Prior | |
|---|---|---|---|
| | Start Book | to Removal of | Book Value of |
| | Value on | Endogenous | Endogenous |
| Index Lot | June 30, 2004 | Outflow | Outflow |
| Base-Full | $87,086,621 | $87,369,657 | $2,270,330 |
| 12/03 | | | |
| Base-Full | $1,891,805 | $1,897,791 | $48,735 |
| 1/04 | | | |
| Base-Full | $4,489,447 | $4,503,026 | $112,286 |
| 2/04 | | | |
| Base-Full | $957,812 | $960,639 | $23,280 |
| 3/04 | | | |
| Base-Full | $5,757,582 | $5,778,465 | $141,602 |
| 4/04 | | | |
| Base-Full | $6,534,672 | $6,559,674 | $158,174 |
| 5/04 | | | |
| Base-Full | $6,799,759 | $6,825,336 | $160,545 |
| 6/04 | | | |
| Total | $113,517,698 | $113,894,587 | $2,914,950 |

In July, the portfolio experiences a $12,000,000 withdrawal. A $12,000,000 exogenous outflow, reflecting this withdrawal, is removed from the index. Unlike the scenario discussed in the March rebalancing, July's exogenous outflow ($12,000,000) cannot be covered by the endogenous outflows generated in the same month ($2,914,950). The exogenous outflows may be removed from the value of the index alone, but in this example it is preferable to also use the value of the endogenous outflows in addition to the value of the index purchase lots. So, in this example, the total value of endogenous outflow, $2,914,950, will be removed from the index. This value will be part of the value of exogenous outflows, $12,000,000, removed from the index in July. The net exogenous outflow may then be calculated, reducing the $12,000,000 value for exogenous outflow by the $2,914,950 value of endogenous outflow. This calculation leaves a value of $9,085,050 remaining as net exogenous outflow after reduction by the value of endogenous outflow. This net exogenous outflow may then be removed from the value of the index to cover what the endogenous outflows of the index could not. This value, in this example, is removed from each of the outstanding purchase index lots in proportion to their relative current market values. There are, of course, numerous ways in which this value may be meet with the BII.

In this example, starting with the adjusted book value of the index before removal of endogenous cash flow of $113,894,587 and removing the value $2,914,950 of endogenous outflows leaves a value of $110,979,637 before removing any value for exogenous outflow.

Removing value from the index to cover net exogenous outflow may be accomplished by removing holdings from the index with a value sufficient to meet any exogenous outflow. On the day these constituents are removed, which is Jul. 31, 2004 in this case, the difference between the market values on that date and the book values at which they were maintained in the index may be recognized as a capital gain or loss. The selection criteria and determination for removing constituents from the index will depend upon the preferences for the index.

It may be difficult to remove constituents from the index with a value exactly equal to the net exogenous outflow. So, in some cases, a value greater than the value of net exogenous outflow may be removed from the index to cover the difference. The excess amount may also be removed from the index or reinvested into the index or used in a manner inline with the preferences of the index.

In this example, constituents may be removed to meet the net value of exogenous outflow, $9,085,050. Constituents may be removed from the index such that the total market value of the removed constituents is equal to or greater than the net value of exogenous outflow. As discussed above, the selection of the constituents to be removed may be made according to a number of determinations, preferences, variables, and/or the like.

In this example, constituents having a combined market value of $9,085,050 are removed from the BII to cover the net value of exogenous outflow. The constituents removed here should each have a recognized and recorded book value. These constituents to be removed with a market value $9,085,050 have a total book value of $9,175,797 in the BII. This results in a loss of $90,747, which may be realized by the index depending on the performance measurement preferences.

The endogenous outflow value of $2,914,950 and market value of constituents removed of $9,085,050 may be combined for a value of $12,000,000, which may be removed from the index to meet the total exogenous outflow.

The book value of these removed constituents is removed from the book value of the index at this point. The net book value of the index prior to the removal of these constituents was calculated above as $110,979,637. Removing the book value of $9,175,797 from this value leaves a book value for the BII of $101,803,840. This is the starting book value for the index for the next reporting period starting Aug. 1, 2004.

The values for each index lot are shown below:

| | Book Value | Market Value | | |
|---|---|---|---|---|
| | of Bonds | of Bonds | Exogenous | Book Value on |
| Index Lot | Removed | Removed | Outflow | July 31, 2005 |
| Base-Full | $7,036,013 | $6,950,857 | $9,221,187 | $78,063,314 |
| 12/03 | | | | |
| Base-Full | $152,880 | $150,272 | $199,007 | $1,696,176 |
| 1/04 | | | | |
| Base-Full | $363,026 | $354,111 | $466,397 | $4,027,713 |
| 2/04 | | | | |
| Base-Full | $77,501 | $75,245 | $98,525 | $859,858 |
| 3/04 | | | | |
| Base-Full | $466,056 | $466,265 | $607,867 | $5,170,808 |
| 4/04 | | | | |
| Base-Full | $529,276 | $533,745 | $691,919 | $5,872,225 |
| 5/04 | | | | |
| Base-Full | $551,045 | $554,554 | $715,099 | $6,113,746 |
| 6/04 | | | | |
| Total | $9,175,797 | $9,085,050 | $12,000,000 | $101,803,840 |

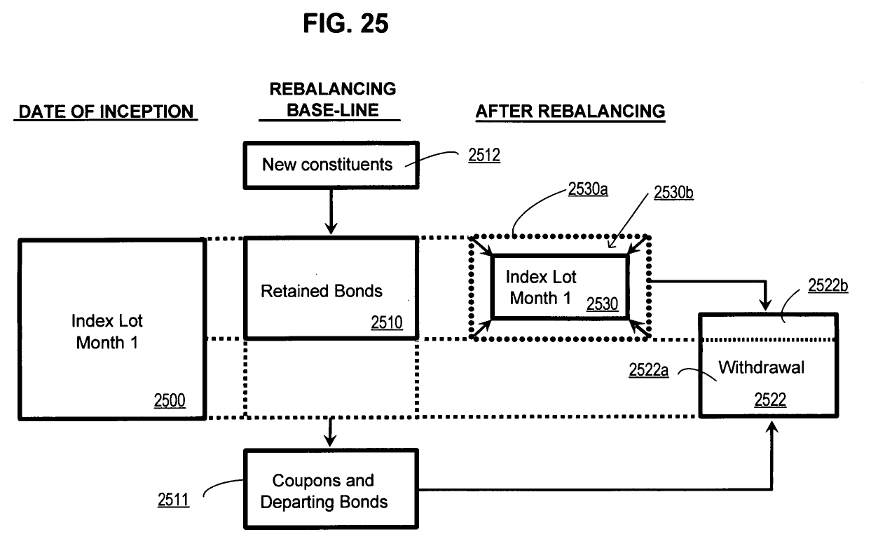

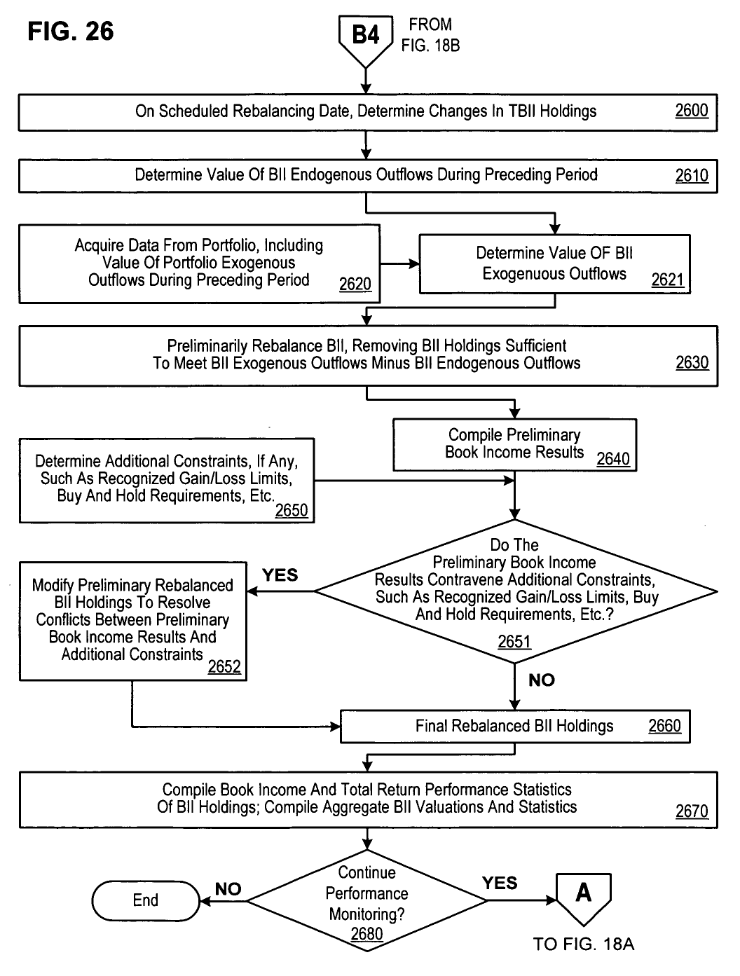

FIG. 25 provides an illustrative representation to assist with describing this example. This illustrates the rebalancing of endogenous outflows with an exogenous outflow. Although this figure involves a single index purchase lot at inception, it is understood that this may be equally applicable to an index with multiple index purchase lots, but is shown with a single index purchase lot for ease of illustration. For example, in the scenario outlined above, there are seven index purchase lots; however, FIG. 25 only depicts a single purchase lot on the date of inception instead of the seven index purchase lots as described in the scenario above. This is only for ease of explanation of the concept. This concept is equally applicable to the other six index purchase lots as described above or any number of index purchase lots as described herein.

The first BII lot 2500 is shown at the beginning of the month. At the end of the month, the first lot 2500 is rebalanced, retaining the bonds retained by the base-line index at rebalancing and releasing the bonds that have left the base-line index by the rebalancing date, represented as a rebalanced lot 2510. The value of released constituents and coupon payments 2511 reflects the bonds that have left the BII and the interest payments made by the assets in the market corresponding to the BII constituents and comprise the endogenous outflows 2511.

A withdrawal was removed from the portfolio. Therefore, an exogenous outflow 2522 of comparable value may be removed from the BII to reflect this withdrawal. The entire value of endogenous outflows in the BII 2511 may be removed from the index to cover this exogenous outflow. This amount alone, however, is not sufficient to meet the value of exogenous outflow. It is only a portion 2522a of the total exogenous outflow 2522 removed from the index. A pro-rata portion 2530b of the constituents that remain in the preliminarily rebalanced index purchase lot 2530a may be removed, reducing the value of the index purchase lot 2530. The market value of the removed constituents may be used to cover the remainder of the exogenous outflow 2522b.

If the index were comprised of seven index purchase lots on the date of inception, as described above, there would be additional index purchase lots before and after rebalancing, each acting in a similar fashion as that illustrated in FIG. 25 and adding to the value of exogenous outflow.

FIGS. 18A, 18B, and 26 provide yet another representation to assist with describing this scenario in the hypothetical example. Referring to the logic flow diagram of FIG. 18A again, at this point (“A”) in the scenario performance monitoring has already commenced and determinations 1800 have been made and the BII has been created 1801.

In this scenario, all cash flow would be reinvested into the full base-line index at rebalancing if any existed. This will result in a positive response to the query 1810 of whether to reinvest all cash flow in the full base-line index, which will lead to FIG. 18B. If this were not the case, a negative response would lead to subsequent queries in FIG. 18A leading to alternate rebalancing techniques.

In this scenario, there is only an exogenous outflow. Thus, the answer to query 1811 in FIG. 18B of whether there is exogenous cash inflow is negative, which leads to query 1812. Query 1812 asks whether an exogenous cash outflow exists. As there is an exogenous outflow in this example, the next question is whether the exogenous outflow is greater than endogenous outflows for the index 1813. If the exogenous outflows are not greater than endogenous outflows, FIG. 24 outlines the logic flow diagram for this example as discussed above. If the exogenous outflows are greater than endogenous outflows, FIG. 26 outlines the logic flow diagram for this scenario. As this example involves an exogenous outflow that is greater than the endogenous outflow for the index, FIG. 26 is applicable here.

Because an index may be rebalanced according to any number of rebalancing preferences and involve a number of circumstances, variables, inputs, and/or the like, this routine may be modified to assist with providing the proper logic flow diagram applicable to the set of circumstances, variables, inputs and/or the like for resolution.

FIG. 26 provides an illustrative representation of the rebalancing process with an exogenous cash outflow. On Jul. 31, 2004 (the rebalancing date), the base-line index is examined to determine 2600 what changes have occurred since Jun. 30, 2004 2600. Once the base-line index has been examined and the changes within it determined 2600, the BII is examined. Using the updated data from the base-line index, the value of endogenous outflows for the BII since Jun. 30, 2004 may be determined 2610. Here, for example, it is determined that the book value of the index prior to removal of endogenous cash flow has increased to $113,894,587 before removal of the value of endogenous outflows is $2,914,950.

Data may be acquired 2620 regarding any data necessary for the BII. For example, in this case, the portfolio may be examined and, through this examination, it may be discovered that there was a portfolio withdrawal in the amount of $12,000,000. This withdrawal may be reflected in the index as an exogenous outflow. It may be that there is no data acquired here. In this example, the value of exogenous outflow is determined 2621, based on the information acquired 2620 from the portfolio, to be $12,000,000.

At rebalancing 2630, the value to be removed from the index is calculated. The value of exogenous outflow $12,000,000 may be reduced by the value of endogenous outflow $2,914,950, leaving a net value of $9,085,050, which may then be removed from the value of the index on Jul. 31, 2004.

Preliminary book income results may then be compiled and/or calculated 2640 and the existence and application of additional constraints may be determined 2650. Once it is determined if and what additional constraints exist 2650, it should be determined 2651 whether the preliminary book income results calculated 2640 contravene these constraints 2650. If the preliminary book income results compiled 2640 do contravene, the preliminarily rebalanced BII may be modified to resolve any conflicts 2652 with these constraints 2650. The steps involved in this modification are discussed in greater detail below. Once the index has been modified 2652, it may be finalized 2660. If the preliminary book income results compiled 2640 do not contravene, the BII may be finalized 2660.

At this point, statistics may be calculated and compiled 2670 for the BII. There are numerous examples of the statistics, metrics, and/or the like that may be compiled, calculated, and/or the like, as discussed above, including, but not limited to compiling performance statistics and valuations of the index holdings. If performance monitoring is complete, a negative response to query 2680 will lead to the end of this process. If performance monitoring is to continue, a positive response will lead back to FIG. 18A.

### EXAMPLE 2

### Reinvestment of Endogenous Cash Flow in New Additions to the Base-Line Index and Investment of Exogenous Cash Flow in Full TBII

This second example describes a hypothetical BII that rebalances monthly reflecting a base-line index and is used as a benchmark to a portfolio. At inception, the BII starts with an acquisition of the entire base-line index at market yields, wights, prices, and/or the like on the day of inception. This BII then begins with a lot comprised of the holdings of the entire base-line index as of the date of inception of the BII as in the example above. At rebalancing, this embodiment of the BIIS reinvests the value of endogenous cash flows in new lots comprised of only the constituents that have entered the base-line index subsequent to the previous rebalancing, index inception date, and/or the like. These constituents are acquired at the market yields, weights, prices, and/or the like, on the date of acquisition into the BII. The value of any exogenous inflows into the BIIS in this example are invested in new index purchase lots comprised of the entire base-line index at current market yields on the day of purchase (and rebalancing), similar to the example above. The start date of the index in this example again coincides with the initial funding date of the portfolio. The BII will then retain all of the bonds that remain in the base-line index through all subsequent rebalancings for the duration of the performance monitoring.

The value of endogenous outflows, in this example, will first be used to cover the value of any exogenous outflows. If there is a surplus endogenous outflow above the value of exogenous outflows, such surplus will be reinvested as discussed above. If the value of endogenous outflows is lower than the value of exogenous outflows, the deficit is removed from all previously purchased index purchase lots on a pro-rata basis as discussed above.

The BII will be investing in a standard non-customized, base-line index encompassing the U.S. investment grade bonds market (“Base”) and involve a series of exogenous cash flows reflecting deposits and withdrawals in the portfolio. Below are descriptions of select periods during the performance monitoring of the index to provide an illustration of the performance of this index.

### EXAMPLE 2

### First Month—No Exogenous Cash Flow

The first lot of the BII is created on Dec. 31, 2003 with a value of $100,000,000 comprised of the entire holdings of the base-line index. During January, the BII, comprised of the first lot purchased, generates a 0.310% ordinary income return and a 0.001% capital gain return. The small capital gain was caused by bonds exiting the base-line index and reflecting the exit of such bonds in the BII at the Jan. 31, 2004 rebalancing at market prices that were slightly higher, on average, than their book prices in the BII. These returns increased the book value prior to removal of endogenous outflow of the index to $100,311,440. Part of this value is comprised of endogenous outflows worth $2,131,945. This value may be removed from the initial purchase lot (Base-Full December 2003) and reinvested into new holdings of the base-line index. The result of reducing the book value of the first purchase lot (Base-Full December 2003) by the net rebalancing endogenous outflow is a final book value of the first purchase lot (Base-Full December 2003) of $98,179,495. This amount may then be carried forward to the next month as the February starting book value for this purchase lot (Base-Full December 2003).

The $2,131,945 value from endogenous outflows may then be invested in a new purchase lot (Base-New January 2004) comprised of the new holdings that have entered the base-line bond index since inception, Dec. 31, 2003, at market values, yields, prices, and/or the like on Jan. 31, 2004. After the Jan. 31, 2004 rebalancing, the BII is comprised of two purchase lots, one purchased on Dec. 31, 2003 (Base-Full December 2003) with a value of $98,179,495 and the other purchased on Jan. 31, 2004 (Base-New January 2004) with a value of $2,131,945.

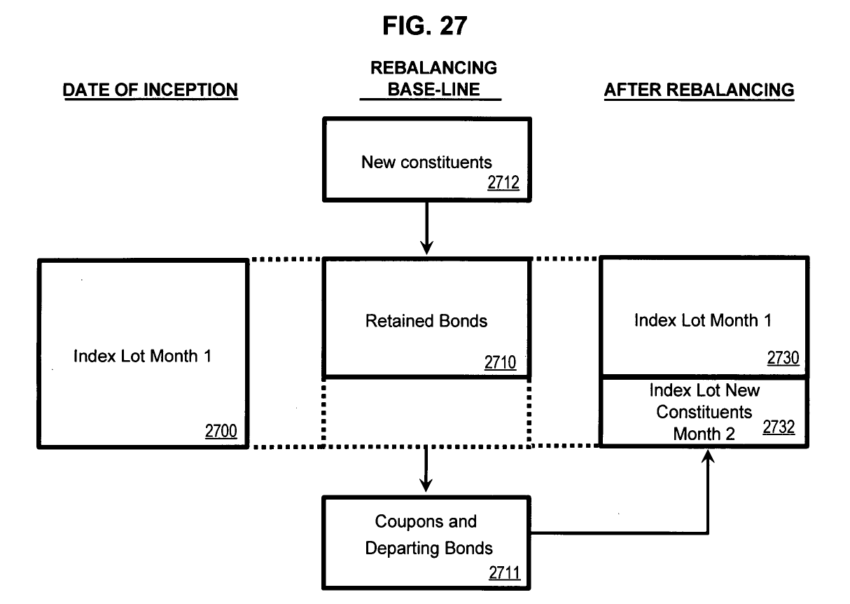

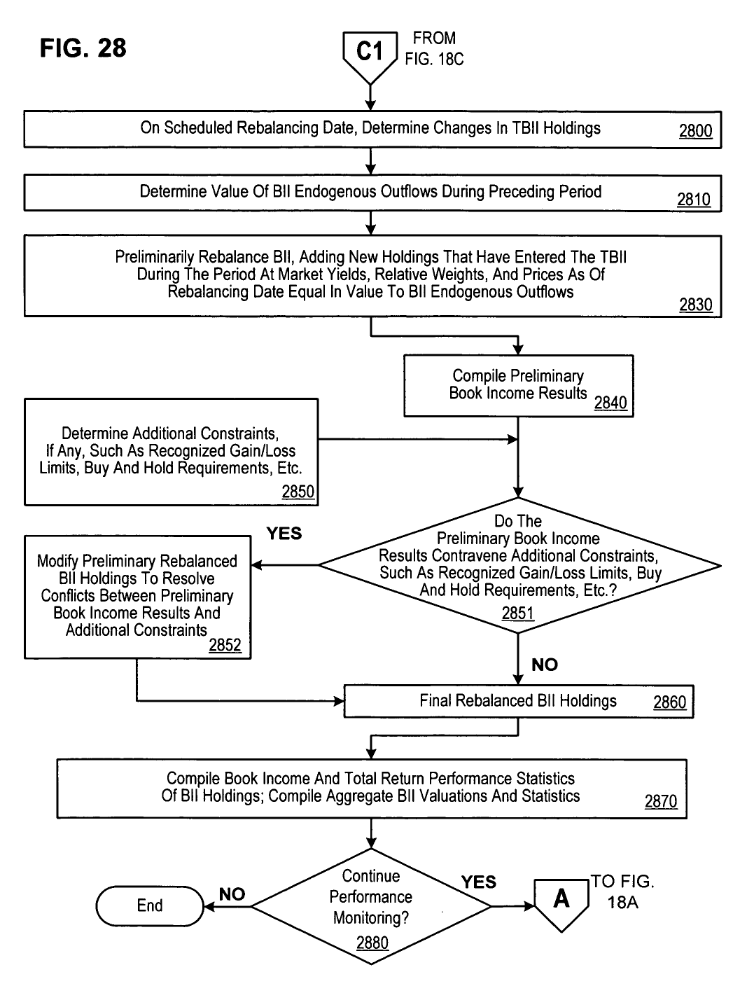

FIG. 27 provides an illustrative representation to assist with describing this example. This illustrates the rebalancing of endogenous outflows with no exogenous inflows or outflows. Although this figure involves a single index purchase lot at inception, it is understood that this may be equally applicable to an index with multiple index purchase lots, but is shown with a single index purchase lot for ease of illustration.

The first BII lot 2700 (Base-Full December 2003) purchased on the Dec. 31, 2003 for $100,000,000 is shown on its inception date. On Jan. 31, 2004, the first lot 2700 (Base-Full December 2003) is rebalanced, retaining the bonds retained by the bond index at rebalancing and releasing the bonds that have left the bond index by the rebalancing date, represented as a rebalanced lot 2710. The value of released constituents and coupon payments 2711 reflects the bonds that have left the BII and the interest payments made by the assets in the market corresponding to the BII constituents. This value represents the endogenous outflows 2711.

On the rebalancing date, Jan. 31, 2004, the value of the first index purchase lot 2700 may be adjusted to reflect the updated status of the base-line index, represented as the index purchase lot after rebalancing. This index purchase lot (Base-Full December 2003) 2710 has an initial updated book value prior to removal of endogenous outflows of $100,311,440, which is then reduced by endogenous outflows 2711 with a value of $2,131,945, reflecting the endogenous outflows of the BII. The resulting lot (Base-Full December 2003) 2710 has a reduced value of $98,179,495, which is carried forward as an index purchase lot 2730 for the application of additional constraints or possible subsequent rebalancings.

The value of BII endogenous outflows 2711 is $2,131,945, reflecting the value of endogenous outflows calculated for the base-line index. This value 2711 is reinvested in the new holdings of the base-line index as of Jan. 31, 2004, which reflects the new constituents added to the base-line index 2712 since Dec. 31, 2003, creating an additional index purchase lot 2732 with a value of $2,131,945. Thus, after rebalancing, this BII is comprised of two subsidiary index purchase lots: the first index purchase lot 2730 created Dec. 31, 2003 (Base-Full December 2003) with a value of $98,179,495 and the second index purchase lot 2732 created on Jan. 31, 2004 (Base-New January 2004) with a value of $2,131,945.

FIGS. 18A, 18C, and 28 provide yet another representation to assist with describing this scenario in the hypothetical example. Referring to the logic flow diagram of FIG. 18A, once performance monitoring commences on Dec. 31, 2003, a determination 1800 is made concerning what the reinvestment and rebalancing strategy has been established for the BII. At this point in the example, it is determined that the index will be rebalanced monthly using the value of endogenous outflow to invest in new constituents added to the base-line index and the value of any exogenous inflow to invest in the full base-line index.

Once these determinations 1800 have been made concerning the BII, an index purchase lot may be created 1801 investing the entire value of the BII into the full base-line index at market yields, weights, prices, and/or the like. In this example, the index is comprised of one index purchase lot of the entire base-line index (Base-Full December 2003) on Dec. 31, 2003 with a value of $100,000,000.

After creating the BII 1801, the process of rebalancing may unfold. In this scenario, cash flow is reinvested using the value of endogenous outflow to invest in new constituents added to the base-line index and the value of any exogenous inflow to invest in the full base-line index at rebalancing. This will result in a negative response to the query 1810 of whether to reinvest all cash flow in the full base-line index, which leads to FIG. 18B. The next question 1820 is whether to reinvest endogenous cash flows in newly added constituents to the base-line index and invest exogenous cash flow in the full base-line index. If this were not the case, a negative response would lead to subsequent queries in FIG. 18A leading to alternate reinvestment techniques. However, this example fits within the parameters of 1820, which leads to FIG. 18C.

FIG. 18C provides a map for determining which logic flow diagram may be applicable regarding BII cash flows. In this scenario, there are no exogenous cash flows. Thus, the answer to query 1821 of whether there is an exogenous cash inflow is negative, which leads to query 1822. Query 1822 applies to exogenous cash flow out, which is also not present in this scenario. A negative response to 1822 leads to FIG. 28.

Because an index may be rebalanced according to any number of rebalancing preferences and involve a number of circumstances, variables, inputs, and/or the like, this routine may be modified to assist with providing the proper logic flow diagram applicable to the set of circumstances, variables, inputs and/or the like for resolution.

FIG. 28 provides an illustrative representation of the rebalancing process with no exogenous cash flows. On Jan. 31, 2004 (the rebalancing date), the base-line index is examined to determine 2800 what changes have occurred since Dec. 31, 2003. This determination 2800 may involve what bonds left the base-line index, what bonds entered the base-line index, the prices, yields, values, and/or the like of bonds in the base-line index. Once the base-line index has been examined and the changes within it determined, the BII is examined. Using the updated data from the base-line index, the value of endogenous outflows for the BII since Dec. 31, 2003 may be determined 2810. Here, it is determined that the book value of the first lot (Base-Full December 2003) has increased to $100,311,440 before removal of endogenous cash flow and the value of endogenous outflows is $2,131,945.

Once these determinations 2800 and 2810 are made, the BII may be preliminarily rebalanced 2830. This rebalancing 2830 results in a reduced book value of the first lot (Base-Full December 2003) of $98,179,495 going forward into the application of additional constraints and/or the next rebalancing period if applicable. At this rebalancing 2830, the value of endogenous outflows $2,131,945 may be used to invest in the constituents that entered the base-line index on the Jan. 31, 2004 rebalancing date (Base-New January 2004) at market yields, weights, prices, and/or the like of Jan. 31, 2004, adding such holdings to the BII. In this example, the constituents in this additional lot, and their relative weights, are established by comparison of the base-line index before and after the rebalancing. So, if a constituent in an index issues more, this incremental portion will be added as a new holding even though the constituent already exists in the index. Other practices are also equally applicable for determining the relative weight of constituents in an index purchase lot inline with the BIIS as described herein.

Preliminary book income results may then be compiled and/or calculated 2840. The existence and application of additional constraints may now be determined 2850, such as whether to impose gain/loss limits, whether there are buy and hold requirements, and/or the like. It is, of course, not necessary that this step occur at this point in the process. The choice of taking these steps at this point in the process was merely one of convenience for representation. Once it is determined if and what additional constraints exist, it should be determined 2851 whether the preliminary book income results calculated 2840 contravene these constraints 2850. If the preliminary book income results compiled 2840 do contravene, the preliminarily rebalanced BII may be modified to resolve any conflicts 2852 with these constraints 2850. The steps involved in this modification are discussed in greater detail below. Once the index has been modified 2852, it may be finalized 2860. If the preliminary book income results compiled 2840 do not contravene, the BII may be finalized 2860.

At this point, statistics may be calculated and compiled 2870 for the BII. There are numerous examples of the statistics, metrics, and/or the like that may be compiled, calculated, and/or the like, as discussed above, including, but not limited to compiling performance statistics and valuations of the index holdings. If performance monitoring is complete, a negative response to query 2880 will lead to the end of this process. If performance monitoring is to continue, a positive response will lead back to FIG. 18A.

### EXAMPLE 2

### Second Month—Exogenous Inflow No Exogenous Outflow

Performance monitoring may continue into a second month. The second month in this hypothetical example is similar to the first, except the index begins the month comprised of two purchase lots to rebalance: (Base-Full December 2003) and (Base-Full January 2004) and an exogenous inflow is added to the index at the end of the month.

During February, the BII gained in value. The index on Jan. 31, 2004 has a book value of $100,311,440, comprised of the sum of index purchase lot values. The value of the first lot (Base-Full December 2003) is $98,179,495 and the value of the second lot (Base-New January 2004) is $2,131,945. On Feb. 29, 2004, the book value prior to the removal of endogenous cash flow of the index and each lot is calculated. The book value prior to removal of endogenous outflows of the index as a result of this calculation is $100,614,337, consisting of the sum of book values of the index purchase lots at the end of the month but prior to rebalancing: $98,476,540 and $2,137,797.

Upon rebalancing, the endogenous outflows generated by the first and second lots are calculated, having values of $2,856,177 and $132,737, respectively, for a sum of $2,988,914 for the value of endogenous outflow for the index. The result of removing the value of endogenous outflows from each lot (Base-Full December 2003) and (Base-New January 2004) in the index is a reduced book value for each lot of $95,620,364 and $2,005,060, respectively. The value $2,988,914 from endogenous outflows is invested in a new purchase lot (Base-New February 2004) comprised of the new holdings that have entered the base-line index since Jan. 31, 2004, at market values, yields, prices, and/or the like on Feb. 29, 2004. These values are carried forward for all three lots to the next month as the March starting book values.

In February, $2,000,000 was deposited into the portfolio. Reflecting this, an exogenous inflow of $2,000,000 is recognized in the BII at the Feb. 29, 2004 rebalancing through the addition to the index of a new purchase lot (Base-Full February 2004) comprised of holdings of the base-line index at current market values, yields, prices, and/or the like and having a starting book value of $2,000,000. After the Feb. 29, 2004 rebalancing, the BII is comprised of four purchase lots: the first (Base-Full December 2003) with a value of $95,620,364, the second (Base-New January 2004) with a value of $2,005,060, the third (Base-New February 2004) with a value of $2,988,914, and the fourth (Base-Full February 2004) with a value of $2,000,000.

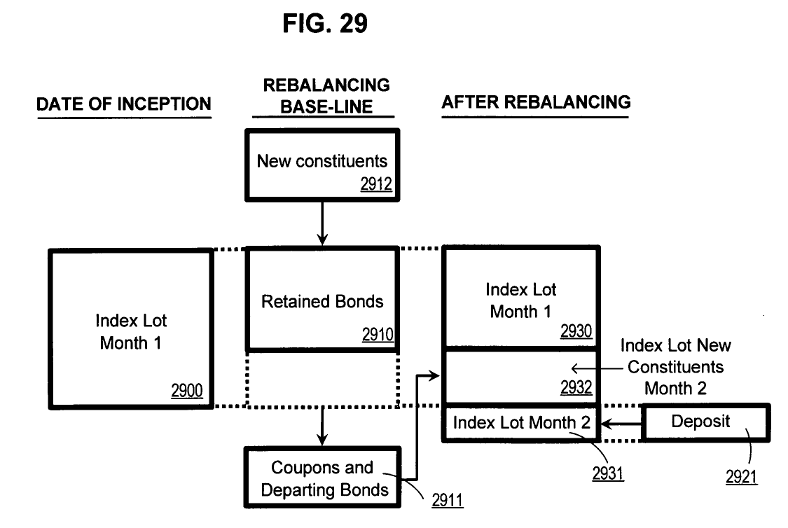

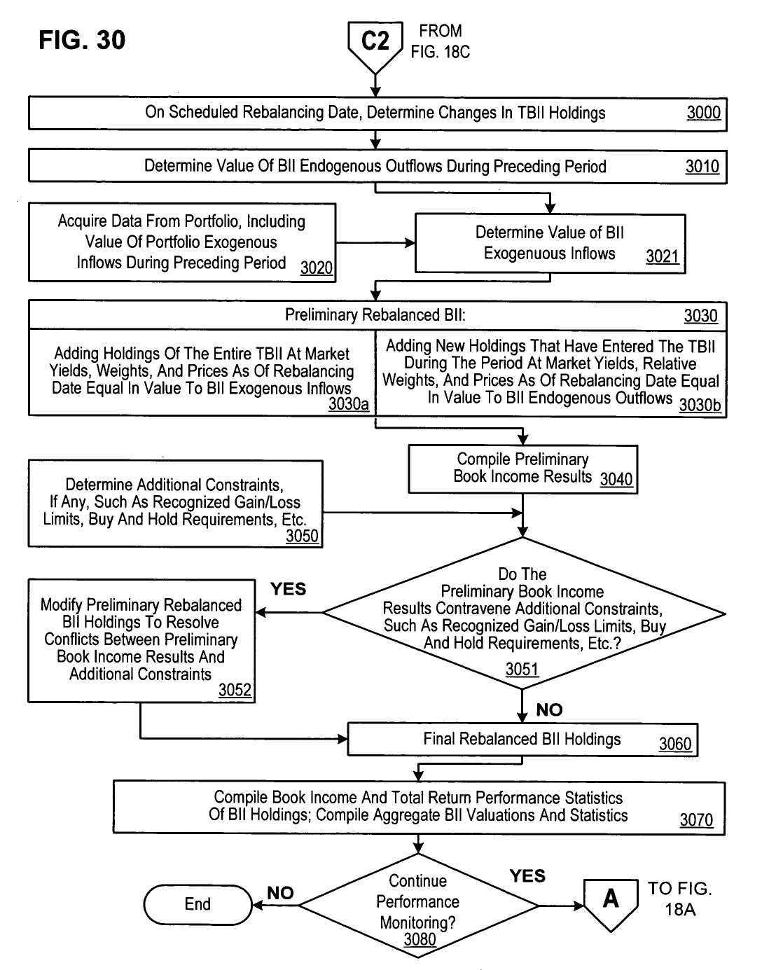

FIG. 29 provides an illustrative representation to assist with describing this example. This illustrates the rebalancing of endogenous outflows with an exogenous inflow. Although this figure involves a single index purchase lot at inception, it is understood that this may be equally applicable to an index with multiple index purchase lots, but is shown with a single index purchase lot for ease of representation. For example, in the scenario outlined above, there are two index purchase lots at the beginning of the performance monitoring period; however, FIG. 29 only depicts a single purchase lot on the date of inception instead of the two index purchase lots as described in the scenario above. This is only for ease of explanation of the concept. This concept is equally applicable to additional index purchase lots as described above.

The first BII lot 2900 is shown at the beginning of the monitoring period. At the end of the monitoring period, the first lot 2900 is rebalanced, retaining the bonds retained by the base-line index at rebalancing and releasing the bonds that have left the base-line index by the rebalancing date, represented as a rebalanced lot 2910. The value of released constituents and coupon payments 2911 reflects the bonds that have left the BII and the interest payments made by the assets in the market corresponding to the BII constituents.

The value of endogenous outflow 2911 is reinvested into the BII by creating another index purchase lot 2932 comprised of new constituents that entered the base-line index subsequent to the previous rebalancing which are represented by 2912. An exogenous inflow 2921 is added to the index in this example. This inflow 2921 is reinvested in the entire base-line index as of the rebalancing date, which would incorporate any new constituents 2912 along with any securities that had entered the base-line index on or before the previous rebalancing date, creating an additional index purchase lot 2931.

If the index were comprised of two index purchase lots at the start of the performance monitoring period, as described above, there would be an another index purchase lot in addition to the initial index purchase lot 2900 and there would be another index purchase lot after rebalancing in addition to the rebalanced initial index purchase lot 2930 and newly created index purchase lots 2931 and 2932. Further, as described above, the newly created index purchase lots 2931 and 2932 might be comprised of endogenous outflows from the additional index purchase lot not shown.

FIGS. 18A, 18B, and 30 provide yet another representation to assist with describing this scenario in the hypothetical example. Referring to the logic flow diagram of FIG. 18A again, at this point (“A”) in the scenario performance monitoring has already commenced and determinations 1800 have been made and the BII has been created 1801.

In this scenario, cash flow is reinvested using the value of endogenous outflow to invest in new constituents added to the base-line index and the value of any exogenous inflow to invest in the full base-line index at rebalancing. This will result in a negative response to the query 1810 of whether to reinvest all cash flow in the full base-line index, which leads to FIG. 18B. The next question 1820 is whether to reinvest endogenous cash flows in newly added constituents to the base-line index and to invest exogenous cash flow in the full base-line index. If this were not the case, a negative response would lead to subsequent queries in FIG. 18A leading to alternate reinvestment techniques. However, this example fits within the parameters of 1820, which leads to FIG. 18C.

FIG. 18C provides a map for determining which logic flow diagram may be applicable regarding BII cash flows. In this scenario, there is an exogenous inflow. Thus, the answer to query 1811 of whether there is exogenous cash flow in is positive, which leads to FIG. 30.

Because an index may be rebalanced according to any number of rebalancing preferences and involve a number of circumstances, variables, inputs, and/or the like, this routine may be modified to assist with providing the proper logic flow diagram applicable to the set of circumstances, variables, inputs and/or the like for resolution.

FIG. 30 provides an illustrative representation of the rebalancing process with an exogenous cash inflow. On Feb. 29, 2004 (the rebalancing date), the base-line index is examined to determine 3000 what changes have occurred since Jan. 31, 2004. This determination 3000 may involve a determination of what bonds left the base-line index, what bonds entered the base-line index, the prices, yields, values, and/or the like of bonds in the base-line index. Once the base-line index has been examined and the changes within it determined 3000, the BII is examined. Using the updated data from the base-line index, the value of endogenous outflows for the BII since Jan. 31, 2004 may be determined 3010. Here, for example, it is determined that the book value prior to the removal of endogenous cash flow of the index has increased to $100,614,337 and the value of endogenous outflows is $2,988,914.

Data may be acquired 3020 regarding any information necessary for the performance monitoring index. For example, in this case, the portfolio may be examined and through this examination it may be discovered that there was a portfolio deposit in the amount of $2,000,000. This deposit may be reflected in the index as an exogenous inflow. It may be that there is no data acquired here. In this example, the value of exogenous inflow is determined 3021, based on the information acquired 3020 from the portfolio, to be $2,000,000.

The BII is preliminarily rebalanced 3030. This rebalancing 3030 results in a reduced book value of the first lot (Base-Full December 2003) of $95,620,364 and a reduced book value of the second lot (Base-New January 2004) of $2,005,060 going forward into the application of additional constraints and/or the next rebalancing period if applicable. This rebalancing 3030 also involves using the exogenous inflow ($2,000,000) to invest in the entire base-line index (Base-Full February 2004) 3030a at market yields, weights, and prices on the Feb. 29, 2004 rebalancing date. This rebalancing 3030 also involves using the value of endogenous outflows ($2,988,914) to invest in new constituents added to the base-line index since Jan. 31, 2004 (Base-New February 2004) 3030a at market yields, relative weights, and prices on the Feb. 29, 2004 rebalancing date. In this example, the relative weights of this additional lot are relative to the constituents of the lot in this example. So, if a constituent in an index issues more, this new issuance will be added as a new holding even though it already exists in the index. Other practices are also equally applicable for determining the relative weight of constituents in an index purchase lot inline with the BIIS as described herein.

Preliminary book income results may then be compiled and/or calculated 3040. The existence and application of additional constraints may now be determined 3050, such as whether to impose gain/loss limits, whether there are buy and hold requirements, and/or the like. Once it is determined if and what additional constraints exist, it should be determined 3051 whether the preliminary book income results calculated 3040 contravene these constraints 3050. If the preliminary book income results compiled 3040 do contravene, the preliminarily rebalanced BII may be modified to resolve any conflicts 3052 with these constraints 3050. The steps involved in this modification are discussed in greater detail below. Once the index has been modified 3052, it may be finalized 3060. If the preliminary book income results compiled 3040 do not contravene, the BII is finalized 3060.

At this point, statistics may be calculated and compiled 3070 for the BII. There are numerous examples of the statistics, metrics, and/or the like that may be compiled, calculated, and/or the like, as discussed above, including, but not limited to compiling performance statistics and valuations of the index holdings. If performance monitoring is complete, a negative response to query 3080 will lead to the end of this process. If performance monitoring to continue, a positive response will lead back to FIG. 18A.

Each monthly rebalancing and each rebalancing involving an exogenous inflow may occur in a very similar fashion.

### EXAMPLE 2

### Third Month—Exogenous Inflow, No Exogenous Outflow

Performance monitoring may continue into an additional month. The third month in this hypothetical example involves an exogenous outflow removed from the value of the index. The index begins the month comprised of four purchase lots: the lot purchased on Dec. 31, 2003 (Base-Full December 2003), the lot purchased on Jan. 31, 2004 (Base-New January 2004), and the lots purchased on Feb. 29, 2004 (Base-Full February 2004) and (Base-New February 2004). In addition, an exogenous outflow is removed from the index at the end of the month.

The BII on Feb. 29, 2004 has a book value of $102,614,337, consisting of the sum of values of the four index purchase lots that comprise the index. The lots (Base-Full December 2003), (Base-New January 2004), (Base-New February 2004), and (Base-Full February 2004) each have book values of $95,620,364, $2,005,060, $2,988,914 and $2,000,000. During March, the BII gained in value. On March 31, 2004, the book value of the index prior to the removal of endogenous cash flow is $102,954,369, consisting of the sum of book values of the four index lots: $95,940,126, $2,011,552, $2,996,756, and $2,005,934.

Upon rebalancing, the endogenous outflows generated by the first, second, third, and fourth lots are calculated, having values of $1,891,764, $28,189, $122, 868, and $40,061, respectively, for a sum of $2,082,883 for the value of endogenous outflow for the BII. The result of removing the value of endogenous outflows from each lot (Base-Full December 2003), (Base-New January 2004), (Base-New February 2004), and (Base-Full February 2004) in the index is a reduced book value for each lot of $94,048,362, $1,983, 362, $2,873, 890 and $1,965,873, respectively.

In March, a $1,000,000 withdrawal was removed from the portfolio. This withdrawal is reflected as an exogenous outflow from the BII of $1,000,000. Because the value of exogenous outflow is lower than the total value of endogenous outflows, there is no need to remove value from the index purchase lots. The total value of endogenous outflow of $2,082,883 may be reduced by the $1,000,000, resulting in a net value of $1,082,883 for investing in a new index purchase lot (Base-New March 2004) comprised of new holdings added to the base-line bond index since Feb. 29, 2004.

Immediately following the Mar. 31, 2004 rebalancing the BII consists of five lots, which may be used in subsequent performance monitoring and rebalancing: the first (Base-Full December 2003) with a value of $94,048,362, the second (Base-New January 2004) with a value of $1,983,362, the third (Base-New February 2004) with a value of $2,873,890, the fourth (Base-Full February 2004) with a value of $1,965,873, and the fifth with a value of $1,082,883.

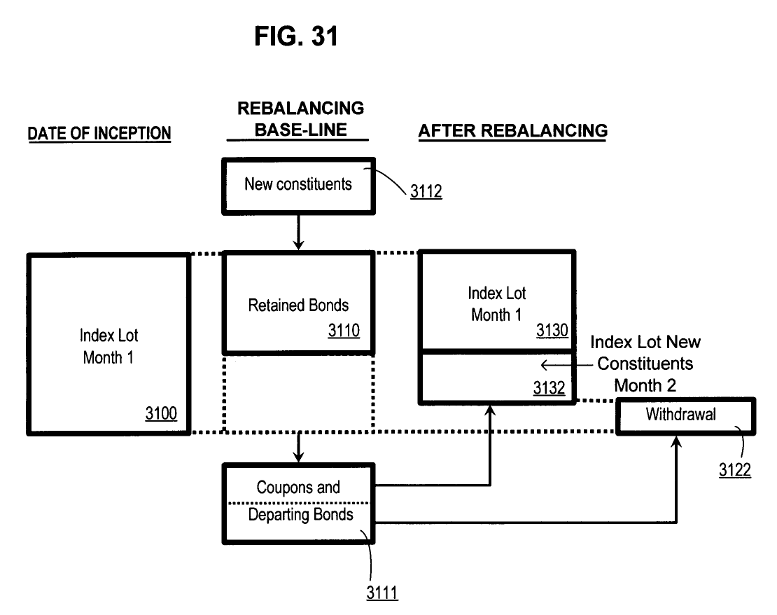

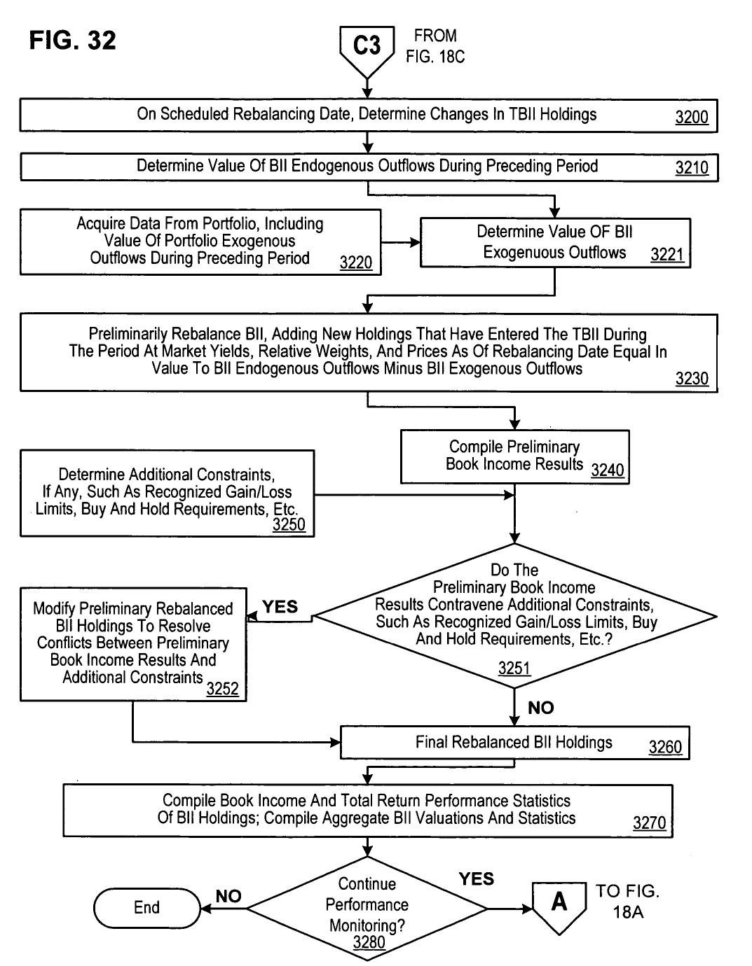

FIG. 31 provides an illustrative representation to assist with describing this example. This illustrates the rebalancing of endogenous outflows with an exogenous outflow. Although this figure involves a single index purchase lot at inception, it is understood that this may be equally applicable to an index with multiple index purchase lots, but is shown with a single index purchase lot for ease of representation. For example, in the scenario outlined above, there are multiple index purchase lots at the start of the performance monitoring period; however, FIG. 31 only depicts a single purchase lot on the date of inception instead of the four index purchase lots as described in the scenario above. This is only for ease of explanation of the concept. This concept is equally applicable to additional index purchase lots as described above.

The first BII lot 3100 is shown at the beginning of the monitoring period. At the end of the monitoring period, the first lot 3100 is rebalanced, retaining the bonds retained by the base-line index at rebalancing and releasing the bonds that have left the base-line index by the rebalancing date, represented as a rebalanced lot 3110. The value of released constituents and coupon payments 3111 reflects the bonds that have left the BII and the interest payments made by the assets in the market corresponding to the BII constituents.

A withdrawal is removed from the portfolio and, therefore, a portion of the endogenous cash flow 3111 is removed from the BII and applied to the exogenous outflow 3122. The remainder of the endogenous outflow may then be reinvested into a new index purchase lot 3132 comprised of new constituents that have entered the base-line index subsequent to the previous rebalancing. Thus, after rebalancing, this BII is comprised of two index purchase lots: the first index purchase lot 3130 and the newly acquired index purchase lot 3132.

If the index were comprised of three index purchase lots on Mar. 1, 2004, as described above, there would be additional index purchase lots before and after rebalancing, each acting in a similar fashion as that illustrated in FIG. 31.

FIGS. 18A, 18B, and 32 provide yet another representation to assist with describing this scenario in the hypothetical example. Referring to the logic flow diagram of FIG. 18A again, at this point (“A”) in the scenario performance monitoring has already commenced and determinations 1800 have been made and the BII has been created 1801.

In this scenario, cash flow is reinvested using the value of endogenous outflow to invest in new constituents added to the base-line index and the value of any exogenous inflow to invest in the full base-line index at rebalancing. This will result in a negative response to the query 1810 of whether to reinvest all cash flow in the full base-line index, which leads to FIG. 18B. The next question 1820 is whether to reinvest endogenous cash flows in newly added constituents to the base-line index and to invest exogenous cash flow in the full base-line index. If this were not the case, a negative response would lead to subsequent queries in FIG. 18A leading to alternate reinvestment techniques. However, this example fits within the parameters of 1820, which leads to FIG. 18C.

FIG. 18C provides a map for determining which logic flow diagram may be applicable regarding BII cash flows. In this scenario, there is no exogenous cash inflow. If there were, query 1821 would lead to FIG. 30. A negative response to this query 1821 leads to the next query 1822, which is whether there is exogenous cash flow out. If there were none, as in the example above, query 1822 would lead to FIG. 28. However, because there is an exogenous cash flow out, the next question is whether the exogenous outflow is greater than the endogenous outflows generated by the BII at rebalancing. If it is, FIG. 18C leads to FIG. 26, which provides a logic flow diagram representing this scenario. In this case, the exogenous outflows are not greater than endogenous outflows, which leads to FIG. 32 and the logic flow diagram representing this scenario.

Because an index may be rebalanced according to any number of rebalancing preferences and involve a number of circumstances, variables, inputs, and/or the like, this routine may be modified to assist with providing the proper logic flow diagram applicable to the set of circumstances, variables, inputs and/or the like for resolution.

FIG. 32 provides an illustrative representation of the rebalancing process with an exogenous cash flow out. On Mar. 31, 2004 (the rebalancing date), the base-line index is examined to determine 3200 what changes have occurred since Feb. 29, 2004. Once the base-line index has been examined and the changes within it determined 3200, the BII is examined. Using the updated data from the base-line index, the value of endogenous outflows for the BII since Feb. 29, 2004 may be determined 3210. Here, for example, it is determined that the book value prior to removal of endogenous outflow of the index on Mar. 31, 2004 increased to $102,954,369 and the value of endogenous outflows is $2,082,883.

Data may be acquired 3220 regarding any data necessary for the BII. For example, in this case, the portfolio may be examined and through this examination it may be discovered that there was a portfolio withdrawal in the amount of $1,000,000. This withdrawal may be reflected in the index as an exogenous outflow. It may be that there is no data acquired here. In this example, the value of exogenous outflow is determined 3221, based on the information acquired 3220 from the portfolio, to be $1,000,000.

The BII is preliminarily rebalanced 3230. At this rebalancing 3230, the value to be reinvested, if any, is calculated. In this example, the value of endogenous outflows ($2,082,883) minus the value of exogenous outflow ($1,000,000) is determined to be $1,082,883. This amount may used to invest in the new constituents added to the base-line index since Feb. 29, 2004 (Base-New March 2004) at market yields, relative weights, and prices on the Mar. 31, 2004 rebalancing date, adding such bonds to the BII. In this example, the relative weights of this additional lot are relative to the constituents of the lot in this example. So, if a constituent in an index issues more, this new issuance will be added as a new holding even though it already exists in the index. Other practices are also equally applicable for determining the relative weight of constituents in an index purchase lot inline with the BIIS as described herein.

Preliminary book income results may then be compiled and/or calculated 3240 and the existence and application of additional constraints may be determined 3250. Once it is determined if and what additional constraints exist 3250, it should be determined 3251 whether the preliminary book income results calculated 3240 contravene these constraints 3250. If the preliminary book income results compiled 3240 do contravene, the preliminarily rebalanced BII may be modified to resolve any conflicts 3252 with these constraints 3250. The steps involved in this modification are discussed in greater detail below. Once the index has been modified 3252, it may be finalized 3260. If the preliminary book income results compiled 3240 do not contravene, the BII may be finalized 3260.

At this point, statistics may be calculated and compiled 3270 for the BII. There are numerous examples of the statistics, metrics, and/or the like that may be compiled, calculated, and/or the like, as discussed above, including, but not limited to compiling performance statistics and valuations of the index holdings. If performance monitoring is complete, a negative response to query 3280 will lead to the end of this process. If performance monitoring is to continue, a positive response will lead back to FIG. 18A.

### EXAMPLE 2

### Seventh Month—Exogenous Outflow Greater Than Endogenous Outflow, No Exogenous Inflow

Looking ahead to the seventh month of this hypothetical example, the index begins the month comprised of twelve purchase lots. In addition, an exogenous outflow is removed from the value of the index on the rebalancing date, Jul. 31, 2004, that is larger than the value of endogenous outflows calculated for the index during the month.

The BII on Jun. 30, 2004 has a book value prior to removal of endogenous outflows of $113,509,401, consisting of the sum of values of twelve lots that comprise the index. During July, the book value prior to removal of endogenous outflows of the index rose to $113,882,673. Upon rebalancing the index, the endogenous outflows are calculated with a total value of $2,649,577.

In July, the portfolio experiences a $12,000,000 withdrawal. A $12,000,000 exogenous outflow, reflecting this withdrawal, is removed from the index. Unlike the scenario discussed in the March rebalancing, July's exogenous outflow ($12,000,000) cannot be covered by the endogenous outflows generated in the same month ($2,649,577). In this example a portion of the existing index purchase lots is removed, which, together with the value of the endogenous outflows, may be used to cover the exogenous outflow. So, in this example, the total value of endogenous outflow, $2,649,577, will be removed from the index. This value will be part of the value of exogenous outflows removed from the index in July. The net exogenous outflow may then be calculated, reducing its $12,000,000 value by the $2,649,577 value of endogenous outflow, resulting in a value of $9,350,423. This net exogenous outflow may then be removed from the BII to cover what the endogenous outflows of the index could not. In this example, this value reflecting the net exogenous outflow value will be removed from each of the outstanding purchase lots in proportion to their relative current market values.

In this example, starting with the adjusted book value of the index before removal of endogenous cash flow of $113,882,673 and removing the value $2,649,577 of endogenous outflows leaves a value of $111,233,096 before removing any additional constituents in order to cover the remainder of the value for the exogenous outflow from the index.

In this example, holdings of the BII, having a market value of $9,350,423, are removed to meet the net remaining value of exogenous outflow. The specific constituents to be removed can be determined any number of ways. In this example, a pro-rata portion of all index constituents were removed. These constituents to be removed have a market value $9,350,423 and a total book value of $9,443,427 in the BII. This results in a recognized capital loss for the index of $93,004.

The endogenous outflow value of $2,649,577 and market value of constituents removed $9,350,423 may be combined for a value of $12,000,000, which may be removed from the index as an exogenous outflow.

The book value of these removed constituents is removed from the value of the book index at this point. The net book value of the index was calculated above as $111,233,096. Removing the book value of $9,443,427 from this value leaves a value of $101,789,670. Additional constraints may be applied to this value or it may be used for subsequent rebalancing starting Jul. 31, 2004.

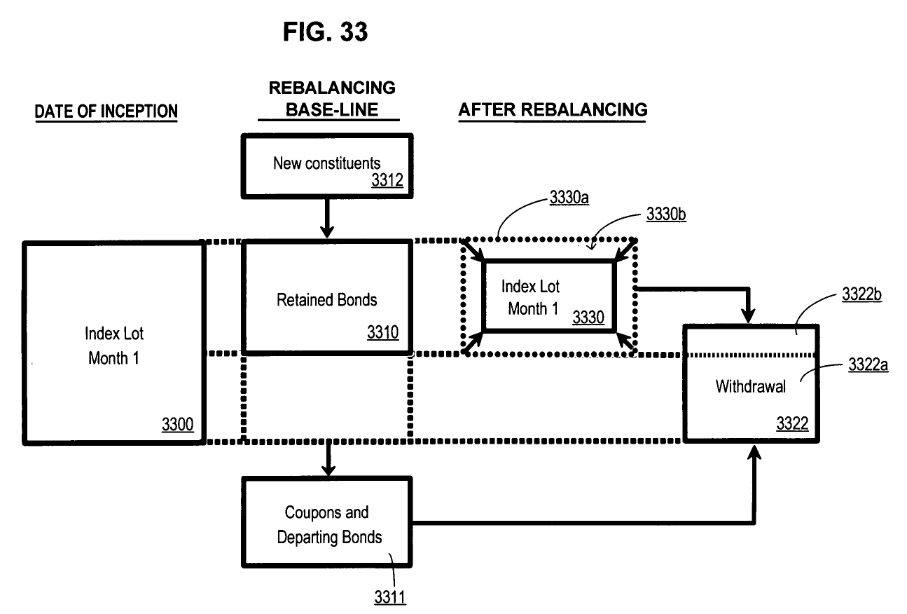

FIG. 33 provides an illustrative representation to assist with describing this example. This illustrates the rebalancing of endogenous outflows with a larger exogenous outflow. Although this figure involves a single index purchase lot at inception, it is understood that this may be equally applicable to an index with multiple index purchase lots, but is shown with a single index purchase lot for ease of example. For example, in the scenario outlined above, there are twelve index purchase lots at the start of the performance monitoring period; however, FIG. 33 depicts only a single purchase lot on the date of inception instead of the twelve index purchase lots as described in the scenario above. This is only for ease of explanation of the concept. This concept is equally applicable to the other ten index purchase lots as described above or any number of index purchase lots as described herein.

The first BII lot 3300 is shown at the beginning of the monitoring period. At the end of the monitoring period, the first lot 3300 is rebalanced, retaining the bonds retained by the base-line index at rebalancing and releasing the bonds that have left the base-line index by the rebalancing date. The rebalanced lot after this release is represented as 3310. The value of released constituents and coupon payments 3311 reflects the bonds that have left the BII and the interest payments made by the assets in the market corresponding to the BII constituents and comprise the endogenous outflows 3311.

A withdrawal is removed from the portfolio. Therefore, an exogenous outflow 2522 of may be removed from the BII to reflect this withdrawal. The entire value of endogenous outflows in the BII 3311 may be removed from the index to cover this exogenous outflow. This amount alone, however, is not sufficient to meet the value of exogenous outflow. It is only a portion 3322a of the total exogenous outflow 3322 removed from the index. A pro-rata portion 3330b of the constituents that remain in the initial index purchase lot 3330a may be removed, reducing the value of the initial index purchase lot 3330. The market value of the removed constituents may be used to cover the remainder of the exogenous outflow 3322b. The total value of exogenous outflow 3322 is comprised of the sum of the values generated from endogenous outflows 3322a and the market value of constituents removed from the index 3322b.

If the index were comprised of twelve index purchase lots on the date of inception, as described above, there would be additional index purchase lots before and after rebalancing, each acting in a similar fashion as that illustrated in FIG. 33.

FIGS. 18A, 18C, and 26 as discussed above also provide another representation to assist with describing this scenario in the hypothetical example.

Each monthly rebalancing involving an exogenous outflow that is greater than the endogenous outflow generated by an index or index purchase lot may occur in a very similar fashion.

### EXAMPLE 3

### Reinvestment Replicating the Base-Line Index Scaled to Cash Flows

This third example describes a hypothetical BII, used as a benchmark to a portfolio, which rebalances monthly reflecting a base-line index. At inception, the BII starts with an acquisition of the entire base-line index at market yields, wights, prices, and/or the like on the day of inception. This BII then begins with a lot comprised of the holdings of the entire base-line index as of the date of inception of the index as in the example above. At rebalancing, this embodiment of the BII then uses the value of endogenous outflows to subsequently create new lot(s) to reflect the updated status of the base-line index. The value of any exogenous inflows into the BII may be used to supplement any value of endogenous outflows and the value of any exogenous outflows or any portion of exogenous outflows may be deducted from the value of any endogenous outflow, using the resulting value of net endogenous outflow, if any exists, in acquiring new lots.

Index purchase lots are added to the BII to provide an overall BII with the same composite constituent weights as the base-line index scaled to value of the initial and subsequent cash flows into the index. These index purchase lots may include a lot comprising the holdings of the entire base-line index, a lot comprising only new constituents that have entered the base-line index, and/or a combination of the two, at market yields, weights, prices, and/or the like on the day of acquisition, such that the final composite of index purchase lots place the total BII inline with the constituent weighting of the base-line index.

In one embodiment, a pro-rata portion of all previously purchased lots may be sold, with all or a portion of the proceeds invested in a purchase lot of new constituents entering the base-line index subsequent to the previous rebalancing, in order to keep the composition of the BII in line with the base-line index.

One advantage of this embodiment is that it maintains a BII that closely mimics the base-line index adjusting for the initial value and subsequent exogenous cash flows of the BII.

Below are descriptions of select periods during the performance monitoring of the index to provide an illustration of the performance of this index.

### EXAMPLE 3

### First Month—No Exogenous Cash Flow

The first lot of the BII is created on Dec. 31, 2003 with a value of $100,000,000 comprised of the entire holdings of the base-line index. During January, the BII, comprised of the first lot purchased, generates a 0.310% ordinary income return and a 0.001% recognized capital gain return. The small capital gain was caused by bonds exiting the base-line index and reflecting the exit of such bonds in the BII at the Jan. 31, 2004 rebalancing at market prices that were slightly higher, on average, than their book prices in the BII. These returns increased the book value prior to removal of endogenous cash flow of the index to $100,311,440. Part of this value is comprised of endogenous outflows worth $2,131,945. This value may be removed from the initial purchase lot (Base-Full December 2003) and reinvested into new holdings of the base-line index. The result of reducing the book value of the first purchase lot (Base-Full December 2003) by the net rebalancing endogenous outflow is a final book value of the first purchase lot (Base-Full December 2003) of $98,179,495. This amount may then be carried forward to the next month as the February starting book value for this purchase lot (Base-Full December 2003).

The $2,131,945 value from endogenous outflows may then be invested in a combination of new lots with constituents incorporated at market values, yields, prices, and/or the like on Jan. 31, 2004, one lot (Base-New January 2004) comprised of the new holdings that have entered the base-line index since inception, Dec. 31, 2003, and another lot (Base-Full January 2004) comprised of all holdings of the base-line index on Jan. 31, 2004. The total value of newly added constituents to the BII on Jan. 31, 2004 is $2,131,945, with the value of the lot of new holdings of the base-line index (Base-New January 2004) representing $1,979,544 and the value of the lot of all holdings of the base-line index (Base-Full January 2004) representing $152,400.

After the Jan. 31, 2004 rebalancing, the BII is comprised of three purchase lots, one created on Dec. 31, 2003 (Base-Full December 2003) with a value of $98,179,495, one created on Jan. 31, 2004 (Base-New January 2004) with a value of $1,979,544, and another created on Jan. 31, 2004 (Base-Full January 2004) with a value of $152,400.

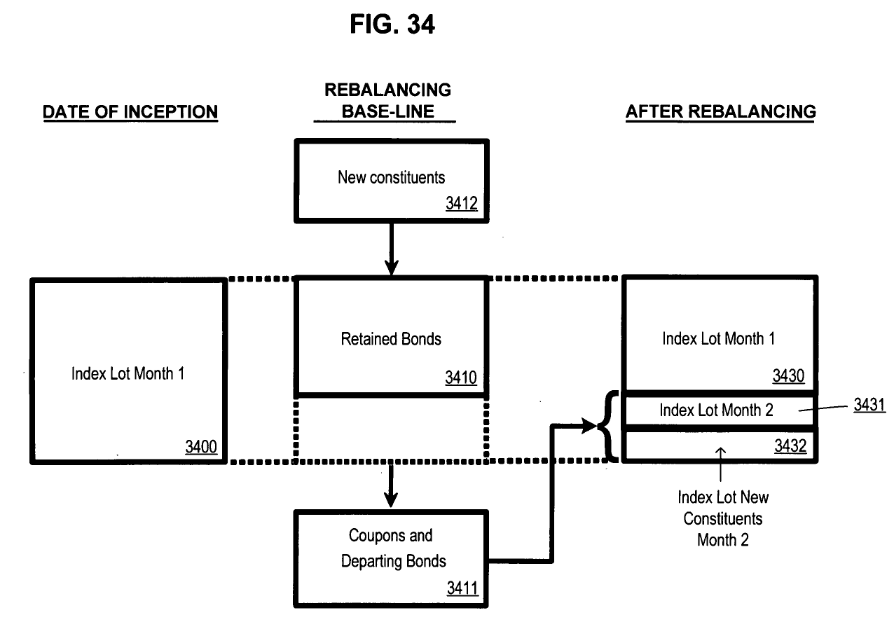

FIG. 34 provides an illustrative representation to assist with describing this example. This illustrates the rebalancing of endogenous outflows with no exogenous inflows or outflows. Although this figure involves a single index purchase lot at inception, it is understood that this may be equally applicable to an index with multiple index purchase lots, but is shown with a single index purchase lot for ease of representation.

The first BII lot 3400 (Base-Full December 2003) purchased on the Dec. 31, 2003 for $100,000,000 is shown on its inception date. On Jan. 31, 2004, the first lot 3400 (Base-Full December 2003) is rebalanced, retaining the bonds retained by the base-line index at rebalancing and releasing the bonds that have left the base-line index by the rebalancing date, represented as a rebalanced lot 3410. The value of released constituents and coupon payments 3411 reflects the bonds that have left the BII and the interest payments made by the assets in the market corresponding to the BII constituents. This value comprises the endogenous outflows 3411 of the index.

On the rebalancing date, Jan. 31, 2004, the book value of the first index purchase lot 3400 may be adjusted to reflect the updated status of the base-line index, represented as the index purchase lot after rebalancing. This index purchase lot (Base-Full December 2003) 3410 has an initial updated book value prior to removal of endogenous cash flow of $100,311,440, which is then reduced by endogenous outflows 3411 with a value of $2,131,945, reflecting the endogenous outflows of the base-line index. The resulting lot (Base-Full December 2003) 3410 has a reduced value of $98,179,495, which is carried forward as an index purchase lot 3430 for the application of additional constraints or possible subsequent rebalancings.

The value of BII endogenous outflows 3411 is $2,131,945. This value 3411 is reinvested into two index purchase lots purchased market values, yields, prices and/or the like on Jan. 31, 2004: (1) an index lot 3431 comprising all holdings of the base-line index on Jan. 31, 2004 with a value of $152,400 and (2) an index lot 3432 comprising only the new holdings of the base-line index added to the index after Dec. 31, 2003, but before or on Jan. 31, 2004 with a value of $1,979,544. Both index purchase lots 3431 and 3432 contain the new constituents added to the base-line index 3412 since Dec. 31, 2003.

Thus, after rebalancing, this BII is comprised of three index purchase lots: the remaining portion of the first index lot 3430 initially purchased on Dec. 31, 2003 (Base-Full December 2003) with a value of $98,179,495, the second index lot 3431 purchased on Jan. 31, 2004 (Base-Full January 2004) with a value of $152,400, and third index lot 3432 also purchased on Jan. 31, 2004 (Base-New January 2004) with a value of $1,979,544.

FIGS. 18A, 18D, 36, and 37 provide yet another representation to assist with describing this scenario in the hypothetical example. Referring to the logic flow diagram of FIG. 18A, once performance monitoring commences on Dec. 31, 2003, a determination 1800 is made concerning the reinvestment and rebalancing strategy for the BII. At this point in the example, it is determined that the index will be rebalanced monthly using the value of endogenous outflows and exogenous inflows to invest in constituents of the base-line index to bring the constituent weightings of the BII in line with the base-line index.

Once these determinations 1800 have been made, a BII may be created 1801 investing the entire value of the BII into the full base-line index at market yields, weights, prices, and/or the like. In this example, the index is comprised of one acquisition of the entire base-line index (Base-Full December 2003) on Dec. 31, 2003 with a value of $ 100,000,000.

After creating a BII 1801, the process of rebalancing may unfold. In this scenario, cash flow is reinvested into the BII to bring the constituent weightings of the BII in line with the base-line TBII. This will result in a negative response to the query 1810 of whether to invest all cash flow in the full base-line index, which leads to FIG. 18B and a negative response to query 1820 of whether to reinvest endogenous cash flow in newly added constituents to the base-line index and exogenous cash flows in the full base-line index. This leads to the question 1830 of whether to invest to replicate the TBII scaled to cash inflows of the BII. Because this is applicable in this scenario, FIG. 18A leads to FIG. 18D.

If this were not the case, a negative response would lead to query 1840 where it is decided whether to reinvest cash flow based on some other preferred criteria. If it is decided to reinvest based on other criteria, a reinvestment strategy and procedures may be established 1841. This reinvestment strategy and the procedures it entails may be established in line with performance measurement needs and/or preferences and may be constructed according to a variety of possible constructions and procedures based on the disclosure herein.

FIG. 18D provides a map for determining which logic flow diagram may be applicable regarding BII cash flows where, at rebalancing, the BII is brought in line with the constituent weightings of the TBII. In this scenario, there are no exogenous cash flows. Thus, the answer to query 1831 of whether there is exogenous cash inflow is negative, which leads to query 1832. Query 1832 applies to exogenous cash flow out, which is also not present in this scenario. A negative response to 1832 leads to FIG. 36.

Because an index may be rebalanced according to any number of rebalancing preferences and involve a number of circumstances, variables, inputs, and/or the like, this routine may be modified to assist with providing the proper logic flow diagram applicable to the set of circumstances, variables, inputs and/or the like for resolution.

FIG. 36 provides an illustrative representation of the rebalancing process with no exogenous cash flows. On the rebalancing date of Jan. 31, 2004, the base-line index is examined to determine 3600 what changes have occurred since Dec. 31, 2003. This determination 3600 may involve what bonds left the base-line index, what bonds entered the base-line index, the prices, yields, values, and/or the like of bonds in the base-line index. This determination may also involve what the current constituent weightings are of holdings of the entire TBII including new holdings that have entered the TBII during the performance monitoring period.

Once the base-line index has been examined 3600 and the changes within it determined, the BII is examined. Using the updated data from the base-line index, the value of endogenous outflows for the BII since Dec. 31, 2003 may be determined 3610. Here, it is determined that the book value prior to the removal of endogenous outflows of the first lot (Base-Full December 2003) on Jan. 31, 2004 has increased to $100,311,440 and the value of endogenous outflows is $2,131,945.

It should be determined 3625 if the value of BII endogenous outflows is sufficient to accommodate the rebalancing of the BII to bring the BII in line with the total TBII market weights as of the rebalancing date without further funding. This determination may entail the determination of what constituents must be added and/or removed from the BII in order to bring it in line to roughly reflect the TBII and the calculation of the value generated by the removal of constituents, the value necessary to add constituents, and/or the like. If it is determined that the value of the endogenous outflow is not enough, or lower than the value necessary to bring the BII in line with the proper constituent weighting, FIG. 38 provides the logic flow diagram for that scenario. Here, however, it is assumed that the endogenous outflows are sufficient to accommodate a rebalancing of the BII to reflect the total TBII market weighting, which leads to FIG. 37.

FIG. 37 provides the logic flow diagram for rebalancing the BII to reflect the total TBII market weighting where the endogenous outflows alone provide sufficient value to accommodate this. The BII may be preliminarily rebalanced 3730. This rebalancing 3730 may involve adding, at market yields, weights, prices, and/or the like, constituents to the BII to reflect (1) holdings of the entire TBII and (2) new holdings that have entered the TBII since, in this case, inception. The total value of added constituents to the BII is equal to the value of endogenous outflows calculated for the BII 3610. These constituents are added to the BII in a manner that would give the BII the same, or similar, resultant constituent weightings as that of the TBII as of the date of rebalancing, which is Jan. 31, 2004 in this case.

This rebalancing 3730 results in an updated book value of the first lot (Base-Full December 2003) of $98,179,495 going forward into the application of additional constraints and/or the next rebalancing period if applicable. At this rebalancing 3730, the value of endogenous outflows $2,131,945 may be used to invest in the base-line index at market yields, weights, prices, and/or the like as of Jan. 31, 2004 in two lots: (1) the first lot consists only of holdings that have been added to the TBII since Dec. 31, 2003 (Base-New January 2004) and (2) the second lot consists of holdings of the entire TBII at rebalancing (Base-Full January 2004).

These two lots (Base-New January 2004) and (Base-Full January 2004) are added to the holdings of the BII on Jan. 31, 2004, the result of which should give the BII a composite constituency weighting equal to, or similar to, the TBII constituency weighting. In this example, the value of the first lot of newly added TBII holdings (Base-New January 2004) is $1,979,544 and the value of the second lot of the entire TBII holdings (Base-Full January 2004) is $152,400.

Thus, after the January rebalancing, three index purchase lots exist for the application of additional constraints and/or subsequent rebalancings if applicable: the first lot (Base-Full December 2003) with a value of $98,179,495, the second lot (Base-New January 2004) with a value of $1,979,544, and the third lot (Base-Full January 2004) with a value of $152,400.

Preliminary book income results may then be compiled and/or calculated 3740. The existence and application of additional constraints may now be determined 3750, such as whether to impose gain/loss limits, whether there are buy and hold requirements, and/or the like. It is, of course, not necessary that this step occur at this point in the process. The choice of taking these steps at this point in the process was merely one of convenience for representation. Once it is determined if and what additional constraints exist, it should be determined 3751 whether the preliminary book income results calculated 3740 contravene these constraints 3750. If the preliminary book income results compiled 3740 do contravene, the preliminarily rebalanced BII may be modified to resolve any conflicts 3752 with these constraints 3750. The steps involved in this modification are discussed in greater detail below. Once the index has been modified 3752, it may be finalized 3760. If the preliminary book income results compiled 3740 do not contravene, the BII is finalized 3760.

At this point, statistics may be calculated and compiled 3770 for the BII. There are numerous examples of the statistics, metrics, and/or the like that may be compiled, calculated, and/or the like, as discussed above, including, but not limited to compiling performance statistics and valuations of the index holdings. If performance monitoring is complete, a negative response to query 3780 will lead to the end of this process. If performance monitoring is to continue, a positive response will lead back to FIG. 18A.

If the BII endogenous outflows were not sufficient to accommodate the rebalancing discussed above, steps could be taken to alleviate this situation. It is possible that, depending upon the reinvestment and rebalancing strategy, if endogenous outflows were insufficient, the rebalancing would continue using the endogenous outflows to bring the BII constituent weighting as close to the constituent weighting of the TBII as possible and using no other funding to assist in the efforts. It is also possible to access further funding to assist with bringing the BII in line with the TBII.

One embodiment of the system involves rebalancing a BII to provide a resultant composite BII constituent weighting that is the same as, or similar to, that of the TBII where the value of endogenous outflow is insufficient alone to accommodate this. This may entail the removal of BII constituents for value and using this value to accommodate a rebalancing in line with the performance measurement preferences.

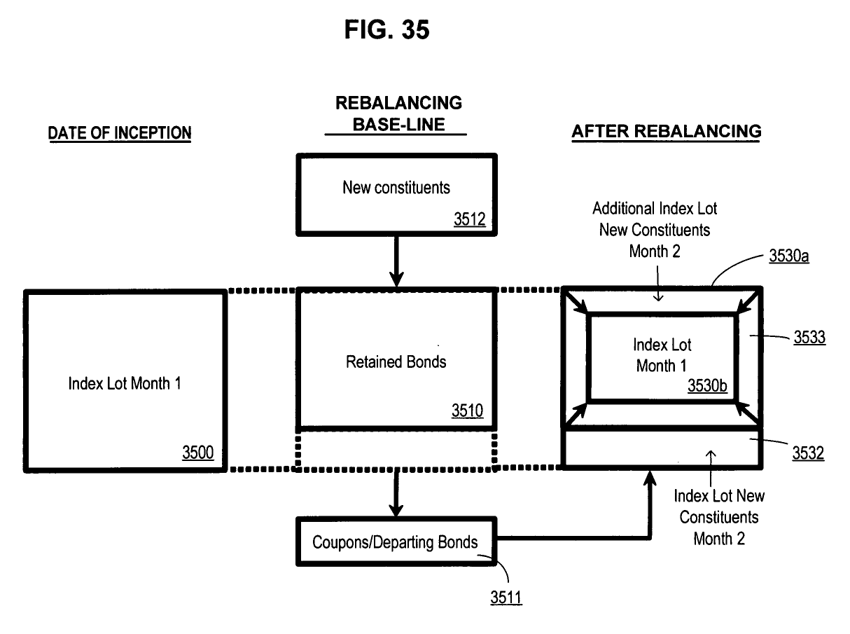

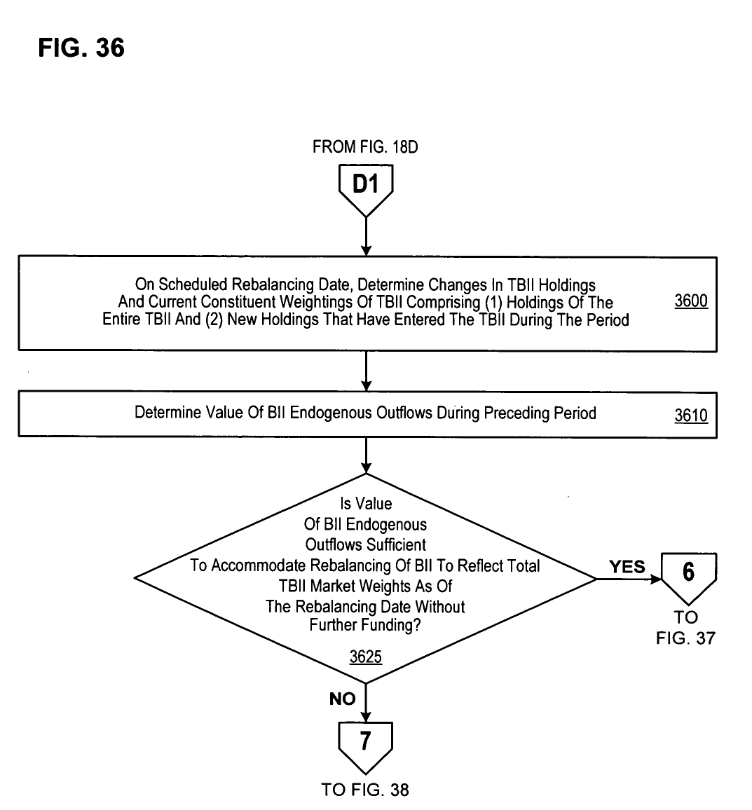

FIG. 35 provides an illustrative representation to assist with describing this example. This illustrates the rebalancing of endogenous outflows with no exogenous cash flow. Although this figure involves a single index purchase lot at inception, it is understood that this may be equally applicable to an index with multiple index purchase lots, but is shown with a single index purchase lot for ease of example

The first BII lot 3500 (Base-Full December 2003) purchased on the Dec. 31, 2003 for $100,000,000 is shown on its inception date. On Jan. 31, 2004, the first lot 3400 (Base-Full December 2003) is rebalanced, retaining the bonds retained by the base-line index at rebalancing and releasing the bonds that have left the base-line index by the rebalancing date, represented as a rebalanced lot 3510. The value of released constituents and coupon payments 3511 reflects the bonds that have left the BII and the interest payments made by the assets in the market corresponding to the BII constituents.

On the rebalancing date, Jan. 31, 2004, the book value of the first index purchase lot 3500 may be adjusted to reflect the updated status of the base-line index, represented as the index purchase lot after rebalancing. This index purchase lot (Base-Full December 2003) 3510 has an initial updated value of $100,311,440, which is then reduced by endogenous outflows 3511 which, in this hypothetical example, has a value of $1,495,160, reflecting the endogenous outflows of the BII. The resulting lot (Base-Full December 2003) 3510 has a reduced value of $98,816,280, which is shown as index purchase lot 3530a prior to additional processing.

The value of BII endogenous outflows 3511 is $1,495,160, reflecting the value of endogenous outflows calculated for the BII. This value 3511 is reinvested into an index purchase lot 3532 comprising the new holdings of the base-line index added to the index after Dec. 31, 2003, but before or on Jan. 31, 2004 with a value of $1,495,160.

The value of the existing index purchase lot 3530a of $98,816,280 and newly created index purchase lot 3532 of $1,495,160 have a composite BII constituent weighting that, in this example, does not match the TBII constituent weighting. Additional steps are necessary to bring the BII in line with the TBII constituent weightings. These steps may not necessarily be taken individually, but may be combined or separated into additional steps. For, example, the acquisition of additional constituents and the corresponding value into the index purchase lot from endogenous outflows 3532 and from the removal of index purchase lot constituents 3533 may all be done as one acquisition of index purchase lot holdings.

There are number of ways to deal with this situation. In this hypothetical example, holdings of the existing index purchase lot 3530a are removed, resulting in a final reduced value for the initial index purchase lot 3530b. The market value of the holdings removed may then be used to invest in the proper index constituents to bring the composite BII constituent weighting in line with the weighting of the TBII. In this example, the value of the existing index purchase lot 3530a was $98,816,280. This value may be reduced by the value of $484,384, which may then be used to create a new index purchase lot 3533 comprising the new holdings of the base-line index added to the index after Dec. 31, 2003, but before or on Jan. 31, 2004. The final reduced value of the initial index purchase lot 3530b is $98,816,280. The resultant composite BII constituent weightings should now be in line with the constituent weighting of the TBII.

Thus, after rebalancing, this BII is comprised of three subsidiary index purchase lots: the first index lot 3530b created Dec. 31, 2003 (Base-Full December 2003) of the constituents of the entire TBII with a value of $98,331,896, the second index lot 3532 created on Jan. 31, 2004 (Base-NewA January 2004) of the new constituents added to the TBII with a value of $1,495,160, and third index lot 3533 created on Jan. 31, 2004 (Base-NewB January 2004) of the new constituents added to the TBII with a value of $484,384. The BII after rebalancing may also be represented as two subsidiary index lots, where the two additional lots of new constituents are merged to form one index purchase lot (Base-New January 2004) of new constituents added to the TBII with a total value of $2,131,945.

In FIG. 36, once determinations have been made regarding the TBII holdings 3600 and BII endogenous outflows 3610, it should be determined 3625 if the value of BII endogenous outflows is sufficient to accommodate the rebalancing of the BII to bring the BII in line with the total TBII market weights as of the rebalancing date without further funding. The value of BII endogenous outflows is $1,495,160. If this value is sufficient, FIG. 37 and the corresponding discussion above provide an illustration of this process. If this value is insufficient and the reinvestment and rebalancing strategy determined 1800 that further rebalancing steps should be taken to bring the BII constituent weighting in line with the TBII constituent weighting, this determination 3625 leads to FIG. 38.

FIG. 38 provides the logic flow diagram for rebalancing the BII to reflect the total TBII market weighting where the endogenous outflows alone do not provide sufficient value to accommodate this rebalancing. In this scenario, during the reinvestment and rebalancing determinations 1800, it was decided that, in order to meet the value of the shortfall between the value necessary to complete the BII rebalancing in line with the strategy and the applicable value of endogenous outflow, BII holdings would be removed and their market value reinvested in the BII to complete the rebalancing.

If BII holdings are to be removed, it should be determined which constituents to remove 3825. This determination 3825 entails deciding which BII holdings should be removed for the rebalancing of the BII to reflect the total TBII market weights on the rebalancing date while accounting for the BII endogenous outflows.

The BII may be preliminarily rebalanced 3830. This rebalancing 3830 may involve the addition of constituents 3830a to the BII with a value roughly equal to that of the BII endogenous outflows at market yields, weights, prices, and/or the like, that reflect the new holdings that have entered the TBII since, in this case, inception. This rebalancing 3830 may also involve the removal of BII holdings 3830b according to the preferences of the BII as determined 3825 and the addition of constituents to the BII with a total value roughly equal to that of the removed BII holdings. In other words, the market value resulting from the removed constituents may be used to acquire constituents to the BII with a total market value of acquired constituents roughly equal to the value of removed constituents. These added constituents to the BII 3830b may reflect new holdings that have entered the TBII since, in this case, inception and acquired at market yields, weights, prices, and/or the like, which is inline with the performance measurement preferences and the reinvestment and rebalancing strategy 1800.

This rebalancing 3830 results in an updated book value of the first lot (Base-Full December 2003) of $98,331,896. At this rebalancing 3830, the value of endogenous outflows $1,495,160 plus the value of removed BII holdings $484,384 may be used to invest in a purchase lot (Base-New January 2004) of the new additions to the base-line index at market yields, weights, prices, and/or the like as of Jan. 31, 2004, with a total value of $2,131,945.

Preliminary book income results may then be compiled and/or calculated 3840. The existence and application of additional constraints may now be determined 3850, such as whether to impose gain/loss limits, whether there are buy and hold requirements, and/or the like. Once it is determined if and what additional constraints exist, it should be determined 3851 whether the preliminary book income results calculated 3840 contravene these constraints 3850. If the preliminary book income results compiled 3840 do contravene, the preliminarily rebalanced BII may be modified to resolve any conflicts 3852 with these constraints 3850. The steps involved in this modification are discussed in greater detail below. Once the index has been modified 3852, it may be finalized 3860. If the preliminary book income results compiled 3840 do not contravene, the BII is finalized 3860.

At this point, statistics may be calculated and compiled 3870 for the BII. If performance monitoring is complete, a negative response to query 3880 will lead to the end of this process. If performance monitoring is to continue, a positive response will lead back to FIG. 18A.

### EXAMPLE 3

### Second Month—Exogenous Inflow, No Exogenous Outflow

Performance monitoring may continue into a second month. The second month in this hypothetical example is similar to the first, except that the index begins the performance monitoring period comprised of three purchase lots to rebalance: the first purchase lot (Base-Full December 2003), the second purchase lot (Base-New January 2004), and the third purchase lot (Base-Full January 2004). In addition, an exogenous inflow is added to the index at the end of the performance monitoring period. This hypothetical example continues after the Jan. 31, 2004 rebalancing above where the BII endogenous outflows were sufficient to accommodate rebalancing the BII to bring composite constituent weightings in line with the TBII total constituent weightings.

During February, the BII gained in value. The index on Jan. 31, 2004 has a value of $100,311,439, comprised of the sum of index purchase lot values. The value of the first lot (Base-Full December 2003) is $98,179,495, the value of the second lot (Base-New January 2004) is $1,979,544, and the value of the third lot (Base-Full January 2004) is $152,400. On Feb. 29, 2004, the book value of the index and each lot is calculated as of that date but prior to the removal of endogenous cash flow. The value of the index as a result of this calculation is $100,614,354, consisting of the sum of rebalanced values of the index purchase lots: $98,476,541, $1,984,977, and $152,836.

Upon rebalancing, the endogenous outflows generated by each of the lots are calculated, having values of $2,856,177 for the first lot (Base-Full December 2003), $123,249 for the second lot (Base-New January 2004), and $4,516 for the third lot (Base-Full January 2004) for a sum of $2,983,941 for the value of endogenous outflow for the index. The result of removing the value of endogenous outflows from each lot (Base-Full December 2003), (Base-New January 2004), and (Base-Full January 2004) in the index is a reduced value for each lot of $95,620,364, $1,861,729, and $148,321, respectively.

In February, $2,000,000 was deposited into the portfolio. Reflecting this, an exogenous inflow of $2,000,000 is recognized in the BII at the Feb. 29, 2004 rebalancing. The value the exogenous inflow, $2,000,000, and the value of endogenous outflows, $2,983,941, may be combined for a total value of $4,983,941 to be invested into the BII.

In order to bring the resultant composite BII constituent weighting in line with the composite TBII constituent weighting, this $4,983,941 value may be invested in one or more index purchase lots. How this value is invested and what it is invested in would depend upon the performance monitoring preferences for the BII and what is necessary to accommodate bringing the BII in line with these preferences. In this scenario, the value for investing in the BII may be invested in an index purchase lot comprising constituents of the entire base-line index and/or an index purchase lot comprising newly added constituents to the base-line index depending upon the relevant variables.

In this hypothetical example, the $4,983,941 value is invested in two index purchase lots. One index purchase lot (Base-New February 2004), with a value of $2,627,462, is comprised of new holdings that have entered the base-line index since Jan. 31, 2004, at market values, yields, prices, and/or the like on Feb. 29, 2004. The other index purchase lot (Base-Full February 2004), with a value of $2,356,479, is comprised of all holdings of the base-line index on Feb. 29, 2004, at market values, yields, prices, and/or the like. These additional index purchase lots are created to accommodate producing final BII constituent weightings after rebalancing that is roughly the same or similar to the constituent weightings of the TBII on the rebalancing date of Feb. 29, 2004.

After the Feb. 29, 2004 rebalancing, the BII is comprised of five index purchase lots: the first (Base-Full December 2003) with a value of $95,620,364, the second (Base-New January 2004) with a value of $1,861,729, the third (Base-Full January 2004) with a value of $148,321, the fourth (Base-New February 2004) with a value of $2,627,462, and the fifth (Base-Full February 2004) with a value of $2,356,479. The total value of the BII after rebalancing is $102,614,355. These values are carried forward to the next month as the March starting book values.

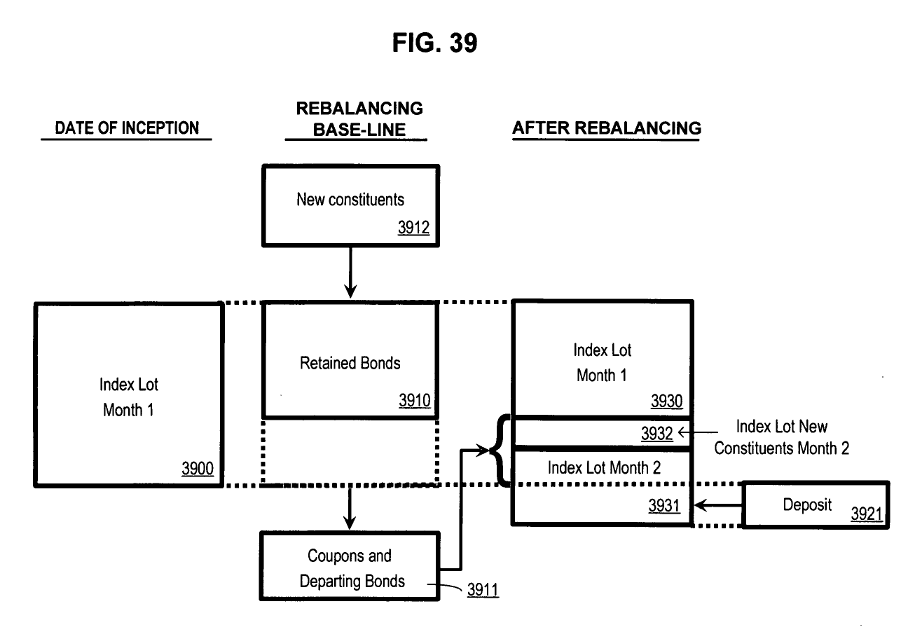

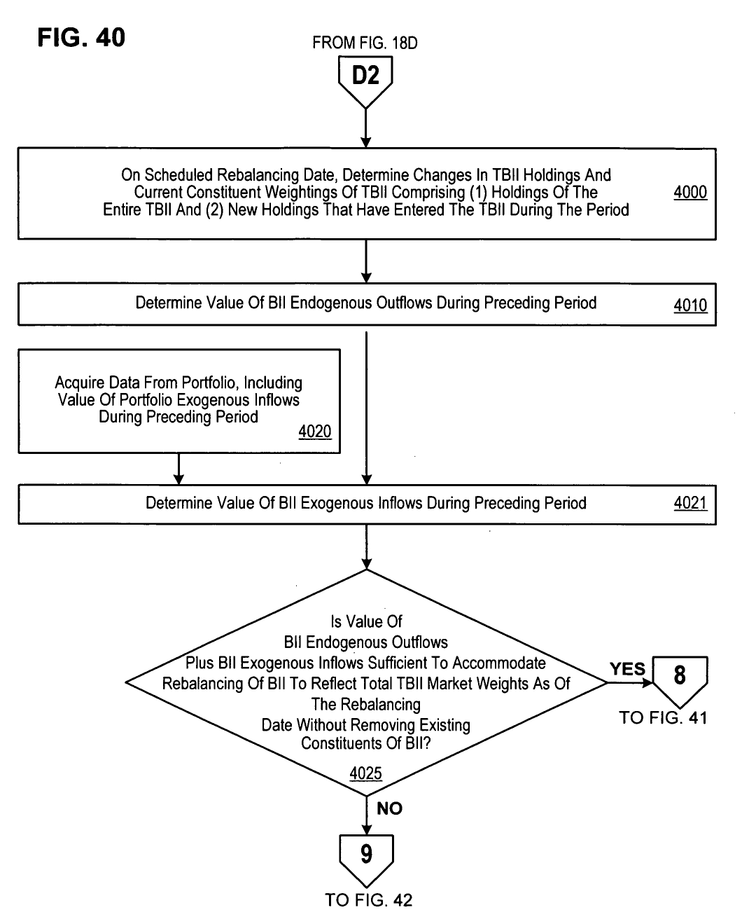

FIG. 39 provides an illustrative representation to assist with describing this example. This illustrates the rebalancing of endogenous outflows with an exogenous inflow. Although this figure involves a single index purchase lot at inception, it is understood that this may be equally applicable to an index with multiple index purchase lots, but is shown with a single index purchase lot for ease of representation.

The first BII lot 3900 is shown at the beginning of the monitoring period. At the end of the monitoring period the first lot 3900 is rebalanced, retaining the bonds retained by the base-line index at rebalancing and releasing the bonds that have left the base-line index by the rebalancing date, represented as a rebalanced lot 3910. The value of released constituents and coupon payments 3911 reflects the bonds that have left the BII and the interest payments made by the assets in the market corresponding to the BII constituents.

An exogenous inflow 3921 is added to the index in this example. This inflow value 3921 may be combined with the value of endogenous outflow 3911. This total value of cash flow in, from endogenous outflows 3911 and exogenous inflow 3921, is invested into two index purchase lots: (1) an index lot 3931 comprising all holdings of the base-line index and (2) an index lot 3932 comprising only the new holdings of the base-line index added to the index after the beginning of the performance monitoring period but before or on the current rebalancing date. Both index purchase lots 3931 and 3932 reflect, but not necessarily, the new constituents added to the base-line index 3912 since the beginning of the performance monitoring period.

Thus, after rebalancing, this BII is comprised of three index purchase lots: the constituents retained from the first index lot 3930, the second index lot 3931 acquired at the rebalancing and containing all holdings of the base-line index, and the third index lot 3932 acquired at the rebalancing and containing all new constituents that entered the base-line index subsequent to the beginning of the performance monitoring period. If the index were comprised of three index purchase lots, as described above, there would be two additional index purchase lots in addition to the initial index purchase lot 3900 and there would be two additional index purchase lots after rebalancing in addition to the rebalanced initial index purchase lot 3930 and newly created index purchase lots 3931 and 3932. Further, as described above, the newly created index purchase lots 3931 and 3932 might be comprised of endogenous outflows from the additional index purchase lot not shown.

FIGS. 18A, 18D, 40, and 41 provide yet another representation to assist with describing this scenario in the hypothetical example. Referring to the logic flow diagram of FIG. 18A, at this point (“A”) in the scenario performance monitoring has already commenced and determinations 1800 have been made and the BII has been created 1801.

In this scenario, cash flow is reinvested into the BII to bring the constituent weighting of the BII in line with the base-line TBII. This will result in a negative response to the query 1810 of whether to invest all cash flows in the full base-line index, which leads to FIG. 18B and a negative response to query 1820 of whether to invest endogenous cash flow in newly added constituents to the base-line index and exogenous cash flow in the full base-line index. This leads to the question 1830 of whether to invest to replicate the TBII scaled to the initial size and subsequent cash flows of the portfolio. Because this is applicable in this scenario, FIG. 18A leads to FIG. 18D.

If this were not the case, a negative response would lead to query 1840 where it is decided whether to reinvest cash flow based on some other preferred criteria. If it is decided to reinvest based on other criteria, a reinvestment strategy and procedures may be established 1841. This reinvestment strategy and the procedures it entails may be established in line with performance measurement needs and/or preferences and may be constructed according to a variety of possible constructions and procedures based on the disclosure herein.

FIG. 18D provides a map for determining which logic flow diagram may be applicable regarding BII cash flows where, at rebalancing, the BII is brought in line with the constituent weightings of the TBII. In this scenario, there is an exogenous inflow. Thus, the answer to query 1831 of whether there is exogenous cash inflow is positive, which leads to FIG. 40. FIG. 40 provides an illustrative representation of the rebalancing process with an exogenous cash inflow.

Because an index may be rebalanced according to any number of rebalancing preferences and involve a number of circumstances, variables, inputs, and/or the like, this routine may be modified to assist with providing the proper logic flow diagram applicable to the set of circumstances, variables, inputs and/or the like for resolution.

FIG. 40 provides an illustrative representation of the rebalancing process with an exogenous inflow. On the rebalancing date of Feb. 29, 2004, the base-line index is examined to determine 4000 what changes have occurred since Jan. 31, 2004. This determination 4000 may involve what bonds left the base-line index, what bonds entered the base-line index, the prices, yields, values, and/or the like of bonds in the base-line index. This determination may also involve what the current constituent weightings are of holdings of the entire TBII including new holdings that have entered the TBII during the performance monitoring period.

Once the base-line index has been examined 4000 and the changes within it determined, the BII is examined. Using the updated data from the base-line index, the value of endogenous outflows for the BII since Jan. 31, 2004 may be determined 4010. Here, it is determined that the book value, prior to removal of endogenous cash flow of the first lot (Base-Full December 2003) has increased to $98,476,541 and the value of endogenous outflows is $2,856,177, the book value prior to removal of endogenous cash flow of the second lot (Base-New January 2004) has increased to $1,984,977 and the value of endogenous outflows is $123,249, and the book value prior to removal of endogenous cash flow of the third lot (Base-Full January 2004) has increased to $152,836 and the value of endogenous outflows is $4,516. The total value of endogenous outflows generated in the BIIS is $2,983,941.

Data may be acquired 4020 regarding any data necessary for the performance monitoring index. For example, in this case, the portfolio may be examined and through this examination it may be discovered that there was a portfolio deposit in the amount of $2,000,000. It may be that there is no data acquired here. This deposit may be reflected in the index as an exogenous inflow. In this example, the value of exogenous inflow is determined 4021, based on the information acquired 4020 from the portfolio, to be $2,000,000.

It should be determined 4025 if the value of BII endogenous outflows is sufficient to accommodate the rebalancing of the BII to bring the BII in line with the total TBII market weights as of the rebalancing date without further rebalancing adjustments. This determination may entail the determination of what constituents must be added and/or removed from the BII in order to bring it in line to roughly reflect the TBII and the calculation of the value generated by the removal of constituents, the value necessary to add constituents, and/or the like. If it is determined that the value of the endogenous outflow is not enough, or lower than the value necessary to bring the BII in line with the proper constituent weighting, FIG. 42 provides the logic flow diagram for that scenario. Here, however, it is assumed that the endogenous outflows are sufficient to accommodate a rebalancing of the BII to reflect the total TBII market weighting, which leads to FIG. 41.

FIG. 41 provides the logic flow diagram for rebalancing the BII to reflect the total TBII market weighting where the endogenous outflows plus exogenous inflows provide sufficient value to accommodate this. The BII may be preliminarily rebalanced 4130. This rebalancing 4130 may involve adding, at market yields, weights, prices, and/or the like, constituents to the BII to reflect (1) holdings of the entire TBII and (2) new holdings that have entered the TBII since, in this case, the Jan. 31, 2004 rebalancing. The total value of added constituents to the BII is equal to the value of endogenous outflows calculated for the BII 4010 plus the value of exogenous inflows calculated for the BII 4021. These constituents are added to the BII in a manner that would give the BII the same, or similar, resultant composite constituent weighting as that of the TBII as of the date of rebalancing, which is Feb. 29, 2004 in this case.

This rebalancing 4130 results in a reduced book value of the first lot (Base-Full December 2003) of $95,620,364, a reduced book value of the second lot (Base-New January 2004) of $1,861,729, and a reduced book value of the third lot (Base-Full January 2004) of $148,321 for the application of additional constraints and/or subsequent rebalancings if applicable.

At this rebalancing 4130, the value of endogenous outflows $2,983,941 and the value of exogenous inflow $2,000,000 may be combined for a value of $4,983,941 and used to invest in the base-line index at market yields, weights, prices, and/or the like as of Feb. 29, 2004 in two lots: (1) the first lot consists only of holdings that have been added to the TBII since inception (Base-New February 2004) and (2) the second lot consists of holdings of the entire TBII at rebalancing (Base-Full February 2004).

These two new lots (Base-New February 2004) and (Base-Full February 2004) are added to the holdings of the BII on Feb. 29, 2004, the result of which should give the BII a composite constituency weighting equal to, or similar to, the TBII constituency weighting. In this example, the value of the first lot of newly added TBII holdings (Base-New January 2004) is $2,627,462 and the value of the second lot of the entire TBII holdings (Base-Full January 2004) is $2,356,479.

Thus, after the February rebalancing, five index purchase lots exist for the application of additional constraints and/or subsequent rebalancings if applicable: the first lot (Base-Full December 2003) with a value of $95,620,364, the second lot (Base-New January 2004) with a value of $1,861,729, the third lot (Base-Full January 2004) with a value of $148,321, the fourth lot (Base-New February 2004) with a value of $2,627,462, and the fifth lot (Base-Full February 2004) with a value of $2,356,479.

Preliminary book income results may then be compiled and/or calculated 4140. The existence and application of additional constraints may now be determined 4150, such as whether to impose gain/loss limits, whether there are buy and hold requirements, and/or the like. It is, of course, not necessary that this step occur at this point in the process. The choice of taking these steps at this point in the process was merely one of convenience for representation. Once it is determined if and what additional constraints exist, it should be determined 4151 whether the preliminary book income results calculated 4140 contravene these constraints 4150. If the preliminary book income results compiled 4140 do contravene, the preliminarily rebalanced BII may be modified to resolve any conflicts 4152 with these constraints 4150. The steps involved in this modification are discussed in greater detail below. Once the index has been modified 4152, it may be finalized 4160. If the preliminary book income results compiled 4140 do not contravene, the BII is finalized 4160.

At this point, statistics may be calculated and compiled 4170 for the BII. There are numerous examples of the statistics, metrics, and/or the like that may be compiled, calculated, and/or the like, as discussed above, including, but not limited to compiling performance statistics and valuations of the index holdings. If performance monitoring is complete, a negative response to query 4180 will lead to the end of this process. If performance monitoring is to continue, a positive response will lead back to FIG. 18A.

If the combined value of the BII endogenous outflows and BII exogenous inflow was not sufficient to accommodate the rebalancing discussed above, steps could be taken to alleviate this situation. It is possible that, depending upon the reinvestment and rebalancing strategy, if the combined value of the BII endogenous outflows and BII exogenous inflow was insufficient, the rebalancing could continue using this combined value to bring the BII constituent weighting as close to the constituent weighting of the TBII as possible and use no other funding to assist in the efforts. It is also possible to apply further rebalancing adjustments to assist with bringing the BII in line with the TBII.

One embodiment of the system involves rebalancing a BII to provide a resultant composite BII constituent weighting that is the same as, or similar to, that of the TBII where the value of endogenous outflow plus exogenous inflows is insufficient alone to accommodate this. This may entail the removal of BII constituents for value and using this value to accommodate a rebalancing in line with the performance measurement preferences.

Using a hypothetical example that is very similar to that of the Feb. 29, 2004 rebalancing above, this scenario may be discussed

Using the hypothetical example discussed above with respect to the Feb. 29, 2004 rebalancing, a similar hypothetical example may be used to discuss and illustrate a situation where the BII endogenous outflows and exogenous inflows were insufficient for rebalancing purposes. In this hypothetical example, the state of the BII is the same as above on Jan. 31, 2004, but the TBII constituent weighting on Feb. 29, 2004 is different, requiring additional rebalancing adjustments beyond investing the combined values of BII endogenous outflows and the exogenous inflow.

In FIG. 40, once determinations have been made regarding the TBII holdings 4000, BII endogenous outflows 4010, and BII exogenous inflows 4021, it should be determined 4025 if the combined value of BII endogenous outflows and exogenous inflows is sufficient to accommodate the rebalancing of the BII to bring the BII in line with the TBII constituent market weights as of the rebalancing date without further rebalancing adjustments. The value of BII endogenous outflows in this example is $2,983,941 and the value of the exogenous inflow is $2,000,000. The combined value of BII cash flow is $4,983,941. BII cash flow would include any endogenous outflow, exogenous inflow, exogenous outflow, and/or the like depending upon what is applicable. In this case, it includes the value of endogenous outflows and the value of an exogenous inflow.

If this combined value of BII cash flow of $4,983,941 is sufficient, FIG. 41 and the corresponding discussion above provide an illustration of this process. If this combined value is insufficient and the reinvestment and rebalancing strategy determined 1800 that further rebalancing adjustments should be used to complete the rebalancing to bring the BII constituent weighting in line with the TBII constituent weighting, this determination 4025 leads to FIG. 42.

FIG. 42 provides the logic flow diagram for rebalancing the BII to reflect the TBII constituent market weightings where the combined value of BII endogenous outflows and BII exogenous inflows does not provide sufficient value to accommodate this rebalancing. In this scenario, during the reinvestment and rebalancing determinations 1800, it was decided that, in order to meet the value of the shortfall between the value necessary to complete the BII rebalancing in line with the strategy and the applicable combined value of endogenous and exogenous cash flow, BII holdings would be removed and their market value reinvested in the BII to complete the rebalancing.

If BII holdings are to be removed, it should be determined which to remove 4226. This determination 4226 entails deciding which BII holdings should be removed for the rebalancing of the BII to reflect the TBII market weights on the rebalancing date while accounting for any BII cash flow.

The BII may be preliminarily rebalanced 4230. This rebalancing 4230 may involve the addition of constituents 4230a to the BII with a value roughly equal to that of the BII cash flow at market yields, weights, prices, and/or the like, that reflect the new holdings that have entered the TBII since, in this case, Jan. 31, 2004. This rebalancing 4230 may also involve the removal of BII holdings 4230b according to the preferences of the BIIS as determined 4226 and the addition of constituents to the BII with a total value roughly equal to the value of removed BII holdings. In other words, the value resulting from the removed constituents may be used to acquire constituents for the BII with a total value of acquired constituents roughly equal to the value of removed constituents. These added constituents to the BII 4230b are used to adjust the BII constituent weightings. These constituents may reflect new holdings that have entered the TBII since, in this case, Jan. 31, 2004 and acquired at market yields, weights, prices, and/or the like, which is inline with the performance measurement preferences and the reinvestment and rebalancing strategy 1800. The removal of existing BII holdings and acquisition of new BII holdings 4230 may bring the composite BII constituent weighting roughly in line with the TBII constituent weighting.

This rebalancing 4230 results in a reduced book value of the first lot (Base-Full December 2003) of $95,620,364, a reduced book value of the second lot (Base-New January 2004) of $1,861,729, and a reduced book value of the third lot (Base-Full January 2004) of $148,321. These values are as a result of the removal of the value of endogenous outflows and the value of removed BII constituents. This rebalancing 4230 also calculates the value of the additional BII constituents to be removed, which in this case is $1,458,029.

At this rebalancing 4230, the sum of the values of endogenous outflows $2,983,941, exogenous inflow $2,000,000, and BII removed constituents $1,458,029 is used to invest in a purchase lot (Base-New February 2004) of the new additions to the base-line index at market yields, weights, prices, and/or the like as of Feb. 29, 2004, with a total value of $6,441,970.

The total value of the BII at this point is $102,614,355, comprised of four index purchase lots: (Base-Full December 2003) with a value of $94,192,353, (Base-New January 2004) with a value of $1,833,926, (Base-Full January 2004) with a value of $146,106, and (Base-New February 2004) with a value of $6,441,970.

Preliminary book income results may then be compiled and/or calculated 4240. The existence and application of additional constraints may now be determined 4250, such as whether to impose gain/loss limits, whether there are buy and hold requirements, and/or the like. Once it is determined if and what additional constraints exist, it should be determined 4251 whether the preliminary book income results calculated 4240 contravene these constraints 4250. If the preliminary book income results compiled 4240 do contravene, the preliminarily rebalanced BII may be modified to resolve any conflicts 4252 with these constraints 4250. The steps involved in this modification are discussed in greater detail below. Once the index has been modified 4252, it may be finalized 4260. If the preliminary book income results compiled 4240 do not contravene, the BII is finalized 4260.

At this point, statistics may be calculated and/or compiled 4270 for the BII. If performance monitoring is complete, a negative response to query 4280 will lead to the end of this process. If performance monitoring is to continue, a positive response will lead back to FIG. 18A.

### EXAMPLE 3

### Seventh Month—Exogenous Outflow Greater Than Endogenous Outflow, No Exogenous Inflow

Looking ahead to the seventh month of this hypothetical example, the index begins the monitoring period comprised of twelve purchase lots. In addition, on the rebalancing date, Jul. 31, 2004, an exogenous outflow is removed from the value of the index that is larger than the value of endogenous outflows calculated for the index during this monitoring period.

The BII on Jun. 30, 2004 has a value of $113,531,736, consisting of the sum of values of twelve lots that comprise the index. On Jul. 31, 2004, the value of the index may be calculated, using the base-line index for reference. During July, the book value prior to removal of endogenous cash flow of the index rose to $113,904,280. The endogenous outflows are calculated with a total value of $2,631,563.

In July, the portfolio experiences a $12,000,000 withdrawal. A $12,000,000 exogenous outflow, reflecting this withdrawal, may then be removed from the BII. July's exogenous outflow ($12,000,000) cannot be covered by the endogenous outflows generated in the same month ($2,631,563). In this example it is preferable to use the value of the endogenous outflows in addition to the value of the index purchase lots to cover the exogenous outflow. So, in this example, the total value of endogenous outflow, $2,631,563, will be removed from the index. This value will be part of the value of exogenous outflows removed from the index in July. The net exogenous outflow may then be calculated, reducing its $12,000,000 value by the $2,631,563 value of endogenous outflow, resulting in a value of $9,368,437. This net exogenous outflow may then be removed from the BII to cover what the endogenous outflows of the index could not. In this example, this value reflecting the net exogenous outflow value will be removed from each of the outstanding purchase lots in proportion to their relative current market values.

In this example, starting with the adjusted book value of the index before removal of endogenous cash flow of $113,904,280 and removing the value $2,631,563 of endogenous outflows leaves a value of $111,272,717 before removing any additional constituents to meet the remainder of the exogenous outflow.

Removing additional constituents from the index to cover net exogenous outflow may be accomplished by removing holdings of the index with a value sufficient to meet any remaining exogenous outflow not covered by the endogenous outflow. On the day these constituents are removed, which is Jul. 31, 2004 in this case, their market value may be realized.

The constituents to be removed to meet the net value of exogenous outflow have a market value of $9,368,437 and a total book value of $9,463,464. It is not necessary to remove the exact value equal to the value of an exogenous outflow, but to remove enough value from the index to meet the exogenous outflow.

The endogenous outflow value of $2,631,563 and market value of constituents removed $9,368,437 may be combined for a value of $12,000,000, which may be removed from the index as an exogenous outflow.

In order to have a composite BII constituent weighting that is roughly the same as the base-line index, additional constituents of the BII may be removed and new constituents added to bring its constituents in line with their proper weightings. In addition to the value removed to meet the exogenous outflow, additional constituents may be removed from the BII and their realized market value reinvested into the BII through new BII holdings. So, in order to provide the proper BII constituent weightings, constituents are removed from the BII with a market value of $1,662,935. This results in a decrease in the book value of the BII by $1,679,803. The market value of the removed constituents, $1,662,935, may be reinvested into the index at current market yields, relative weighting, prices, and/or the like on Jul. 31, 2004.

The market value of the constituents removed to meet the exogenous outflow is $9,368,437 and the market value of the constituents removed for rebalancing purposes is $1,662,935. The result is a total market value for the removed constituents of $11,031,372. The book value of the constituents removed to meet the exogenous outflow is $9,463,464 and the book value of the constituents removed for rebalancing is $1,679,803, for a total book value of removed constituents of $11,143,267.

The book value of these removed constituents is removed from the total book value of the index. The net book value of the index was calculated above as $111,272,717 and removing the book value of $11,143,267 leaves a book value of $100,129,450. This book value, along with the $1,662,935 value of additional constituents acquired by the index, is the total book value, $101,792,385, of the BII on Jul. 31, 2004, before the application of any additional constraints or subsequent rebalancings.

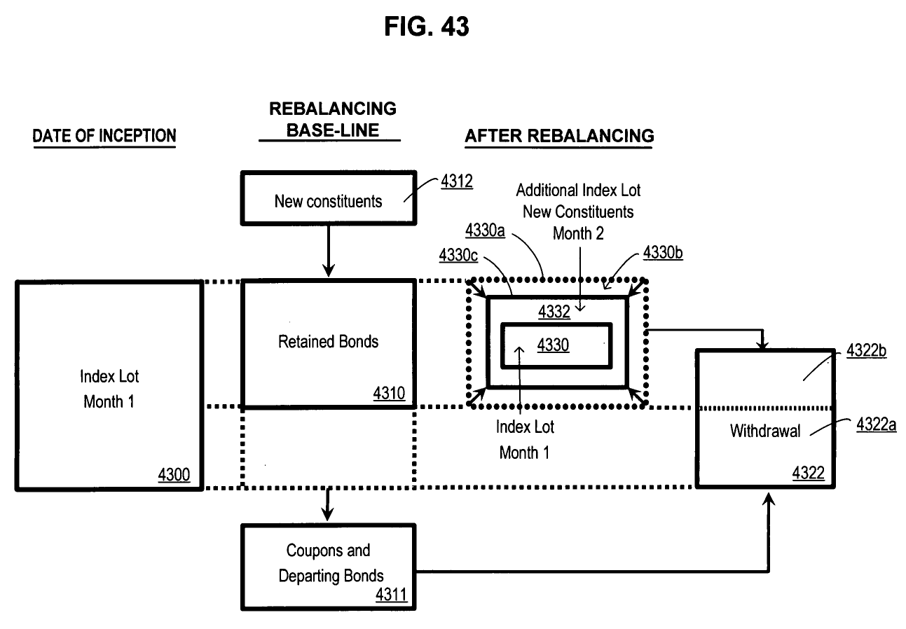

FIG. 43 provides an illustrative representation to assist with describing this example. This illustrates the rebalancing of endogenous outflows with an exogenous outflow. Although this figure involves a single index purchase lot at inception, it is understood that this may be equally applicable to an index with multiple index purchase lots, but is shown with a single index purchase lot for ease of example. For example, in the scenario outlined above, there are twelve index purchase lots; however, FIG. 43 depicts only a single purchase lot on the date of inception instead of the twelve index purchase lots at the start of the monitoring period as described in the scenario above. This is only for ease of explanation of the concept. This concept is equally applicable to the other eleven index purchase lots as described above or any number of index purchase lots as described herein.

The first BII lot 4300 is shown at the beginning of the monitoring period. At the end of the monitoring period, the first lot 4300 is rebalanced, retaining the bonds retained by the base-line index at rebalancing and releasing the bonds that have left the base-line index by the rebalancing date represented as a rebalanced lot 4310. The value of released constituents and coupon payments 4311 reflects the bonds that have left the BII and the interest payments made by the assets in the market corresponding to the BII constituents.

A withdrawal is removed from the portfolio. Therefore, an exogenous outflow of may be removed from the BII to reflect this withdrawal. The entire value of endogenous outflows 4311 may be removed from the index to cover the exogenous outflow 4322. This amount, however, is only a portion 4322a of the total exogenous outflow 4322 removed from the index. A pro-rata portion 4330b of the constituents that remain in the initial index purchase lot 4330a may be removed from the index reducing the value of the initial index purchase lot 4330c. The market value of the removed constituents may be used to cover the remainder of the exogenous outflow 4322b. The total value of exogenous outflow 4322 is comprised of the sum of the values generated from endogenous outflows 4322a and the market value of constituents removed from the index 4322b.

Removing of the value 4330b from the index purchase lot reduces the value of index purchase lot 4330a to 4330c. If this were the final result of the rebalancing, the BII constituent weightings would not likely match the TBII constituent weightings as required in this scenario. Thus, additional constituents of the index purchase lot must be removed, and their value used to acquire additional holdings for the index purchase lot in order to bring the BII constituents to their proper weightings. This removal of additional constituents may be a separate action from the removal of constituents and their corresponding value from the index purchase lot or constituents and their corresponding value may be removed from the index purchase lot to meet both the exogenous outflow and rebalancing requirements.

A portion of the index purchase lot 4330c may be removed and the market value of those removed constituents used to acquire additional holdings for the BII 4332 necessary to bring it in line with the TBII constituent weightings, acquired at market yields, prices, and/or the like on the date of acquisition. The resultant composite BII constituent weightings should now be in line with the constituent weighting of the TBII.

After rebalancing, this BII is comprised of two index purchase lots: the retained constituents from the first index lot 4330 and the newly acquired constituents comprising the second index lot 4332.

If the index were comprised of twelve index purchase lots on Jul. 1, 2004, as described above, there would be additional index purchase lots before and after rebalancing, each acting in a similar fashion as that illustrated in FIG. 43 and adding to the value of exogenous outflow and/or a newly added index purchase lot.

FIGS. 18A, 18D, 44A, and 44B provide yet another representation to assist with describing this scenario in the hypothetical example. Referring to the logic flow diagram of FIG. 18A, at this point (“A”) in the scenario performance monitoring has already commenced and determinations 1800 have been made and the BII has been created 1801.

In this scenario, cash flow is reinvested into the BII to bring the constituent weightings of the BII in line with the base-line TBII. This will result in a negative response to the query 1810 of whether to invest all cash flow in the full base-line index, which leads to FIG. 18B, and a negative response to query 1820 of whether to reinvest endogenous cash flow in newly added constituents to the base-line index and invest exogenous cash flow in the full base-line index, which leads to FIG. 18C. This leads to the question 1830 of whether to invest to replicate the TBII scaled to the initial portfolio value and subsequent cash flow. Because this is applicable in this scenario, FIG. 18A leads to FIG. 18D.

If this were not the case, a negative response would lead to query 1840 where it is decided whether to reinvest cash flow based on some other preferred criteria. If it is decided to reinvest based on other criteria, a reinvestment strategy and procedures may be established 1841. This reinvestment strategy and the procedures it entails may be established in line with performance measurement needs and/or preferences and may be constructed according to a variety of possible constructions and procedures based on the disclosure herein.

FIG. 18D provides a map for determining which logic flow diagram may be applicable regarding BII cash flows where, at rebalancing, the BII is brought in line with the constituent weightings of the TBII. In this scenario, there is no exogenous inflow. So, the answer to query 1831 of whether there is exogenous cash inflow is negative leading to query 1832 of whether there is exogenous cash flow out. In this example, there is an exogenous cash flow out, which leads to FIG. 44A.

Because an index may be rebalanced according to any number of rebalancing preferences and involve a number of circumstances, variables, inputs, and/or the like, this routine may be modified to assist with providing the proper logic flow diagram applicable to the set of circumstances, variables, inputs and/or the like for resolution.

FIGS. 44A and 44B provide an illustrative representation for rebalancing the BII to reflect the total TBII market weighting where the combined value of BII endogenous outflows and BII exogenous inflows does not provide sufficient value to accommodate this rebalancing. In this scenario, during the reinvestment and rebalancing determinations 1800, it was decided that, in order to meet the value of the shortfall between the value necessary to complete the BII rebalancing in line with the strategy and the applicable combined value of endogenous and exogenous cash flow, BII holdings would be removed and their value used for the rebalancing. FIGS. 44A and 44B represent a situation where the rebalancing process with an exogenous cash flow out that is greater than the value of endogenous outflow.

On the rebalancing date of Jul. 31, 2004, the base-line index is examined to determine 4400 what changes have occurred since Jun. 30, 2004. This determination 4400 may involve what bonds left the base-line index, what bonds entered the base-line index, the prices, yields, values, and/or the like of bonds in the base-line index. This determination may also involve what the current constituent weightings are of holdings of the entire TBII including new holdings that have entered the TBII during the performance monitoring period.

Once the base-line index has been examined 4400 and the changes within it determined, the BII is examined. Using the updated data from the base-line index, the value of endogenous outflows for the BII since Jun. 30, 2004 may be determined 4410. Here, it is determined that the book value of the BII, prior to removal of endogenous cash flow, has increased to $113,904,280 and the total value of endogenous outflows generated in the BII is $2,631,563.

Data may be acquired 4420 regarding any data necessary for the BII. For example, in this case, the portfolio may be examined and through this examination it may be discovered that there was a portfolio withdrawal in the amount of $12,000,000. It may be that there is no data acquired here. In this example, the value of exogenous outflow is determined 4421, based on the information acquired 4420 from the portfolio, to be $12,000,000.

The value of exogenous outflows for the BII, $12,000,000, determined 4421 is greater than the value of endogenous outflows for the BII, $2,631,563, determined 4410. According to the reinvestment and rebalancing strategy determined 1800, holdings of the BII should be removed and the value of the removed constituents reinvested into the BII through the acquisition of constituents that will allow the BII constituency weighting to roughly match that of the TBII.

If BII holdings are to be removed, it should be determined which to remove 4423. This determination 4423 entails deciding which BII holdings should be removed for the rebalancing of the BII to reflect the total TBII market weights on the rebalancing date while accounting for any BII cash flow. The value of the removed constituents should be at least enough to cover the shortfall left after accounting for the value of BII cash flows. To meet this value, BII holdings will be removed on whatever basis is preferred for the BIIS, which may be in line with the performance measurement needs and/or outlined as part of the reinvestment and rebalancing strategy 1800. For example, holdings may be removed that meet certain criteria or holdings may be removed on a pro-rata basis to meet the value of the shortfall. In this example, holdings are removed on a pro-rata basis from all existing index purchase lots.

The BII may be preliminarily rebalanced 4430. This rebalancing 4430 may involve the removal of constituents 4430a of the BII as determined above 4423 with a value roughly equal to that of the BII exogenous outflow minus the BII endogenous outflow. As discussed above, the BII endogenous outflow may be used to fund the exogenous outflow and, so, in this case, the deficiency may be funded by a removal or sale of BII holdings.

This rebalancing 4430 may also involve the removal of BII holdings 4430b according to the preferences of the BIIS as determined 1800 and 4426 and the addition of constituents to the BII with a total value roughly equal to the value of removed BII holdings. In other words, the value resulting from the removed constituents may be used to acquire constituents for the BII with a total value of acquired constituents roughly equal to the value of removed constituents. It may be that the market value of the removed constituents is realized and this market value may be used to acquire new BII holdings. These added constituents to the BII 4430b are used to adjust the BII constituent weighting. These constituents may reflect new holdings that have entered the TBII since, in this case, Jun. 30, 2004 and acquired at market yields, weights, prices, and/or the like, which is inline with the performance measurement preferences and the reinvestment and rebalancing strategy 1800. The removal of existing BII holdings and acquisition of new BII holdings 4430 may bring the composite BII constituent weighting roughly in line with the TBII constituent weighting.

The value of BII endogenous outflows was determined 4410 to be $2,631,563. The total book value removed from the BII to meet the exogenous outflow and rebalancing needs was $11,143,267. This is the value of BII holdings removed. The corresponding market value of these removed holdings is $11,031,372. The sum of the value of endogenous outflows, $2,631,563, and market value of removed constituents, $11,031,372, is $13,662,935. From this, the $12,000,000 exogenous outflow may be withdrawn, leaving $1,662,935, which was reinvested into the BII through the acquisition of new BII holdings in line with the reinvestment and rebalancing strategy 1800.

After rebalancing 4430 the total value of the BII is $101,792,385, comprised of 13 index purchase lots, including the newly created index purchase lot (Base-New July 2004) with a value of $1,662,935.

Preliminary book income results may then be compiled and/or calculated 4440. The existence and application of additional constraints may now be determined 4450, such as whether to impose gain/loss limits, whether there are buy and hold requirements, and/or the like. Once it is determined if and what additional constraints exist, it should be determined 4451 whether the preliminary book income results calculated 4440 contravene these constraints 4450. If the preliminary book income results compiled 4440 do contravene, the preliminarily rebalanced BII may be modified to resolve any conflicts 4452 with these constraints 4450. The steps involved in this modification are discussed in greater detail below. Once the index has been modified 4452, it may be finalized 4460. If the preliminary book income results compiled 4440 do not contravene, the BII is finalized 4460.

At this point, statistics may be calculated and/or compiled 4470 for the BII. If performance monitoring is complete, a negative response to query 4480 will lead to the end of this process. If performance monitoring is to continue, a positive response will lead back to FIG. 18A.

Each monthly rebalancing involving an exogenous outflow that is greater than the endogenous outflow generated by an index or index purchase lot may occur in a very similar fashion.

Comparing Various BIIS Rebalancing Strategies

The system disclosed herein provides flexibility and more accurate performance measurement than a standard index. As discussed herein, there are a great number of variables to consider in performance measurement in a BIIS and a user of a BIIS has a variety of options available when establishing and using a BIIS, including performance measurement preferences, reinvestment strategies, rebalancing methodologies, performance monitoring needs, and/or the like.

The result of such flexibility is that the BIIS has a broad variety of useful applications. Another result is that one BIIS may be configured quite differently from another and produce significantly different results, while nevertheless functioning in a very similar manner. For example, three reinvestment and rebalancing strategies were discussed above: investment of all cash flows in the full base-line index, reinvestment of endogenous cash flow in the new base-line index constituents, investment of exogenous cash flow in the full base-line index, and reinvestment of cash flows to replicate the base-line index. Each strategy was applied to roughly the same scenario, involving an inception value of $100,000,000 and a series of exogenous inflows and/or outflows. As each scenario played out in accordance with the applicable reinvestment strategy, the results of each rebalancing differed from the results of rebalancings using other reinvestment strategies.

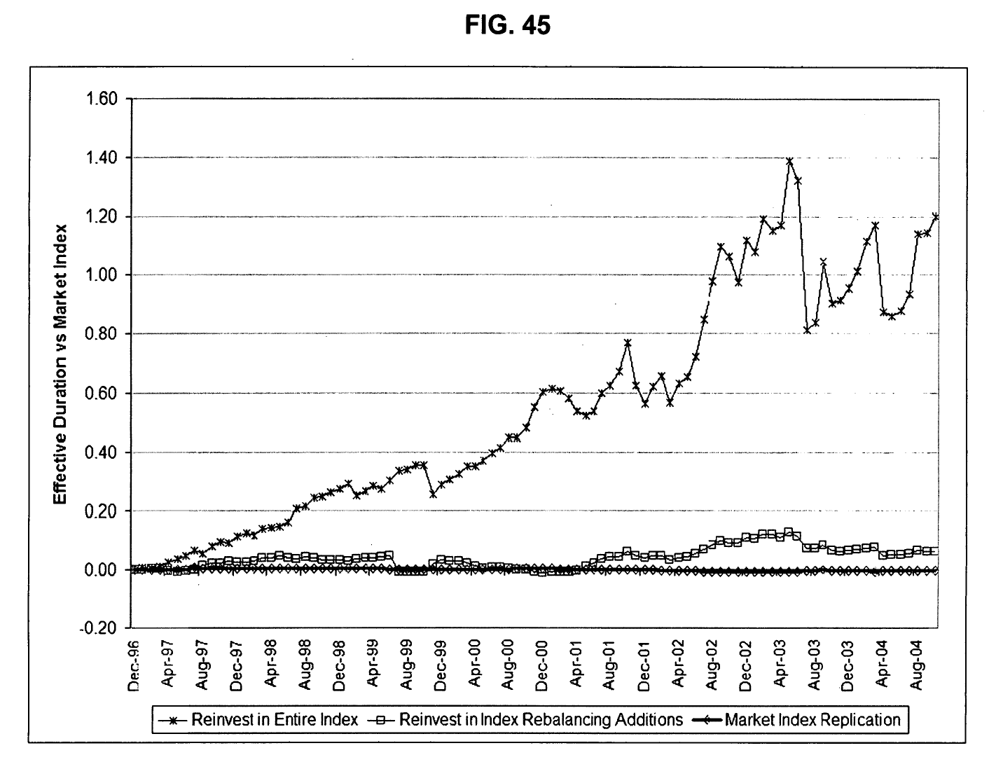

FIG. 45 provides a graph illustrating how three book income indices practiced in accordance with the disclosure herein may evolve over time with respect to a common base-line index. The three book income indices shown in this graph represent indices practicing the three reinvestment strategies discussed above: investment of all cash flow in the full base-line index, reinvestment of endogenous cash flow in the new base-line index constituents and investment of exogenous cash flow in the full base-line index, and reinvestment to replicate the base-line index. This graph represents the effective duration drift of the three book income indices over time, illustrating how the duration of each index based on its own reinvestment strategy drifts from the duration of the base-line index. Although FIG. 45 depicts only one measure, duration drift of each book income index from the base-line index, and involves a variation in only one variable of a BII, the reinvestment strategy, it illustrates how a BII may vary depending upon the determinations and decisions made in establishing and using a BIIS. It also shows how differently two indices can perform, while functioning within the spirit of the system disclosed herein.

The legend at the bottom of FIG. 45 describes the three reinvestment strategies, investing all cash flow in the full base-line index, reinvesting endogenous cash flow in the new additions to the base-line index and exogenous cash flow in the full base-line index, and replicating the base-line index, and provides the corresponding symbol for each index for use in referencing the index in the graph above. The graph in FIG. 45 highlights a few key differences in the underlying reinvestment methodologies of each index. For example, as is indicated by each of the three lines, alternative reinvestment strategies may produce notably different book income indices and BII results as shown by the duration drift of the index reinvesting in the full index at rebalancing as compared to the base-line index versus the minimal duration drift of the index replicating the base-line index at rebalancing as compared to the base-line index. It is likely that these indices will continue to deviate from one another as performance monitoring continues. The index replicating the base-line index at rebalancing remained relatively stable, experiencing very little effective duration drift, of course, as it was rebalanced each month to reflect the constituent weightings of the base-line index. There are benefits to a system closely reflecting the base-line, as well as a system providing alternative rebalancing methodologies. Which methodology to apply depends upon the desired characteristics of a BII and/or the performance monitoring preferences and/or needs.

Applying Gain/Loss Recognition Constraints

As discussed above, additional constraints may be applied to a BII providing additional customization and flexibility. Additional constraints may address particular concerns and/or preferences for performance measurement. It may be that these concerns and/or preferences are more appropriately addressed after rebalancing or that the rebalancing process does not provide the ability to properly account for such concerns and/or preferences. Although the application of additional constraints to a BII has been discussed as a single action, it may very well involve a series of actions. There may also be more than one constraint applied. The application of a number of additional constraints to a BIIS is possible and may be preferred to address a variety of performance measurement concerns and/or preferences.

The application of a gain/loss recognition constraint is indicative of the application of an additional constraint within a BIIS. Before factoring in an additional constraint, an index may first go through its normal rebalancing cycle, taking account of: (1) constituents that exit the base-line index, (2) endogenous outflows, (3) exogenous inflows and/or outflows, and, possibly, (4) additional sales required to match the composition of the base-line index, depending upon the rebalancing methodology selected.

Similarly, after taking of such BII considerations, additional steps may be taken with the book income indices to accommodate for a gain/loss recognition constraint. Capital gains and/or losses generated by rebalancing a BII may be determined and/or calculated. The aggregate result of compiling the gains and/or losses may then be compared to any minimum and/or maximum capital gain/loss constraints established for the BII. If the net result is within the allowed range specified then the rebalancing is complete, unless there are additional constraints to apply. If the net capital gain or loss is not within the specified range, the difference may be resolved through the removal of additional BII constituents, producing offsetting gains and/or losses, or through the reversal of the preliminary rebalancing removal of certain constituents.

In one embodiment of the system, a net capital gain or loss that is not within the specified range may be resolved by removing BII constituents that provide the proper offsetting gain or loss to bring the net capital gain or loss of the BII within the specified range. The rebalanced BII holdings may be grouped according to those with unrealized gains and those with unrealized losses. Once these are defined, it may be determined which BII holdings are to be removed. Holdings may be removed on a variety of bases and involve a variety of considerations. For example, criteria may be established for the removal of holdings from a BII or holdings may be removed simply on a pro-rata basis. BII holdings may be removed in accordance with any of these applicable considerations and/or preferences in order to resolve a discrepancy between the net capital gain or loss and a gain/loss constraint. The BII holdings removed in accordance with a gain/loss constraint may then have their respective gain or loss realized by the BII.

For example, if the net capital gain is greater than the preferred recognized capital gain for the index for a rebalancing, then the BII could recognize greater losses as a way to counteract the gains and bring the net capital gain in line with the applicable gain/loss constraint. By grouping the BII holdings according to unrealized gains and unrealized losses, in this case, a pro-rata share of BII holdings with unrealized losses may be removed from the BII and the associated losses may be realized by the BII, the result of which should bring the BII capital gain within the specified capital gain limit. Conversely, if additional gains must be realized by a BII, then a share of holdings with unrealized gains may be sold and the unrealized gains of those sold holdings realized by the BII.

If maintaining the proper index structure is a preference or requirement for the BII, the value of the constituents removed from the BII may be used to reacquire the constituents removed at current market yields, prices, values, and/or the like. This would allow the necessary recognition of capital gain or loss, while maintaining the proper structure and BII constituent weighting. For example, if the rebalancing produced a net capital loss that was $100,000 over the allowed limit, and if the gross unrealized gains in the portfolio totaled $1,000,000, then one-tenth of every holding with a gain would be liquidated and the value of the liquidated holdings may be used to reacquire the liquidated holdings at current market yields.

There are other ways of bringing a BII net gain or loss within the proper established gain/loss range. For example, if a rebalanced BII has a net gain or loss that is not within a previously established range, the rebalancing may be “unraveled.” If possible, the rebalancing of the BII may be undone and rebalanced again in accordance of the established gain/loss constraint.

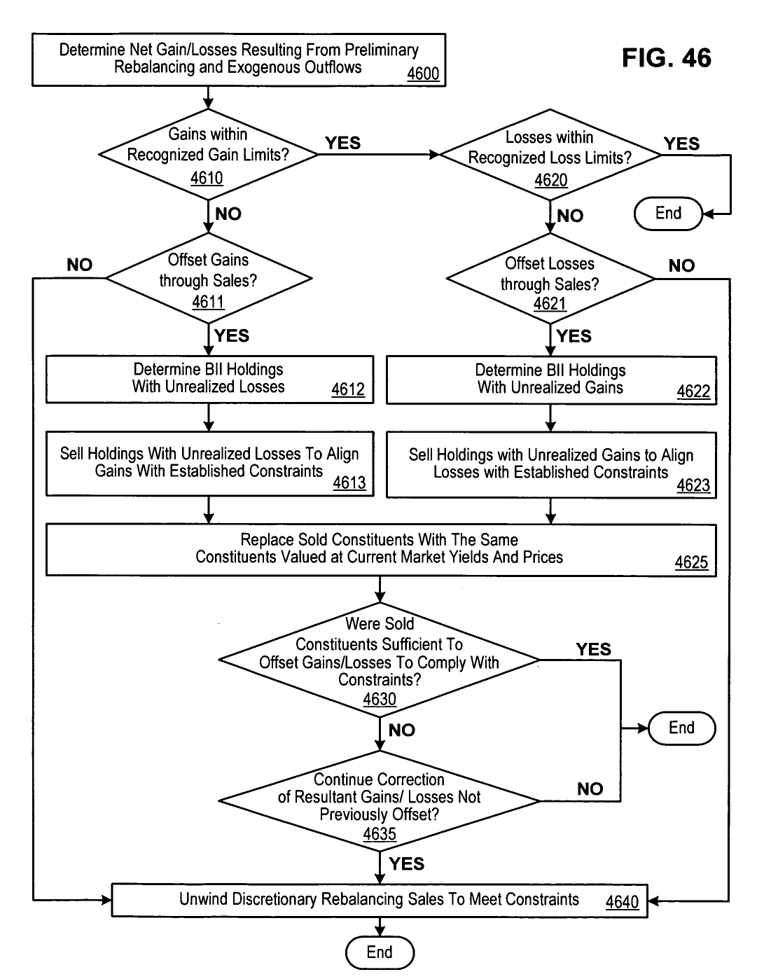

FIG. 46 provides an illustrative representation of the application of a gain/loss recognition constraint. This figure provides a sample procedure for the application of such a constraint. In this example, a BII has been established and preliminarily rebalanced. Determinations and preferences for the BII and performance monitoring have been established for implementation of the BII. Once a BII has been rebalanced, the preliminary book income results may be compiled. The net gains or losses resulting from the preliminarily rebalanced BII and any exogenous outflows that the BII experienced in the relevant period of time may be determined 4600.

If the gains are within the recognized gain limits 4610 and the losses are within the recognized loss limits 4620, the application of a gain/loss constraint may not be necessary. A gain/loss constraint may still be applied to a BII, but, in this case, where the gains or losses are within the proper limits, there is no need to take further steps in the application of an additional gain/loss constraint.

If the gains are not within the recognized gain limits 4610, a decision of whether to bolster, offset, or otherwise amend the gains through the sale of BII holdings 4611 may be made. If it is determined 4611 that additional sales will not be used to amend the out of range gains, certain steps of the preliminary rebalancing may be undone to bring the BII in line with the applicable gain/loss constraints. Certain sales of BII holdings during the preliminary rebalancing may be unwound 4640. This involves the selective reversal of the preliminary rebalancing removals in an attempt to produce a resultant final rebalancing with gains within the recognized gain limits.

For example, the constituents removed from the BII during the preliminary rebalancing may be examined to determine those that should remain in the BII in order to meet the needs of the rebalancing and produce gains or losses within the established limits. Where the gains of a preliminarily rebalanced BII are not within the recognized gain limits, certain steps involving the removal of BII holdings during the rebalancing, along with any additional related steps and/or information including recognized values of the removed holdings with the BII, may be undone and the BII holdings and related steps and/or information may be left in the state they would have been if not for the rebalancing. Additionally, other BII holdings may be removed in accordance with the rebalancing requirements and/or the established gain/loss limitations. A wide variety of methodologies may be employed to define the steps taken to unwind preliminary rebalancing removals in order to meet a gain/loss constraint.

If it is determined 4611 that additional sales will be used to bolster, offset, or otherwise amend the out-of-range gains, it should be determined what BII holdings should be removed. This may be practiced in a variety of ways. Here, the BII holdings with unrealized losses are determined 4612 and a portion, or all, of those holdings are sold in an attempt to align the resultant gains of the BII with the applicable established gain constraints 4613. This sale of BII holdings may involve the removal of constituents from the BII, the value of the constituents from the value of the BII, and any other characteristics affecting the BII relating to the removed BII holdings. These constituents may be removed from the BII through a variety of methodologies. For example, once the BII holdings with unrealized losses are determined, they may be removed on a pro-rata basis, removed based on certain characteristics, removed to meet some performance measurement needs and/or preferences, and/or the like.

Once the BII holdings with unrealized losses are removed from the BII 4613, the value of the removed constituents may be used to reacquire the same constituents 4625 at the current market yields, values, prices, and/or the like. This should approximately maintain the proper constituent weighting within the BII and allow the BII to realize sufficient losses to bring its net gain within the established limits. This may be analogized as buying and selling a portfolio constituent in one day, which would result in the realization of the constituents current market yields, prices, values, and/or the like and the likely generation of a gain or loss on that day.

If the removed constituents and realized losses for the BII 4613 were sufficient to bring the resultant net BII gains in line with the applicable gain/loss constraints 4630, this process of applying a gain/loss constraint may be complete. In other words, if the steps taken have created a BII with a net gain that is within the applicable gain/loss constraint, then no more steps need to be taken order to comply with the applicable constraint.

If, however, the removed constituents and realized losses for the BII 4613 were not sufficient to bring the resultant net BII gains in line with the applicable gain/loss constraints 4630, then it should be determined if more should be done. This situation would arise where, after realizing all unrealized losses by the BII or at least realizing all desirable unrealized losses by the BII, the net BII gains are still not within the established gain limits. At this point, it must be determined 4635 whether to continue the attempt of bringing the net BII gains within the established gain limits where the steps before were insufficient to properly bolster, offset, or otherwise amend the gains generated during the rebalancing. If further action is not to be taken, no further steps need to be taken in trying to comply with this constraint.

If further action is to be taken to correct the resultant net BII gain and bring it within the established gain limits, steps may be taken to unwind preliminary rebalancing steps to bring the BII within the applicable constraints 4640. As discussed above, this may involve the selective reversal of preliminary rebalancing removals in an attempt to produce a resultant final rebalancing with gains within the recognized gain limits. Where the gains of a rebalanced BII, after removing BII holdings with unrealized losses and recognizing the unrealized losses by the BII 4613, are still not within the recognized gain limits, certain steps of the preliminary rebalancing may be undone and the BII holdings and related steps and/or information may be left in the state they would have been if not for the rebalancing. Additionally, other BII holdings may be removed in accordance with the rebalancing requirements and/or the established gain/loss limitations. Once the BII meets the applicable gain/loss constraint, no further steps need to be taken in trying to comply with this constraint.

If the gains are within the recognized gain limits 4610, but the losses are not within the recognized loss limits 4620, a decision of whether to bolster, offset, or otherwise amend the gains through the sale of BII holdings 4621 may be made. If it is determined 4621 that additional sales will not be used to amend the out of range gains or losses, certain sales of BII holdings caused by the preliminary rebalancing may be unwound 4640. This involves the discretionary modification of the preliminary rebalancing in an attempt to produce a resultant preliminary rebalancing with losses within the recognized loss limits.

For example, the constituents removed from the BII during the preliminary rebalancing may be examined to determine those that should remain in order to meet the needs of the rebalancing and produce gains or losses within the established limitations. Where the losses of a preliminarily rebalanced BII are not within the recognized loss limits, certain steps involving the removal of BII holdings during the rebalancing, along with any additional related steps and/or information including recognized values of the removed holdings with the BII, may be undone and the BII holdings and related steps and/or information may be left in the state they would have been if not for the rebalancing. Additionally, other BII holdings may be removed in accordance with the rebalancing requirements and/or the established gain/loss limitations. A wide variety of methodologies may be employed to define the steps taken to unwind preliminary rebalancing removals in order to meet a gain/loss constraint.

If it is determined 4621 that additional sales will be used to bolster, offset, or otherwise amend the out-of-range losses, it should be determined what BII holdings should be removed. This may be practiced in a variety of ways. Here, the BII holdings with unrealized gains are determined 4622 and a portion, or all, of these holdings are sold in an attempt to align the resultant losses of the BII with the applicable established loss constraints 4623. This sale of BII holdings may involve the removal of constituents from the BII, the value of the constituents from the value of the BII, and a modification of any other characteristics affecting the BII relating to the removed BII holding.

Once the BII holdings with unrealized gains are removed from the BII 4623, the value of the removed constituents may be used to reacquire the same constituents 4625 at the current market yields, values, prices, and/or the like. This should approximately maintain the proper constituent weighting within the BII and allow the BII to realize sufficient gains to bring its net loss within the established limits.

If the removed constituents and realized gains for the BII 4623 were sufficient to bring the resultant net BII losses in line with the applicable gain/loss constraints 4630, this process of applying a gain/loss constraint may be complete. In other words, if the steps taken have created a BII with a net loss that is within the applicable gain/loss constraint, then no more steps need to be taken order to comply with the applicable constraint.

If, however, the removed constituents and realized gains for the BII 4623 were not sufficient to bring the resultant net BII losses in line with the applicable gain/loss constraints 4630, then it should be determined 4635 whether further steps should be taken to bring the net BII losses within the applicable established loss limits where the steps before were insufficient to properly amend the losses generated during the rebalancing. If further action is not to be taken, no further steps need to be taken in trying to comply with this constraint.

If further action is to be taken to correct the resultant net BII loss and bring it within the established loss limits, steps may be taken to unwind preliminary rebalancing steps to bring the BII within the applicable constraints 4640. As discussed above, this may involve the selective reversal of preliminary rebalancing removals in an attempt to produce a resultant final rebalancing with losses within the recognized loss limits. Where the losses of a rebalanced BII, after removing BII holdings with unrealized gains and recognizing the unrealized gains by the BII 4623, are still not within the recognized loss limits, certain steps of the preliminary rebalancing may be undone and the BII holdings and related steps and/or information may be left in the state they would have been if not for the rebalancing. Additionally, other BII holdings may be removed in accordance with the rebalancing requirements and/or the established gain/loss limitations. Once the BII meets the applicable gain/loss constraint, no further steps need to be taken in trying to comply with this constraint.

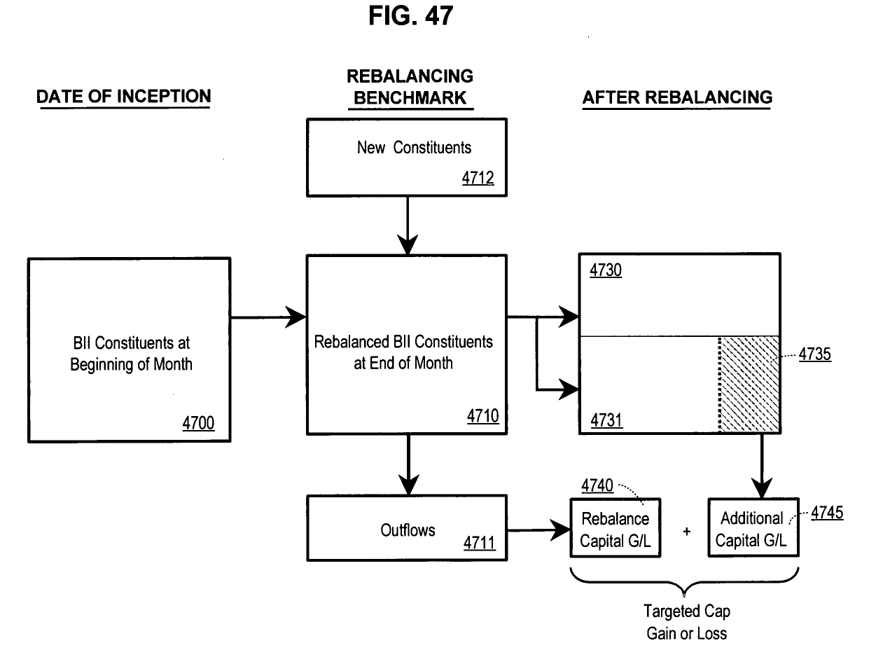

FIG. 47 provides an illustrative representation to assist with describing this example. This illustrates the rebalancing of a BII with the application of a gain/loss recognition constraint. Although this figure involves a single index purchase lot at inception, it is understood that this may be equally applicable to an index with multiple index purchase lots, but is shown with a single index purchase lot for ease of example. The block diagrams is incorporated and discussed herein are not drawn to scale and are not intended to depict actual values or physical actions, but are used as an illustrative tool to assist with understanding the system.

The initial BII holdings 4700 are shown on its inception date. On the rebalancing date, these holdings 4700 are rebalanced to reflect the updated status of the base-line index, retaining the constituents retained by the base-line index at rebalancing, releasing the constituents that have left the base-line index by the rebalancing date, and adding the new constituents that have entered the base-line index subsequent to the previous rebalancing. This rebalancing may involve outflows of value 4711, resulting from coupon payments on the bonds in the BII, the removal of BII constituents to match the composition of the base-line index, the removal of BII constituents to meet an exogenous outflow, and/or the like. This rebalancing may entail the incorporation of new BII constituents 4712, acquired with the endogenous outflows and exogenous inflows minus any exogenous outflows based on whatever established criteria exists concerning the acquisition of new constituents to the BII. Each of these rebalancing changes may be reflected in the updated BII holdings 4710 through a change in the BII constituents, values, yields, prices, and/or the like.

As constituents are removed from the BII, they may generate a recognized capital gain or a loss for the BII 4740 equal to the difference between their market value and book value on the date of removal. These capital gains/losses from rebalancing the BII may be similar to how a portfolio might reflect the sale of a portfolio constituent.

If the capital gain/loss 4740 generated by rebalancing the BII is within the established recognized gain/loss limitations, no further action is required concerning the corresponding gain/loss constraint. If the BII capital gain/loss 4740 from rebalancing does not meet the established gain/loss constraint, further action may be taken to bring the capital gain/loss of the BII in line with the gain/loss constraint.

This situation may be rectified through a number of procedures. For example, as discussed above, discretionary rebalancing steps may be undone to meet the constraint if possible. It may be necessary to decide which is more important, meeting the additional constraint or meeting other requirements of the rebalancing, including the recognition of exogenous cash flows, replication of the base-line index, and/or the like. This situation may also be rectified, for example, by removing additional BII holdings to bolster, offset, or otherwise amend the overall BII capital gain/loss value in an attempt to bring it in line with the gain/loss constraint.

As described above, in one embodiment, BII holdings with the necessary unrealized gains or losses may be removed and their gains or losses realized by the BII. This additional recognized gain or loss may in turn bring the overall BII capital gain/loss within the applicable constraints. For example, if further gains are necessary, because the gains generated by the BII rebalancing were insufficient or the losses generated by the BII rebalancing were beyond the recognized loss constraint, BII holdings with unrealized gains may be removed from the index, or sold, and their unrealized gains realized and incorporated into the overall BII capital gain/loss in an attempt to bring the BII capital gain/loss in line with the applicable gain/loss constraint. After realizing the unrealized gain, the value resulting from the removed, or sold, constituents may be used to buy the holdings back at current market values, prices, yields, and/or the like.

The preliminarily rebalanced BII holdings 4710 may be represented in two portions 4730 and 4731 according to holdings with unrealized gains and holdings with unrealized losses. It is feasible, of course for certain BII holdings to have zero unrealized gains or losses. However, holdings with zero unrealized gains or losses are not of concern here. If the objective of this procedure is to realize unrealized losses, then unrealized gains may be represented as 4730 and unrealized losses may be represented as 4731. If the objective of this procedure is to realize unrealized gains, then unrealized losses may be represented as 4730 and unrealized gains may be represented as 4731.

A portion 4735 of the holdings and their corresponding value of the BII with either unrealized gains or losses 4731, depending upon which will be useful in properly amending the recognized capital gain/loss for the BII, may be removed from the preliminary rebalanced BII. Where possible, it may be preferential to remove enough BII constituents with the proper unrealized gain or loss to generate sufficient BII recognized gains or losses to meet the applicable gain/loss recognition constraint. These removed constituents may be removed according to any set of procedures, including selling a pro-rata share 4735 of all constituents that can generate offsets 4731, i.e. all constituents with unrealized gains or all constituents with unrealized losses.

These removed constituents generate an additional capital gain or loss 4745 equal to the difference between their book values and market values on the date of removal.

Once the additional capital gain/loss value 4745 has been determined and/or calculated, this value may be used in conjunction with the capital gain/loss from the rebalancing 4740 in attempting to comply with the target capital gain or loss for the BII for this rebalancing as determined by the applicable gain/loss recognition constraint and produce a resultant BII capital gain or loss.

The value of the removed constituents from the BII may subsequently, after realizing the market values of the removed constituents, be reinvested into the BII or added to the BII. This value may be reinvested or added to the BII through the reacquisition of the same constituents removed at current market yields, prices, values, and/or the like or through a variety of methodologies.

If the applicable gain/loss constraints have not been meet, then additional constituents may be sold inline with this discussion or other steps may be taken.

### EXAMPLE 4

### Applying Gain/Loss Recognition Constraints

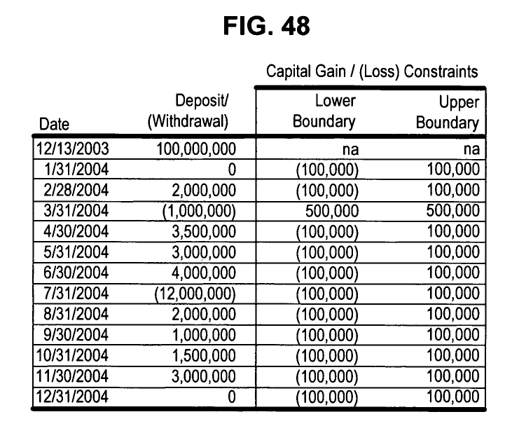

An example of a BII applying gain/loss recognition constraints may be useful in further illustrating these embodiments of the system. This example describes a hypothetical BII rebalancing monthly with previously designated capital gain and loss constraints. These constraints are shown in FIG. 48, which represents one example of a set of gain/loss constraints, involving a one year performance monitoring period and specified upper and lower boundaries for BII recognized gains or losses for monthly rebalancings.

A number of hypothetical examples of book income indices with various rebalancing and reinvestment methodologies have been discussed. These hypothetical examples may be extended to include embodiments concerning capital gain/loss constraints. Here, the hypothetical scenario discussed above concerning the third example of reinvestment strategy: Automatic Reinvestment Replicating the Index Scaled to the Initial Portfolio Value and Subsequent Cash Flows may be used in addition to the capital gain/loss constraints outlined in FIG. 48 to provide an illustrative hypothetical example of the implementation of recognized gain/loss constraints in a BII. At rebalancing, this embodiment of the BII uses the value of net BII cash flows to replicate the base-line index.

The BII in this example is created on Dec. 31, 2003 with a value of $100,000,000 comprised of the entire holdings of the base-line index. During January, the BII generates a 0.320% ordinary income return, which represents a value of $320,000 in calculated ordinary income for the BII for January. Turnover of BII holdings caused by the rebalancing on Jan. 31, 2004 in accordance with the rebalancing and reinvestment strategy produced an endogenous outflow value of $2,114,137 calculated for the BII based in part on the base-line index.

The value of capital gain calculated that would be generated by this outflow is $1,131 for a 0.001% capital gain return on the rebalancing. Rebalancing outflows leads to a reduced book value of the initial BII lot after rebalancing of $98,206,999.

According to the recognized gain/loss constraints outlined in FIG. 48, the small realized capital gain from the Jan. 31, 2004 rebalancing is within the established limitations. The capital gain/loss constraint, as outlined, provides a lower boundary, or capital loss constraint, of −$100,000. Thus, if the rebalanced BII generated a capital loss below the established threshold value of −$100,000 then additional steps may be taken to rectify this. The capital gain/loss constraint, as outlined, also provides an upper boundary, or capital gain constraint, of $100,000. If the rebalanced BII generated a capital gain greater than the established threshold value of $100,000 then additional steps may be taken to rectify this. The value of total capital gains generated by the Jan. 31, 2004 rebalancing is $1,131, which is well within the capital gain/loss constraint established.

The $2,114,137 value from endogenous outflows may then be invested in new constituents for incorporation into the BII at current market values, yields, prices, and/or the like on Jan. 31, 2004.

Thus, after the Jan. 31, 2004 rebalancing, the BII has a total value of $100.321,136, comprised of BII constituents acquired on Dec. 31, 2003 (Base December 2003) with a value of $98,206,999 and constituents acquired on Jan. 31, 2004 (Base January 2004) with a value of $2,114,137.

The BII in this example continues performance monitoring into a second month. The second month in this hypothetical example is similar to the first, except the BII begins the month comprised of constituents purchased on Dec. 31, 2003 (Base December 2003) and Jan. 31, 2004 (Base January 2004) and an exogenous inflow is added to the index at the end of the month.

The BII started February with a value of $100,321,136 and gained in value when calculated at the Feb. 29, 2004 rebalancing date. During February the BII generates a 0.295% ordinary income return, which represents a value of $295,847 in calculated ordinary income for the BII for February. This value is comprised of ordinary income generated from constituents purchased on Dec. 31, 2003 (Base December 2003) with a value of $289,907 and constituents purchased on Jan. 31, 2004 (Base January 2004) with a value of $5,936.

Calculations and/or determinations are provided herein for the Feb. 29, 2004 rebalancing example as an illustration of how constituents acquired at different dates may influence the application of an additional constraint, how the application of an additional constraint may influence constituents acquired on different dates, and to illustrate how the application of an additional constraint may be further broken down within a BIIS.

Turnover of BII holdings caused by the rebalancing on Feb. 29, 2004 in accordance with the rebalancing and reinvestment strategy produced an endogenous outflow value of $2,938,323 calculated for the BII, which may be represented as an endogenous outflow value of $2,812,480 for the constituents purchased on Dec. 31, 2003 (Base December 2003) and an endogenous outflow value of $125,843 for the constituents purchased on Jan. 31, 2004 (Base January 2004).

The recognized capital gain calculated from such an outflow is $7,120 for a 0.007% capital gain return on the rebalancing. Rebalancing outflows leads to a reduced book value of the constituents purchased on Dec. 31, 2003 (Base December 2003) after rebalancing of $95,691,451 and to a reduced book value of the constituents purchased on Jan. 31, 2004 (Base January 2004) after rebalancing of $1,994,287.

According to the recognized gain/loss constraints outlined in FIG. 48, the small realized capital gain from the Feb. 29, 2004 rebalancing is within the established limitations. The capital gain/loss constraint, as outlined, provides a lower boundary, or capital loss constraint, of −$100,000 and an upper boundary, or capital gain constraint, of $100,000. If the rebalanced BII generated a capital gain or loss not within these boundaries or constraints, additional steps may be taken to rectify this. The value of total capital gains generated by the Feb. 29, 2004 rebalancing is $7,120, which is well within the capital gain/loss constraint established.

In February, an exogenous inflow of $2,000,000 is infused into the BII at the Feb. 29, 2004 rebalancing date. The value the exogenous inflow, $2,000,000, may be combined with the value of endogenous outflows, $2,938,323, for a total value of $4,938,323 to be invested into new constituents for incorporation into the BII at current market values, yields, prices, and/or the like on Feb. 29, 2004.

Thus, after the Feb. 29, 2004 rebalancing, the BII has a total value of $102,624,061, comprised of BII constituents acquired on Dec. 31, 2003 (Base December 2003) with a value of $95,691,451, constituents acquired on Jan. 31, 2004 (Base January 2004) with a value of $1,994,287, and constituents acquired on Feb. 29, 2004 (Base February 2004) with a value of $4,938,323.

The BII continues performance monitoring into a third month. The third month in this hypothetical example involves an exogenous outflow removed from the value of the index and the index began the month comprised of constituents purchased on Dec. 31, 2003 (Base December 2003), Jan. 31, 2004 (Base January 2004), Feb. 29, 2004 (Base February 2004).

The BII started March with a value of $102,624,061 and gained in value when calculated at the Mar. 31, 2004 rebalancing date. During March the BII generates a 0.325% ordinary income return, which represents a value of $333,118 in calculated ordinary income for the BII for March. This value is comprised of ordinary income generated from constituents purchased on Dec. 31, 2003 (Base December 2003) with a value of $312,433, constituents purchased on Jan. 31, 2004 (Base January 2004) with a value of $6,226, and constituents purchased on Feb. 29, 2004 (Base February 2004) with a value of $14,459.

Calculations and/or determinations are again provided herein for the Mar. 31, 2004 rebalancing for the BII as a whole and for BII holdings distinguished by purchase date for further illustration of how various embodiments of the system may be practiced.

Turnover of BII holdings caused by the rebalancing on Mar. 31, 2004 in accordance with the rebalancing and reinvestment strategy produced an endogenous outflow value of $3,980,458 calculated for the BII, which may be represented as an endogenous outflow value of $3,695,596 for the constituents purchased on Dec. 31, 2003 (Base December 2003), an endogenous outflow value of $66,280 for the constituents purchased on Jan. 31, 2004 (Base January 2004), and an endogenous outflow value of $218,582 for the constituents purchased on Feb. 29, 2004 (Base February 2004).

In March, an exogenous outflow of $1,000,000 is removed from the BII at the Mar. 31, 2004 rebalancing date. The exogenous outflow value may be removed from the BII through the use of the endogenous outflow values, by reducing the value of endogenous outflows, $3,980,458, by the value of exogenous outflow, $1,000,000. This results in a reduced value of $2,980,458 for reinvestment into the BII.

The capital gain calculated for the BII based on the endogenous outflow value from rebalancing in March is $39,175 for a 0.038% capital gain return on the rebalancing. The capital gain or loss realized by the BII may depend greatly upon methodology used in removing constituents.

This $39,175 value of recognized capital gain for the BII is not within the established recognized gain/loss constraints, as outlined in FIG. 48. According to the constraint, as outlined in FIG. 48, for the Mar. 31, 2004, the recognized capital gain for the BII must be $500,000 in order to meet the established gain/loss constraint on the index. The capital gain/loss constraint, as outlined, provides the same lower and upper boundaries for the BII recognized capital gain/loss, establishing a specific value which should be met in order to comply with this constraint.

Thus, in order to comply with the recognized gain/loss constraint, an additional capital gain in an amount of $460,825 must be recognized in the BII for the Mar. 31, 2004 rebalancing. To meet this additional recognized capital gain requirement, BII holdings with an unrealized gain may be sold. This sale may involve the removal of the holdings from the index, the market value of the removed holdings calculated and/or determined, and the unrealized gains of the removed holdings realized by the BII. This realized gain may then, in turn, be used in the calculation of BII capital gain/loss in a determination of whether the BII complies with the applicable gain/loss constraints.

In order to meet the value of $460,825 necessary for the BII to comply with the recognized gain/loss constraint for Mar. 31, 2004, additional BII holdings may be removed at the rebalancing date. These removed holdings should have a total unrealized gain of $460,825. In order to generate a capital gain value of $460,825 in this example, BII holdings with a calculated total value of $26,970,895 are removed. These removed holdings are comprised of holdings acquired on Dec. 31, 2003 (Base December 2003), Jan. 31, 2004 (Base January 2004), and Feb. 29, 2004 (Base February 2004). The value of the BII holdings removed from December (Base December 2003) is $25,269,381, from January (Base January 2004) is $536,441, and from February (Base February 2004) is $1,165,072. Exactly which BII holdings are removed and how they are removed is a matter of preference. For example, here a pro-rata share of BII holdings with unrealized gains may be sold in order to generate the necessary capital gain.

After the sale of additional BII holdings to comply with the gain/loss constraint, the value of the additional BII recognized capital gains is calculated to be $460,825. This value may be combined with the value of BII recognized gains from the preliminary rebalancing, $39,175, resulting in a total BII recognized capital gain value of $500,000, which is in line with the established recognized gain/loss constraint for the Mar. 31, 2004 rebalancing.

The value of the additional holdings removed, in addition to the value of endogenous outflow, may subsequently be reinvested into new constituents for incorporation into the BII at current market values, yields, prices, and/or the like on Mar. 31, 2004. Thus, the value of $2,980,458 resulting from the value of endogenous outflows and the value of $26,970,895 resulting from the sale of additional BII constituents may be combined for a total value of $29,951,353 for investment in new BII holdings on Mar. 31, 2004.

Rebalancing outflows lead to a reduced book value of the constituents purchased on Dec. 31, 2003 (Base December 2003) after rebalancing of $67,525,627, a reduced book value of the constituents purchased on Jan. 31, 2004 (Base January 2004) after rebalancing of $1,404,524, and a reduced book value of the constituents purchased on Feb. 29, 2004 (Base February 2004) after rebalancing of $3,575,630.

Thus, after the Mar. 31, 2004 rebalancing, the BII has a total value of $102,457,134, comprised of BII constituents acquired on Dec. 31, 2003 (Base December 2003) with a value of $67,525,627, constituents acquired on Jan. 31, 2004 (Base January 2004) with a value of $1,404,524, constituents acquired on Feb. 29, 2004 (Base February 2004) with a value of $3,575,630, and constituents acquired on Mar. 31, 2004 (Base March 2004) with a value of $29,951,353.

BII performance monitoring may continue on experiencing monthly rebalancings similar to those already discussed. Looking ahead to the seventh month of this hypothetical example, an exogenous outflow is removed from the value of the index that is larger than the value of endogenous outflows calculated for the index during this monitoring period on the Jul. 31, 2004 rebalancing date. Although previous rebalancings have been discussed in terms of distinguishing acquisition dates in addition to discussing the BII as a whole, calculations and/or determinations are discussed herein for the Jul. 31, 2004 rebalancing in terms of the BII as a whole without further distinguishing among the various acquisition dates of the holdings. No inference should be drawn regarding this.

The BII on Jun. 30, 2004 has a value of $113,975,954, consisting of the aggregate of values of all BII holdings, acquired at inception or at monthly rebalancings. This index may be rebalanced on Jul. 31, 2004, referencing the base-line index on that day. During July the BII generates a 0.340% ordinary income return, which represents a value of $386,948 in calculated ordinary income for the BII for July.

In July, an exogenous outflow value of $12,000,000 is removed from the BII, which is removed on the Jul. 31, 2004 rebalancing date. The value of endogenous outflows generated by the rebalancing of the index may be calculated and used to meet the exogenous outflow value. In addition, in order to meet this exogenous outflow value, BII holdings are removed and the composite of their value used to cover the exogenous outflow of value from the BII in addition to the application of endogenous outflow values removed to cover this exogenous outflow.

In order to meet such a large exogenous outflow, significant BII holdings were removed, generating a significant net realized loss for the BII. The recognized capital loss calculated for the BII after the rebalancing and removal of exogenous outflow is $176,741 for a 0.155% capital loss return on the rebalancing.

FIG. 48 outlines the boundaries of the recognized gain/loss constraints for the BII. According to these constraints for the Jul. 31, 2004 rebalancing, the recognized capital gain for the BII may be no greater than $100,000 or the loss not less than -$100,000 in order to comply with the established gain/loss constraint on the index. The value of the capital loss calculated is $176,741, which is not within the boundaries of the recognized gain/loss constraints.

Thus, in order to comply with the recognized gain/loss constraint, an additional capital gain must be realized by the BII for the Jul. 31, 2004 rebalancing with a value of $76,741. To meet this value, BII holdings with unrealized gains may be sold. This sale may involve the removal of the holdings from the index, the market value of the removed holdings calculated and/or determined, and the unrealized gains of the removed holdings realized by the BII. This realized gain may then, in turn, be used in the calculation of BII capital gain/loss in a determination of whether the BII complies with the applicable gain/loss constraints. These removed holdings should have a total unrealized gain of $76,741.

In order to generate a capital gain value of $76,741 in this example, BII holdings with a calculated total value of $10,519,541 are removed. Exactly which BII holdings are removed and how they are removed is a matter of preference and may impact the capital gain or loss results. For example, here a pro-rata share of all BII holdings with unrealized gains may be sold in order to generate the necessary capital gain.

After the sale of additional BII holdings to comply with the gain/loss constraint, the value of the additional BII recognized capital gains is calculated to be $76,741. This value may be combined with the value of BII recognized losses from the preliminary rebalancing, $176,741, resulting in a total BII recognized capital loss value of $100,000, which is in line with the established recognized gain/loss constraint for the Jul. 31, 2004 rebalancing.

The value of the additional holdings removed, in addition to value from endogenous outflows, may subsequently be reinvested into new constituents for incorporation into the BII at current market values, yields, prices, and/or the like on Jul. 31, 2004. Thus, the value of $1,202,942 resulting from the value of endogenous outflows and the value of $10,519,541 resulting from the sale of additional BII constituents may be combined for a total value of $11,722,483 for investment in new BII holdings on Jul. 31, 2004.

Thus, after the Jul. 31, 2004 rebalancing, the BII has a total value of $102,262,856, which is the value of the BII after rebalancing and the application of this gain/loss constraint. Additional constraints may be applied to the BII or the BII may continue into the next month with a starting value of $102,262,856 if the rebalancings and application of additional constraints are complete.

Performance monitoring may continue with subsequent rebalancings in accordance with applicable constraints. These few examples help to illustrate various embodiments of the system and were chosen for discussion as a means for representing various different aspects of the system.

It should be understood that the above description is only representative of illustrative embodiments. For the convenience of the reader, the above descriptions have focused on a representative sample of all possible embodiments, a sample that teaches the principles of the system. The description has not attempted to exhaustively enumerate all possible variations. That alternate embodiments may not have been presented for a specific portion of the system or that further undescribed alternate embodiments may be available for a portion is not to be considered a disclaimer of those alternate embodiments. It will be appreciated that many of those undescribed embodiments incorporate the same principles of the system and others are equivalent. Those skilled in the art will recognize that the method and apparatus of the present system has many applications, and that the present system is not limited to the representative examples disclosed herein. Thus, it is to be understood that the embodiments and variations shown and described herein are merely illustrative of the principles of this system and that various modifications and variations may be implemented without departing from the scope and spirit of the system.

What is claimed is:

1. A processor-implemented method to measure financial performance, comprising:
tracking the movement of bond values, both on a current market and book yield basis for the holdings of a specified benchmark index, over time;
tracking unrealized gains and losses of the specified benchmark index holdings;
rebalancing the specified benchmark index based on selection criteria and constraints, portfolio exogenous cash flows, and constraints on realized capital gains and losses; and
updating the specified benchmark index value based on rebalanced holdings and tracked movements in bond valuations.

2. A processor-implemented method to measure financial performance, comprising:
tracking the movement of values on a book income basis for specified holdings over time, the specified holdings comprising an index;
rebalancing the index to account for applicable cash flow in accordance with one or more performance measurement preferences; and
updating one or more values of the index to reflect said rebalancing.

3. The method of claim 2 further comprising:
tracking unrealized gains and losses of one ore more of the specified holdings; and
rebalancing the index in accordance with applicable constraints on realized gains and losses.

4. The method of claim 2 further comprising:
using the index as a benchmark to a portfolio of securities, wherein one or more index characteristics may be derived from one or more characteristics of the portfolio of securities.

5. The method of claim 4 wherein acquisition dates of one or more specified holdings are aligned with acquisition dates of one or more portfolio securities and initial book income values of said holdings are derived from corresponding market valuations on the aligned acquisition dates of the holdings.

6. The method of claim 4 wherein one or more of the applicable cash flows reflect a portfolio exogenous cash flow.

7. The method of claim 4 wherein one or more of said performance measurement preferences reflect one or more characteristics of the portfolio of securities.

8. The method of claim 2 further comprising:
applying one or more constraints to the index, wherein rebalancing the index is in accordance with one or more of the constraints.

9. The method of claim 2 further comprising:
applying one or more constraints to the index; and
modifying the index to correspond to the constraints.

10. The method of claim 9 wherein constraints may include recognized gain/loss limits.

11. The method of claim 9 wherein constraints may include buy and hold requirements.

12. The method of claim 2 wherein said rebalancing further comprises integrating one or more additional holdings into the index.

13. The method of claim 12 wherein said rebalancing further comprises incorporating a value reflecting one or more index endogenous outflows wherein the one or more additional holdings integrated into the index have an aggregate value corresponding to the value reflecting one or more index endogenous outflows.

14. The method of claim 12 wherein said rebalancing further comprises incorporating a value reflecting one or more index exogenous inflows wherein the one or more additional holdings integrated into the index have an aggregate value corresponding to the value reflecting one or more index exogenous inflows.

15. The method of claim 12 wherein said rebalancing further comprises incorporating a value reflecting one or more index endogenous outflows and one or more index exogenous inflows wherein the one or more additional holdings integrated into the index have an aggregate value corresponding to the value reflecting one or more index endogenous outflows and one or more index exogenous cash flows.

16. The method of claim 2 wherein said rebalancing further comprises a reduction in value reflecting one or more index exogenous outflows.

17. The method of claim 16 wherein said rebalancing further comprises removing one or more holdings from the index that no longer meet the performance measurement preferences for incorporation within the index wherein the one or more holdings removed from the index have an aggregate value corresponding to a value reflecting one or more index exogenous outflows.

18. The method of claim 16 wherein said rebalancing further comprises removing one or more holdings from the index that no longer meet the performance measurement preferences for incorporation within the index wherein the one or more holdings removed from the index have an aggregate value corresponding to a value reflecting the value of one or more index exogenous outflows reduced by the value of one or more index endogenous outflows.

19. The method of claim 2 further comprising:
compiling data concerning said index holdings and tracked movements of said values; and
generating performance measurements from the compiled data.

20. The method of claim 2 further comprising:
tracking a target index of holdings, wherein said rebalancing comprises rebalancing the index in an attempt to reflect characteristics of the target index at a point in time;
retaining one or more holdings in the index at the current market values of one or more corresponding securities from the point in time when such holdings are added to the index until removal of said holdings from the index.

21. The method of claim 20 wherein said rebalancing further comprises incorporating one or more additional holdings into the index at the current market values of one or more corresponding securities reflecting holdings recently added to the target index.

22. The method of claim 21 wherein said incorporated holdings have an aggregate value corresponding to one or more index endogenous outflows.

23. The method of claim 22 wherein said index endogenous outflows reflect corresponding endogenous outflows of the target index.

24. The method of claim 21 wherein said incorporated holdings have an aggregate value corresponding to one or more index exogenous cash flows resulting in an inflow of value.

25. The method of claim 21 wherein said incorporated holdings have an aggregate value corresponding to one or more index endogenous outflows and one or more index exogenous cash flows resulting in an inflow of value.

26. The method of claim 25 wherein said index exogenous cash flows reflect index exogenous inflows and index exogenous outflows.

27. The method of claim 21 wherein the additional holdings incorporated into the index reflect all holdings of the target index.

28. The method of claim 21 wherein the additional holdings incorporated into the index reflect recently acquired holdings of the target index.

29. The method of claim 21 wherein the additional holdings incorporated into the index are integrated in an attempt to modify the index to reflect the target index.

30. The method of claim 20 wherein said rebalancing further comprises removing one or more holdings and corresponding values from the index reflecting any holdings removed from the target index not previously reflected in the index.

31. The method of claim 30 wherein said holdings removed have an aggregate value corresponding to one or more index exogenous cash flows resulting in an outflow of value.

32. The method of claim 30 wherein said holdings removed have an aggregate value corresponding to one or more index endogenous outflows and one or more index exogenous cash flows resulting in an outflow of value.

33. The method of claim 32 wherein said index exogenous cash flows may reflect index exogenous inflows and index exogenous outflows.

34. The method of claim 32 wherein said index endogenous outflow values reflect corresponding endogenous outflows of the target index.

35. The method of claim 20 further comprising:
modifying the rebalanced index to reflect the target index in accordance with performance measurement preferences.

36. The method of claim 20 further comprising:
using the index as a benchmark to a portfolio of securities;
incorporating one or more additional holdings into the index during rebalancing with values that reflect the market values of one or more corresponding securities wherein the addition of holdings to the index reflects the target index and wherein the value of additional holdings reflects a value of one or more portfolio exogenous cash flows.

37. The method of claim 20 further comprising:
using said index as a benchmark to a portfolio of securities;
incorporating one or more additional holdings into the index during rebalancing with values that reflect the market values of one or more corresponding securities wherein the addition of holdings to the index reflects the target index and wherein the value of additional holdings reflects a value of one or more portfolio exogenous cash flows plus one or more endogenous outflows.

38. The method of claim 37 wherein said endogenous outflows reflect corresponding endogenous outflows of the target index.

39. The method of claim 37 wherein rebalancing the index to reflect the target index comprises incorporating one or more additional holdings into the index reflecting securities recently added to the target index.

40. The method of claim 2 further comprising:
tracking the movement of values on a current market basis for one or more specified holdings over time, said one or more specified holdings comprising an index.

41. The method of claim 20 further comprising:
modifying the rebalanced index to bring the index in line with additional constraints.

42. The method of claim 20 further comprising:
modifying the rebalanced index to reflect the target index in accordance with performance measurement preferences.

43. The method of claim 42 wherein said modification of the rebalanced index further comprising:
removing one or more holdings from the index at rebalancing;
incorporating one or more additional holdings into the index at rebalancing wherein the value of one or more additional holdings corresponds to the value of one or more holdings removed from the index.

44. The method of claim 43 wherein one or more additional holdings incorporated into the index reflect the same security as one or more holdings removed from the index, incorporated at current market values.

45. The method of claim 43 wherein the aggregate value of holdings removed from the index is equal to the aggregate value of additional holdings incorporated into the index.

46. The method of claim 42 wherein said modification of the rebalanced index further comprising:
removing one or more holdings from the index at rebalancing;
incorporating one or more additional holdings into the index at rebalancing wherein the value of one or more additional holdings corresponds to the value of one or more holdings removed from the index.

47. The method of claim 46 wherein the aggregate value of holdings removed from the index is equal to the aggregate value of additional holdings incorporated into the index.

48. The method of claim 30 further comprising:
modifying the rebalanced index to reflect the target index in accordance with performance measurement preferences.

49. The method of claim 48 wherein said modification of the rebalanced index further comprising:
removing one or more holdings from the index at rebalancing;
incorporating one or more additional holdings into the index at rebalancing wherein the value of one or more additional holdings corresponds to the value of one or more holdings removed from the index.

50. A program for measuring financial performance stored on a medium readable by a processor comprising:
code to track the movement of values on a book income basis for specified holdings over time, the specified holdings comprising an index;
code to rebalance the index to account for applicable cash flow in accordance with one or more performance measurement preferences; and
code to update one or more values of the index to reflect said rebalancing.

51. The medium of claim 50 further comprising:
code to track unrealized gains and losses of one ore more of the specified holdings; and
code to rebalance the index in accordance with applicable constraints on realized gains and losses.

52. The medium of claim 50 further comprising:
code to benchmark a portfolio of securities with the index, wherein one or more index characteristics may be derived from one or more characteristics of the portfolio of securities.

53. The medium of claim 52 further comprising:
code to align the acquisition dates of one or more specified holdings with acquisition dates of one or more portfolio securities and initial book income values of said holdings are derived from corresponding market valuations on the aligned acquisition dates of the holdings.

54. The medium of claim 52 wherein one or more of the applicable cash flows reflect a portfolio exogenous cash flow.

55. The medium of claim 52 wherein said code to perform measurement preferences reflect one or more characteristics of the portfolio of securities.

56. The medium of claim 50 further comprising:
code to apply one or more constraints to the index, wherein rebalancing the index is in accordance with one or more of the constraints.

57. The medium of claim 50 further comprising:
code to apply one or more constraints to the index; and
code to modify the index to correspond to the constraints.

58. The medium of claim 57 wherein said constraints may include recognized gain/loss limits.

59. The medium of claim 57 wherein said constraints may include buy and hold requirements.

60. The medium of claim 50 wherein said code to rebalance further comprises integrating one or more additional holdings into the index.

61. The medium of claim 60 wherein said code to rebalance further comprises code to incorporate a value reflecting one or more index endogenous outflows wherein the one or more additional holdings integrated into the index have an aggregate value corresponding to the value reflecting one or more index endogenous outflows.

62. The medium of claim 60 wherein said code to rebalance further comprises code to incorporate a value reflecting one or more index exogenous inflows wherein the one or more additional holdings integrated into the index have an aggregate value corresponding to the value reflecting one or more index exogenous inflows.

63. The medium of claim 60 wherein said code to rebalance further comprises code to incorporate a value reflecting one or more index endogenous outflows and one or more index exogenous inflows wherein the one or more additional holdings integrated into the index have an aggregate value corresponding to the value reflecting one or more index endogenous outflows and one or more index exogenous cash flows.

64. The medium of claim 50 wherein said code to rebalance further comprises code to reduce an index value reflecting one or more index exogenous outflows.

65. The medium of claim 64 wherein said code to rebalance further comprises code to remove one or more holdings from the index that no longer meet the performance measurement preferences for incorporation within the index wherein the one or more holdings removed from the index have an aggregate value corresponding to a value reflecting one or more index exogenous outflows.

66. The medium of claim 64 wherein said code to rebalance further comprises code to remove one or more holdings from the index that no longer meet the performance measurement preferences for incorporation within the index wherein the one or more holdings removed from the index have an aggregate value corresponding to a value reflecting the value of one or more index exogenous outflows reduced by the value of one or more index endogenous outflows.

67. The medium of claim 50 further comprising:
code to compile data concerning said index holdings and tracked movements of said values; and
code to generate performance measurements from the compiled data.

68. The medium of claim 50 further comprising:
code to track a target index of holdings, wherein said code to rebalance comprises rebalancing the index in an attempt to reflect characteristics of the target index at a point in time;
code to retain one or more holdings in the index at the current market values of one or more corresponding securities from the point in time when such holdings are added to the index until removal of said holdings from the index.

69. The medium of claim 68 wherein said code to rebalance further comprises code to incorporate one or more additional holdings into the index at the current market values of one or more corresponding securities reflecting holdings recently added to the target index.

70. The medium of claim 69 wherein said code to incorporate holdings have an aggregate value corresponding to one or more index endogenous outflows.

71. The medium of claim 70 wherein said index endogenous outflows reflect corresponding endogenous outflows of the target index.

72. The medium of claim 69 wherein said code to incorporate holdings have an aggregate value corresponding to one or more index exogenous cash flows resulting in an inflow of value.

73. The medium of claim 69 wherein said incorporated holdings have an aggregate value corresponding to one or more index endogenous outflows and one or more index exogenous cash flows resulting in an inflow of value.

74. The medium of claim 73 wherein said index exogenous cash flows reflect index exogenous inflows and index exogenous outflows.

75. The medium of claim 69 wherein the additional holdings incorporated into the index reflect all holdings of the target index.

76. The medium of claim 69 wherein the additional holdings incorporated into the index reflect recently acquired holdings of the target index.

77. The medium of claim 69 wherein the additional holdings incorporated into the index are integrated in an attempt to modify the index to reflect the target index.

78. The medium of claim 68 wherein said code to rebalance further comprises removing one or more holdings and corresponding values from the index reflecting any holdings removed from the target index not previously reflected in the index.

79. The medium of claim 78 wherein said holdings removed have an aggregate value corresponding to one or more index exogenous cash flows resulting in an outflow of value.

80. The medium of claim 78 wherein said holdings removed have an aggregate value corresponding to one or more index endogenous outflows and one or more index exogenous cash flows resulting in an outflow of value.

81. The medium of claim 80 wherein said index exogenous cash flows may reflect index exogenous inflows and index exogenous outflows.

82. The medium of claim 80 wherein said index endogenous outflow values reflect corresponding endogenous outflows of the target index.

83. The medium of claim 68 further comprising:
code to modify the rebalanced index to reflect the target index in accordance with performance measurement preferences.

84. The medium of claim 68 further comprising:
code to use the index as a benchmark to a portfolio of securities;
code to incorporate one or more additional holdings into the index during rebalancing with values that reflect the market values of one or more corresponding securities wherein the addition of holdings to the index reflects the target index and wherein the value of additional holdings reflects a value of one or more portfolio exogenous cash flows.

85. The medium of claim 68 further comprising:
code to use said index as a benchmark to a portfolio of securities;
code to incorporate one or more additional holdings into the index during rebalancing with values that reflect the market values of one or more corresponding securities wherein the addition of holdings to the index reflects the target index and wherein the value of additional holdings reflects a value of one or more portfolio exogenous cash flows plus one or more endogenous outflows.

86. The medium of claim 85 wherein said endogenous outflows reflect corresponding endogenous outflows of the target index.

87. The medium of claim 85 wherein said code to rebalance the index to reflect the target index comprises incorporating one or more additional holdings into the index reflecting securities recently added to the target index.

88. The medium of claim 50 further comprising:
code to track the movement of values on a current market basis for one or more specified holdings over time, said one or more specified holdings comprising an index.

89. The medium of claim 68 further comprising:
code to modify the rebalanced index to bring the index in line with additional constraints.

90. The medium of claim 68 further comprising:
code to modify the rebalanced index to reflect the target index in accordance with performance measurement preferences.

91. The medium of claim 90 wherein said code to modify the rebalanced index further comprising:
code to remove one or more holdings from the index at rebalancing;
code to incorporate one or more additional holdings into the index at rebalancing wherein the value of one or more additional holdings corresponds to the value of one or more holdings removed from the index.

92. The medium of claim 91 wherein one or more additional holdings incorporated into the index reflect the same security as one or more holdings removed from the index, incorporated at current market values.

93. The medium of claim 91 wherein the aggregate value of holdings removed from the index is equal to the aggregate value of additional holdings incorporated into the index.

94. The medium of claim 90 wherein said code to modify the rebalanced index further comprising:
code to remove one or more holdings from the index at rebalancing;
code to incorporate one or more additional holdings into the index at rebalancing wherein the value of one or more additional holdings corresponds to the value of one or more holdings removed from the index.

95. The medium of claim 94 wherein the aggregate value of holdings removed from the index is equal to the aggregate value of additional holdings incorporated into the index.

96. The medium of claim 78 further comprising:
code to modify the rebalanced index to reflect the target index in accordance with performance measurement preferences.

97. The medium of claim 96 wherein said code to modify the rebalanced index further comprising:
code to remove one or more holdings from the index at rebalancing;
code to incorporate one or more additional holdings into the index at rebalancing wherein the value of one or more additional holdings corresponds to the value of one or more holdings removed from the index.

98. An apparatus, comprising:
a processor;
a memory, communicatively connected to the processor;
means for tracking the movement of values on a book income basis for specified holdings over time, the specified holdings comprising an index;
means for rebalancing the index to account for applicable cash flow in accordance with one or more performance measurement preferences; and
means for updating one or more values of the index to reflect said rebalancing.

99. The apparatus of claim 98 further comprising:
means for tracking unrealized gains and losses of one ore more of the specified holdings; and
means for rebalancing the index in accordance with applicable constraints on realized gains and losses.

100. The apparatus of claim 98 further comprising:
means for benchmarking a portfolio of securities with the index, wherein one or more index characteristics may be derived from one or more characteristics of the portfolio of securities.

101. The apparatus of claim 100 further comprising:
means for aligning the acquisition dates of one or more specified holdings with acquisition dates of one or more portfolio securities and initial book income values of said holdings are derived from corresponding market valuations on the aligned acquisition dates of the holdings.

102. The apparatus of claim 100 wherein one or more of the applicable cash flows reflect a portfolio exogenous cash flow.

103. The apparatus of claim 100 wherein said performance measurement preferences reflect one or more characteristics of the portfolio of securities.

104. The apparatus of claim 98 further comprising:
means for applying one or more constraints to the index, wherein rebalancing the index is in accordance with one or more of the constraints.

105. The apparatus of claim 98 further comprising:
means for applying one or more constraints to the index; and
means for modifying the index to correspond to the constraints.

106. The apparatus of claim 105 wherein constraints may include recognized gain/loss limits.

107. The apparatus of claim 105 wherein constraints may include buy and hold requirements.

108. The apparatus of claim 98 wherein said means for rebalancing further comprises integrating one or more additional holdings into the index.

109. The apparatus of claim 108 wherein said means for rebalancing further comprises a means for incorporating a value reflecting one or more index endogenous outflows wherein the one or more additional holdings integrated into the index have an aggregate value corresponding to the value reflecting one or more index endogenous outflows.

110. The apparatus of claim 108 wherein said means for rebalancing further comprises a means for incorporating a value reflecting one or more index exogenous inflows wherein the one or more additional holdings integrated into the index have an aggregate value corresponding to the value reflecting one or more index exogenous inflows.

111. The apparatus of claim 108 wherein said means for rebalancing further comprises a means for incorporating a value reflecting one or more index endogenous outflows and one or more index exogenous inflows wherein the one or more additional holdings integrated into the index have an aggregate value corresponding to the value reflecting one or more index endogenous outflows and one or more index exogenous cash flows.

112. The apparatus of claim 98 wherein said means for rebalancing further comprises a means for reducing an index value reflecting one or more index exogenous outflows.

113. The apparatus of claim 112 wherein said means for rebalancing further comprises a means for removing one or more holdings from the index that no longer meet the performance measurement preferences for incorporation within the index wherein the one or more holdings removed from the index have an aggregate value corresponding to a value reflecting one or more index exogenous outflows.

114. The apparatus of claim 112 wherein said means for rebalancing further comprises a means for removing one or more holdings from the index that no longer meet the performance measurement preferences for incorporation within the index wherein the one or more holdings removed from the index have an aggregate value corresponding to a value reflecting the value of one or more index exogenous outflows reduced by the value of one or more index endogenous outflows.

115. The apparatus of claim 98 further comprising:
means for compiling data concerning said index holdings and tracked movements of said values; and
means for generating performance measurements from the compiled data.

116. The apparatus of claim 98 further comprising:
means for tracking a target index of holdings, wherein said means for rebalancing comprises rebalancing the index in an attempt to reflect characteristics of the target index at a point in time;
means for retaining one or more holdings in the index at the current market values of one or more corresponding securities from the point in time when such holdings are added to the index until removal of said holdings from the index.

117. The apparatus of claim 116 wherein said means for rebalancing further comprises a means for incorporating one or more additional holdings into the index at the current market values of one or more corresponding securities reflecting holdings recently added to the target index.

118. The apparatus of claim 117 wherein said means for incorporating holdings have an aggregate value corresponding to one or more index endogenous outflows.

119. The apparatus of claim 118 wherein said index endogenous outflows reflect corresponding endogenous outflows of the target index.

120. The apparatus of claim 117 wherein said means for incorporating holdings have an aggregate value corresponding to one or more index exogenous cash flows resulting in an inflow of value.

121. The apparatus of claim 117 wherein said incorporated holdings have an aggregate value corresponding to one or more index endogenous outflows and one or more index exogenous cash flows resulting in an inflow of value.

122. The apparatus of claim 121 wherein said index exogenous cash flows reflect index exogenous inflows and index exogenous outflows.

123. The apparatus of claim 117 wherein the additional holdings incorporated into the index reflect all holdings of the target index.

124. The apparatus of claim 117 wherein the additional holdings incorporated into the index reflect recently acquired holdings of the target index.

125. The apparatus of claim 117 wherein the additional holdings incorporated into the index are integrated in an attempt to modify the index to reflect the target index.

126. The apparatus of claim 116 wherein said means for rebalancing further comprises removing one or more holdings and corresponding values from the index reflecting any holdings removed from the target index not previously reflected in the index.

127. The apparatus of claim 126 wherein said holdings removed have an aggregate value corresponding to one or more index exogenous cash flows resulting in an outflow of value.

128. The apparatus of claim 126 wherein said holdings removed have an aggregate value corresponding to one or more index endogenous outflows and one or more index exogenous cash flows resulting in an outflow of value.

129. The apparatus of claim 128 wherein said index exogenous cash flows may reflect index exogenous inflows and index exogenous outflows.

130. The apparatus of claim 128 wherein said index endogenous outflow values reflect corresponding endogenous outflows of the target index.

131. The apparatus of claim 116 further comprising:
means for modifying the rebalanced index to reflect the target index in accordance with performance measurement preferences.

132. The apparatus of claim 116 further comprising:
means for using the index as a benchmark to a portfolio of securities;
means for incorporating one or more additional holdings into the index during rebalancing with values that reflect the market values of one or more corresponding securities wherein the addition of holdings to the index reflects the target index and wherein the value of additional holdings reflects a value of one or more portfolio exogenous cash flows.

133. The apparatus of claim 116 further comprising:
means for using said index as a benchmark to a portfolio of securities;
means for incorporating one or more additional holdings into the index during rebalancing with values that reflect the market values of one or more corresponding securities wherein the addition of holdings to the index reflects the target index and wherein the value of additional holdings reflects a value of one or more portfolio exogenous cash flows plus one or more endogenous outflows.

134. The apparatus of claim 133 wherein said endogenous outflows reflect corresponding endogenous outflows of the target index.

135. The apparatus of claim 133 wherein said means for rebalancing the index to reflect the target index comprises incorporating one or more additional holdings into the index reflecting securities recently added to the target index.

136. The apparatus of claim 98 further comprising:
means for tracking the movement of values on a current market basis for one or more specified holdings over time, said one or more specified holdings comprising an index.

137. The apparatus of claim 116 further comprising:
means for modifying the rebalanced index to bring the index in line with additional constraints.

138. The apparatus of claim 116 further comprising:
means for modifying the rebalanced index to reflect the target index in accordance with performance measurement preferences.

139. The apparatus of claim 138 wherein said means for modifying the rebalanced index further comprising:
means for removing one or more holdings from the index at rebalancing;
means for incorporating one or more additional holdings into the index at rebalancing wherein the value of one or more additional holdings corresponds to the value of one or more holdings removed from the index.

140. The apparatus of claim 139 wherein one or more additional holdings incorporated into the index reflect the same security as one or more holdings removed from the index, incorporated at current market values.

141. The apparatus of claim 139 wherein the aggregate value of holdings removed from the index is equal to the aggregate value of additional holdings incorporated into the index.

142. The apparatus of claim 138 wherein said means for modifying the rebalanced index further comprising:
means for removing one or more holdings from the index at rebalancing;
means for incorporating one or more additional holdings into the index at rebalancing wherein the value of one or more additional holdings corresponds to the value of one or more holdings removed from the index.

143. The apparatus of claim 142 wherein the aggregate value of holdings removed from the index is equal to the aggregate value of additional holdings incorporated into the index.

144. The apparatus of claim 126 further comprising:
means for modifying the rebalanced index to reflect the target index in accordance with performance measurement preferences.

145. The apparatus of claim 144 wherein said modification of the rebalanced index further comprising:
means for removing one or more holdings from the index at rebalancing;
means for incorporating one or more additional holdings into the index at rebalancing wherein the value of one or more additional holdings corresponds to the value of one or more holdings removed from the index.

146. A processor-implemented method to measure financial performance, comprising:
tracking the movement of values on a book income basis for specified holdings over time, the specified holdings comprising an index;
retaining one or more holdings in the index at the current market values of one or more corresponding securities from the point in time when such holdings are added to the index until removal of said holdings from the index;
using the index as a benchmark to a portfolio of securities, wherein one or more index characteristics may be derived from one or more characteristics of the portfolio of securities;
rebalancing the index to account for applicable cash flow in accordance with one or more performance measurement preferences, wherein said rebalancing further comprises removing one or more holdings from the index and integrating one or more additional holdings into the index reflecting one or more index cash flows;
tracking a target index of holdings, wherein said rebalancing comprises rebalancing the index in an attempt to reflect characteristics of the target index at a point in time;
modifying the rebalanced index to correspond to one or more constraints to the index; and
updating the values of one or more of the additional holdings to reflect rebalancing the index and current market values of the specified holdings.

147. The method of claim 2 further comprising:
calculating post-tax performance metrics.

148. The medium of claim 50 further comprising:
code to calculate post-tax performance metrics.

149. The apparatus of claim 98 further comprising:
means to calculate post-tax performance metrics.
